(19) United States
(12) Patent Application Publication
(10) Pub. No.: US 2026/0371063 A1
(43) Pub. Date: Nov. 19, 2026

(54) METHODS FOR INSTALLING AND/OR ACTIVATING DEVICE CONFIGURATIONS

(71) Applicant: Apple Inc., Cupertino, CA (US)

(72) Inventors: Lukas M. BUGLA, Fremont, CA (US); Michael S. SOETAERT, San Jose, CA (US); Raj S. CHAUGULE, Santa Clara, CA (US); Li LI, Saratoga, CA (US)

(21) Appl. No.: 19/682,317

(22) Filed: May 19, 2026

Related U.S. Application Data
(60) Provisional application No. 63/808,420, filed on May 19, 2025.
(60) Provisional application No. 63/817,128, filed on Jun. 3, 2025.

(51) Int. Cl. H04W 8/18; H04M 1/72457; H04W 88/06

(52) U.S. Cl. CPC H04W 8/183; H04M 1/72457; H04W 88/06

(57) ABSTRACT

In some embodiments, when an electronic device detects an indication of future travel to a destination, the electronic device initiates one or more operations for installing a configuration, such as a SIM, corresponding to the destination. In some embodiments, when detecting that an electronic device arrives in a destination, for which the currently active configuration is not configured, the electronic device initiates one or more operations for activating a configuration which is configured for the destination.

### CROSS-REFERENCE TO RELATED APPLICATIONS

This application claims the benefit of U.S. Provisional Application No. 63/808,420, filed May 19, 2025, and U.S. Provisional Application No. 63/817,128, filed Jun. 3, 2025, the contents of which are herein incorporated by reference in their entireties for all purposes.

### FIELD OF THE DISCLOSURE

This disclosure relates generally to an electronic device presenting user interfaces for installing, activating, using, and/or otherwise managing one or more configurations, such as SIM profiles, based on the travel associated with an electronic device.

### BACKGROUND OF THE DISCLOSURE

User interaction with electronic devices has increased significantly in recent years. These devices can be devices such as computers, tablet computers, televisions, multimedia devices, or mobile devices. In some circumstances, users may wish to travel to a geographic location which requires a different configuration, such as related to cellular communications, than currently installed and/or activated on the electronic device.

### SUMMARY OF THE DISCLOSURE

Providing efficient ways of installing, activating, using, and/or otherwise managing configurations on an electronic device enhances user interactions with the electronic device by reducing the time and inputs needed to source and activate a configuration corresponding to a second geographic location (e.g., travel destination). Recognizing the need for an alternate configuration and providing efficient ways of installing and/or activating an alternate configuration enhances user interactions with the electronic device by reducing time and inputs needed to source, install, and activate an alternate configuration. Recognizing the need to activate a configuration which is configured for a new geographic location in which an electronic device has detected arrival also reduces chances of excess fees related to using a configuration which is not configured for a destination, for instance.

The full descriptions of the embodiments are provided in the Drawings and the Detailed Description, and it is understood that the Summary provided above does not limit the scope of the disclosure in any way.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIGS. 3A-3G are block diagrams of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 5C-5D illustrate exemplary components of a personal electronic device having a touch-sensitive display and intensity sensors in accordance with some embodiments.

FIGS. 5E-5H illustrate exemplary components and user interfaces of a personal electronic device in accordance with some embodiments.

FIGS. 6A-6T illustrate exemplary ways in which an electronic device initiates one or more operations corresponding to the installation of a configuration based on the detection of an indication of future travel to a different geographic location than the current geographic location according to some embodiments.

FIG. 7 illustrates a flow diagram illustrating a method in which an electronic device initiates one or more operations corresponding to the installation of a configuration based on the detection of an indication of future travel to a different geographic location than the current geographic location according to some embodiments.

FIGS. 8A-8L illustrate exemplary ways in which an electronic device initiates one or more operations corresponding to activation of a configuration installed on the electronic device based on detecting the change of geographic location of the electronic device.

FIG. 9 illustrates a flow diagram illustrating a method in which an electronic device performs one or more operations corresponding to activation of a configuration installed on the electronic device based on detecting the change of geographic location of the electronic device.

### DETAILED DESCRIPTION

In the following description of embodiments, reference is made to the accompanying drawings which form a part hereof, and in which it is shown by way of illustration specific embodiments that are optionally practiced. It is to be understood that other embodiments are optionally used, and structural changes are optionally made without departing from the scope of the disclosed embodiments.

Providing efficient ways of installing, activating, using, and/or otherwise managing configurations on an electronic device enhances user interactions with the electronic device by reducing the time and inputs needed to source and activate a configuration corresponding to a second geographic location (e.g., travel destination). Recognizing the need for an alternate configuration and providing efficient ways of installing and/or activating an alternate configuration enhances user interactions with the electronic device by reducing time and inputs needed to source, install, and activate an alternate configuration. Recognizing the need to activate a configuration which is configured for a new geographic location in which an electronic device has detected arrival also reduces chances of excess fees related to using a configuration which is not configured for a destination, for instance.

Although the following description uses terms "first," "second," etc. to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms "a," "an," and "the" are intended to include the plural forms as well, unless the context clearly indicates otherwise. It will also be understood that the term "and/or" as used herein refers to and encompasses any and all possible combinations of one or more of the associated listed items. It will be further understood that the terms "includes," "including," "comprises," and/or "comprising," when used in this specification, specify the presence of stated features, integers, steps, operations, elements, and/or components, but do not preclude the presence or addition of one or more other features, integers, steps, operations, elements, components, and/or groups thereof.

The term "if" is, optionally, construed to mean "when" or "upon" or "in response to determining" or "in response to detecting," depending on the context. Similarly, the phrase "if it is determined" or "if [a stated condition or event] is detected" is, optionally, construed to mean "upon determining" or "in response to determining" or "upon detecting [the stated condition or event]" or "in response to detecting [the stated condition or event]," depending on the context.

### EXEMPLARY DEVICES

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touch pads), are, optionally, used. It should also be understood that, in some embodiments, the device is not a portable communications device, but is a desktop computer or a television with a touch-sensitive surface (e.g., a touch screen display and/or a touch pad). In some embodiments, the device does not have a touch screen display and/or a touch pad, but rather is capable of outputting display information (such as the user interfaces of the disclosure) for display on a separate display device, and capable of receiving input information from a separate input device having one or more input mechanisms (such as one or more buttons, a touch screen display and/or a touch pad). In some embodiments, the device has a display, but is capable of receiving input information from a separate input device having one or more input mechanisms (such as one or more buttons, a touch screen display and/or a touch pad). In some embodiments, the electronic device is a computer system that is in communication (e.g., via wireless communication, via wired communication) with a display generation component (e.g., a display device such as a head-mounted device (HMD), a display, a projector, a touch-sensitive display, or other device or component that presents visual content to a user, for example, on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse and/or a joystick. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

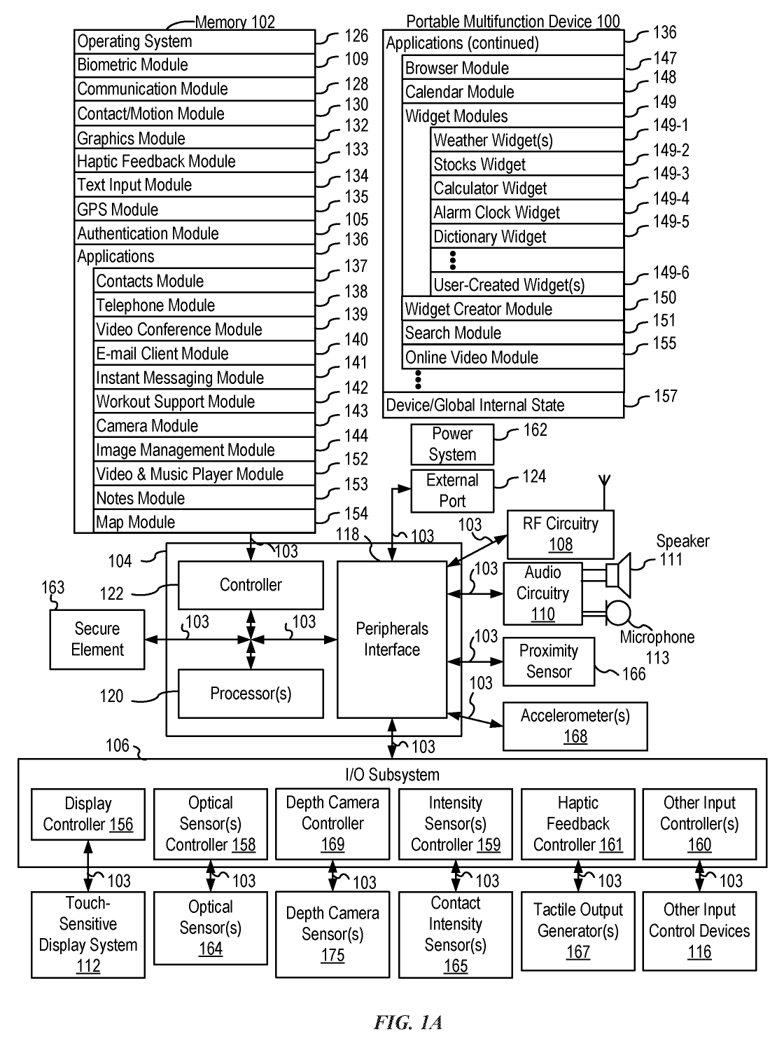

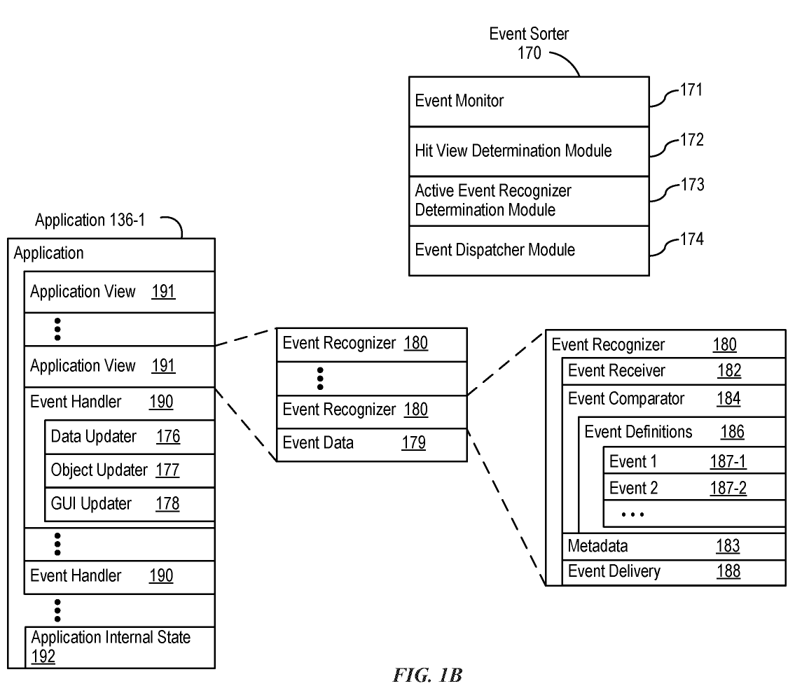

Attention is now directed toward embodiments of portable or non-portable devices with touch-sensitive displays, though the devices need not include touch-sensitive displays or displays in general, as described above. FIG. 1A is a block diagram illustrating portable or non-portable multifunction device 100 with touch-sensitive displays 112 in accordance with some embodiments. Touch-sensitive display 112 is sometimes called a "touch screen" for convenience, and is sometimes known as or called a touch-sensitive display system. Device 100 includes memory 102 (which optionally includes one or more computer readable storage mediums), memory controller 122, one or more processing units (CPU's) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term "intensity" of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term "tactile output" refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a "down click" or "up click" of a physical actuator button. In some cases, a user will feel a tactile sensation such as a "down click" or "up click" even when there is no movement of a physical actuator button associated with the touch-sensitive surface that is physically pressed (e.g., displaced) by the user's movements. As another example, movement of the touch-sensitive surface is, optionally, interpreted or sensed by the user as "roughness" of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an "up click," a "down click," "roughness"), unless otherwise stated, the generated tactile output corresponds to physical displacement of the device or a component thereof that will generate the described sensory perception for a typical (or average) user.

It should be appreciated that device 100 is only one example of a portable or non-portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application specific integrated circuits. Further, the various components shown in FIG. 1A are optionally implemented across two or more devices; for example, a display and audio circuitry on a display device, a touch-sensitive surface on an input device, and remaining components on device 100. In such an embodiment, device 100 optionally communicates with the display device and/or the input device to facilitate operation of the system, as described in the disclosure, and the various components described herein that relate to display and/or input remain in device 100, or are optionally included in the display and/or input device, as appropriate.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data.

In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

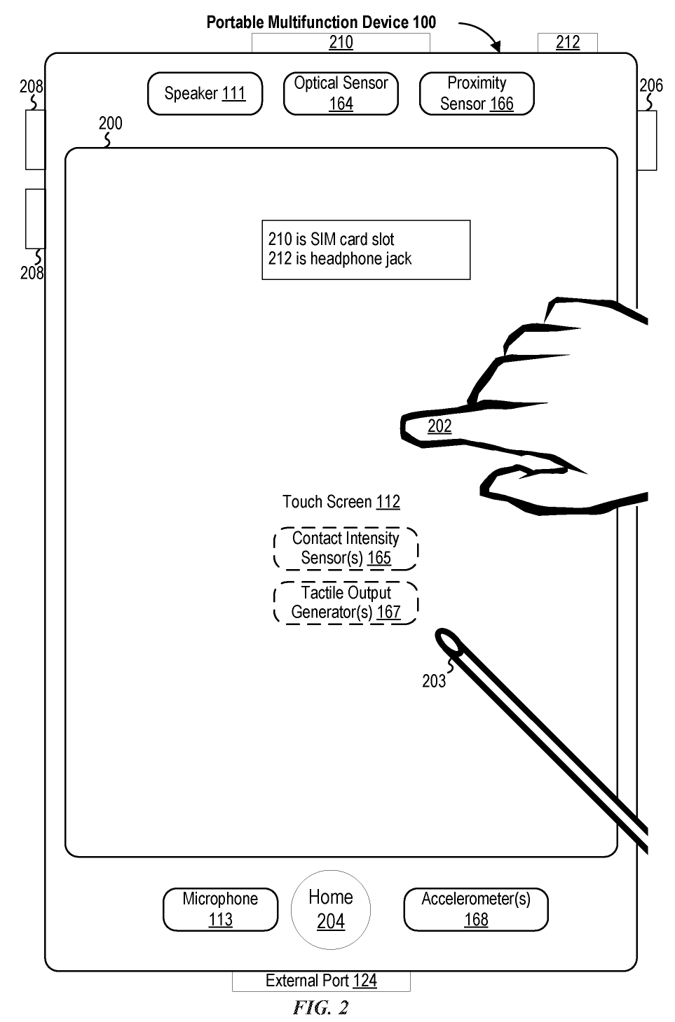

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, intensity sensor controller 159, haptic feedback controller 161 and one or more input controllers 160 for other input or control devices. The one or more input controllers 160 receive/send electrical signals from/to other input or control devices 116. The other input control devices 116 optionally include physical buttons (e.g., push buttons, rocker buttons, etc.), dials, slider switches, joysticks, click wheels, and so forth. In some alternate embodiments, input controller(s) 160 are, optionally, coupled to any (or none) of the following: a keyboard, infrared port, USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

A quick press of the push button optionally disengages a lock of touch screen 112 or optionally begins a process that uses gestures on the touch screen to unlock the device, as described in U.S. Patent Application 11/322,549, "Unlocking a Device by Performing Gestures on an Unlock Image," filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. As described above, the touch-sensitive operation and the display operation of touch-sensitive display 112 are optionally separated from each other, such that a display device is used for display purposes and a touch-sensitive surface (whether display or not) is used for input detection purposes, and the described components and functions are modified accordingly. However, for simplicity, the following description is provided with reference to a touch-sensitive display. Display controller 156 receives and/or sends electrical signals from/to touch screen 112. Touch screen 112 displays visual output to the user. The visual output optionally includes graphics, text, icons, video, and any combination thereof (collectively termed "graphics"). In some embodiments, some or all of the visual output corresponds to user-interface objects.

Touch screen 112 has a touch-sensitive surface, sensor or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone®, iPod Touch®, and iPad® from Apple Inc. of Cupertino, California.

A touch-sensitive display in some embodiments of touch screen 112 is, optionally, analogous to the multi-touch sensitive touchpads described in the following U.S. Patents: 6,323,846 (Westerman et al.), 6,570,557 (Westerman et al.), and/or 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. Patent Application No. 11/381,313, "Multipoint Touch Surface Controller," filed May 2, 2006; (2) U.S. Patent Application No. 10/840,862, "Multipoint Touchscreen," filed May 6, 2004; (3) U.S. Patent Application No. 10/903,964, "Gestures For Touch Sensitive Input Devices," filed Jul. 30, 2004; (4) U.S. Patent Application No. 11/48,264, "Gestures For Touch Sensitive Input Devices," filed Jan. 31, 2005; (5) U.S. Patent Application No. 11/38,590, "Mode-Based Graphical User Interfaces For Touch Sensitive Input Devices," filed Jan. 18, 2005; (6) U.S. Patent Application No. 11/228,758, "Virtual Input Device Placement On A Touch Screen User Interface," filed Sep. 16, 2005; (7) U.S. Patent Application No. 11/228,700, "Operation Of A Computer With A Touch Screen Interface," filed Sep. 16, 2005; (8) U.S. Patent Application No. 11/228,737, "Activating Virtual Keys Of A Touch-Screen Virtual Keyboard," filed Sep. 16, 2005; and (9) U.S. Patent Application No. 11/367,749, "Multi-Functional Hand-Held Device," filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad (not shown) for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable or non-portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112 which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. Patent Application Nos. 11/241,839, "Proximity Detector In Handheld Device"; 11/240,788, "Proximity Detector In Handheld Device"; 11/620,702, "Using Ambient Light Sensor To Augment Proximity Sensor Output"; 11/586,862, "Automated Response To And Sensing Of User Activity In Portable Devices"; and 11/638,251, "Methods And Systems For Automatic Configuration Of Peripherals," which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112 which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, "Acceleration-based Theft Detection System for Portable Electronic Devices," and U.S. Patent Publication No. 20060017692, "Methods And Apparatuses For Operating A Portable Device Based On An Accelerometer," both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

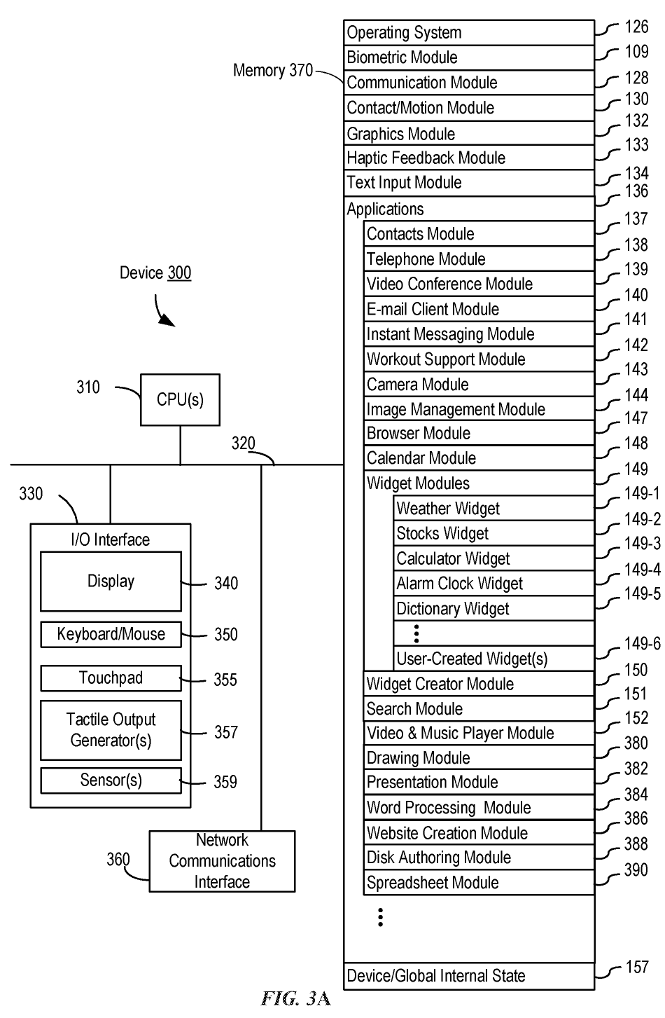

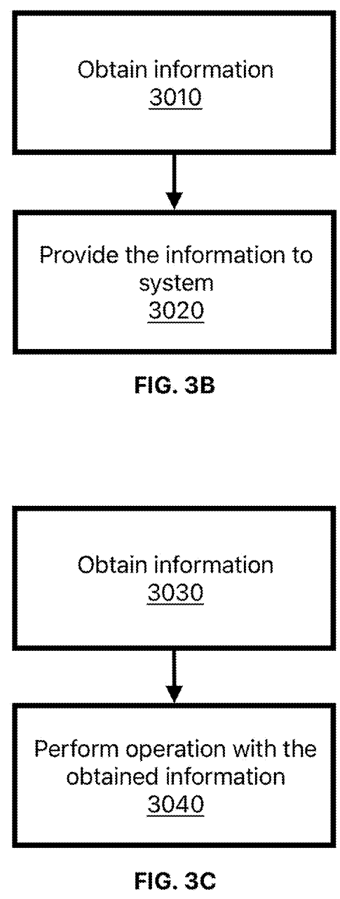

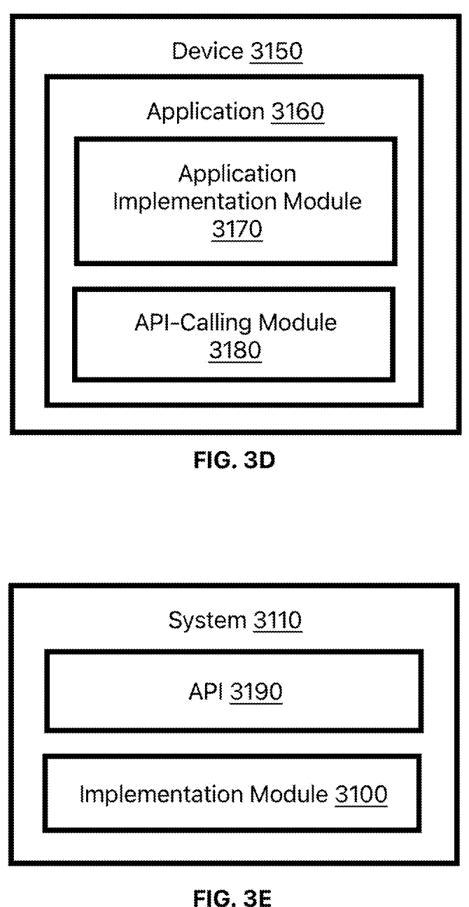

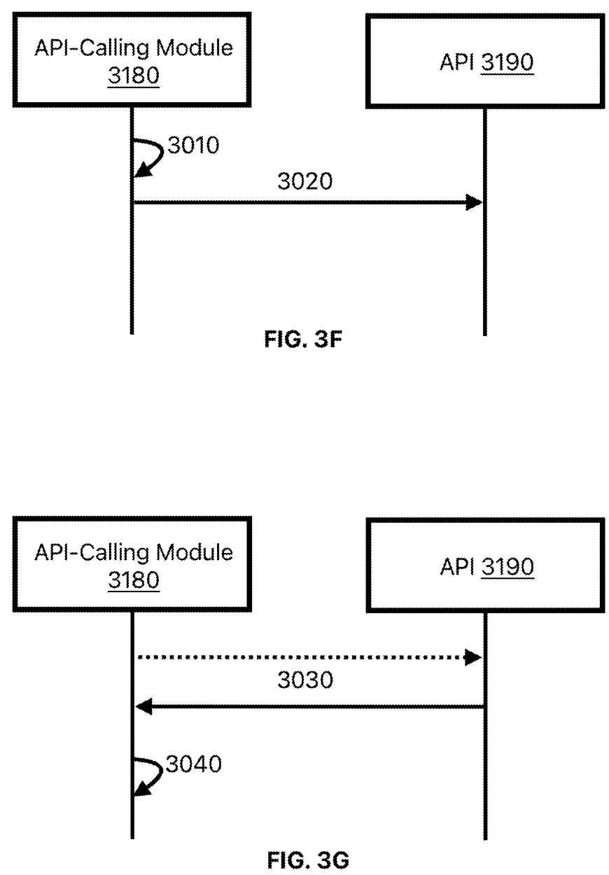

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3A) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used on iPod (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact) determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., "multitouch"/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has "clicked" on an icon). In some embodiments at least a subset of the intensity thresholds are determined in accordance with software parameters (e.g., the intensity thresholds are not determined by the activation thresholds of particular physical actuators and can be adjusted without changing the physical hardware of device 100). For example, a mouse "click" threshold of a trackpad or touch screen display can be set to any of a large range of predefined threshold values without changing the trackpad or touch screen display hardware. Additionally, in some implementations a user of the device is provided with software settings for adjusting one or more of the set of intensity thresholds (e.g., by adjusting individual intensity thresholds and/or by adjusting a plurality of intensity thresholds at once with a system-level click "intensity" parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast or other visual property) of graphics that are displayed. As used herein, the term "graphics" includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing, to camera 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
video player module;
music player module;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which merges video player module and music player module;
notes module 153;
map module 154; and/or
online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, "instant messaging" refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to -do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to -do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, "Portable Multifunction Device, Method, and Graphical User Interface for Playing Online Videos," filed Jun. 20, 2007, and U.S. Patent Application No. 11/968,067, "Portable Multifunction Device, Method, and Graphical User Interface for Playing Online Videos," filed Dec. 31, 2007, the contents of which are hereby incorporated by reference in their entirety.

Each of the above -identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a "menu button" is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (187) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable or non-portable multifunction device 100 having a touch screen 112 in accordance with some embodiments. As stated above, multifunction device 100 is described as having the various illustrated structures (such as touch screen 112, speaker 111, accelerometer 168, microphone 113, etc.); however, it is understood that these structures optionally reside on separate devices. For example, display-related structures (e.g., display, speaker, etc.) and/or functions optionally reside on a separate display device, input-related structures (e.g., touch-sensitive surface, microphone, accelerometer, etc.) and/or functions optionally reside on a separate input device, and remaining structures and/or functions optionally reside on multifunction device 100.

The touch screen 112 optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as "home" or menu button 204. As previously described, menu button 204 is, optionally, used to navigate to any application 136 in a set of applications that are, optionally executed on device 100. Alternatively, in some embodiments, the menu button is implemented as a soft key in a GUI displayed on touch screen 112.

In one embodiment, device 100 includes touch screen 112, menu button 204, push button 206 for powering the device on/off and locking the device, volume adjustment button(s) 208, Subscriber Identity Module (SIM) card slot 210, head set jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not include the display and the touch-sensitive surface, as described above, but rather, in some embodiments, optionally communicates with the display and the touch-sensitive surface on other devices. Additionally, device 300 need not be portable. In some embodiments, device 300 is a laptop computer, a desktop computer, a tablet computer, a multimedia player device (such as a television or a set-top box), a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable or non-portable multifunction device 100 (FIG. 1A), or a subset thereof. Furthermore, memory 370 optionally stores additional programs, modules, and data structures not present in memory 102 of portable or non-portable multifunction device 100. For example, memory 370 of device 300 optionally stores drawing module 380, presentation module 382, word processing module 384, website creation module 386, disk authoring module 388, and/or spreadsheet module 390, while memory 102 of portable or non-portable multifunction device 100 (FIG. 1A) optionally does not store these modules.

Each of the above identified elements in FIG. 3A are, optionally, stored in one or more of the previously mentioned memory devices. Each of the above identified modules corresponds to a set of instructions for performing a function described above. The above identified modules or programs (e.g., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIGS. 3B and 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIGS. 3C and 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

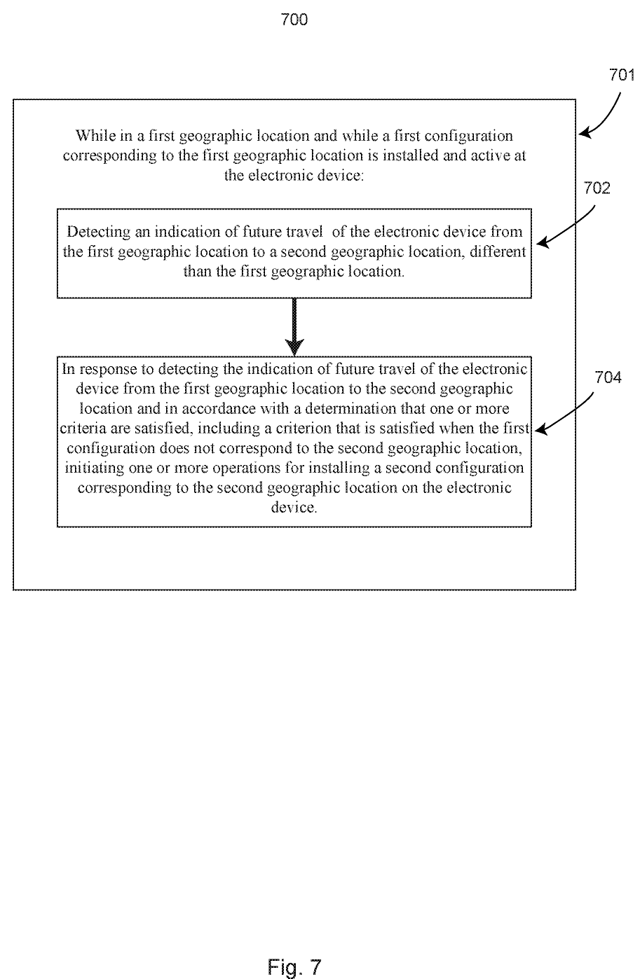

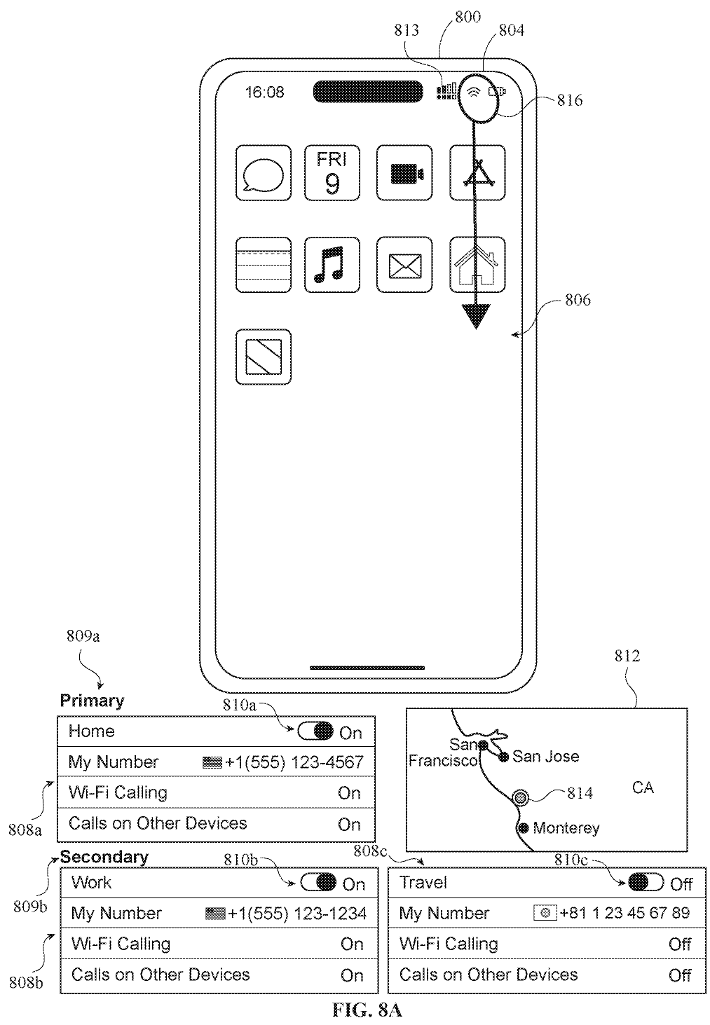

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 700 (FIG. 7), and/or method 900 (FIG. 9) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

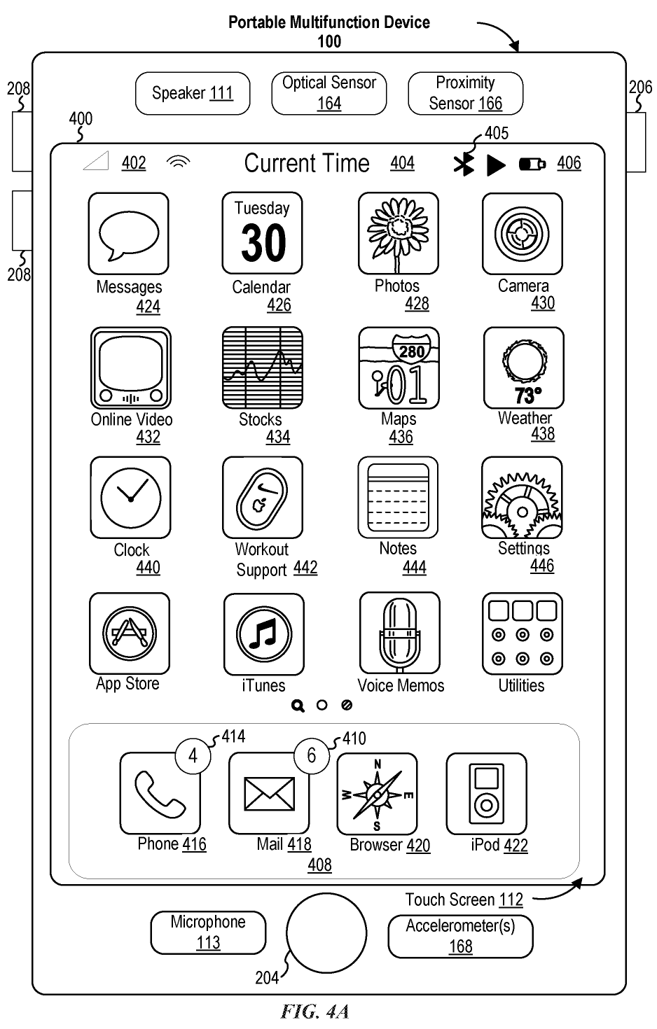

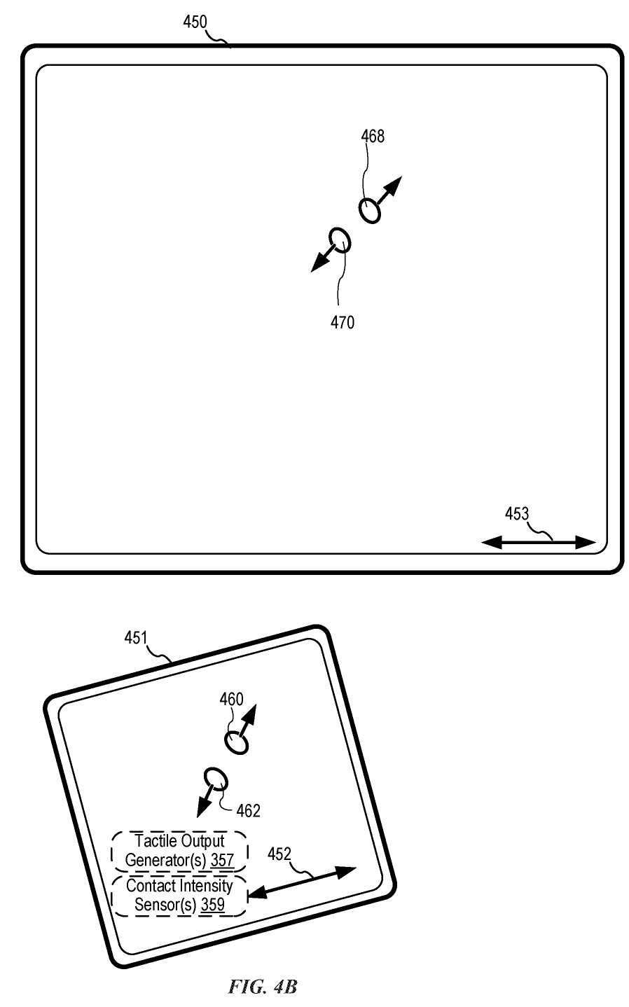

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:

Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 451 (e.g., a tablet or touchpad 355, FIG. 3A) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

As used herein, the term "focus selector" refers to an input element that indicates a current part of a user interface with which a user is interacting. In some implementations that include a cursor or other location marker, the cursor acts as a "focus selector," so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider or other user interface element), the particular user interface element is adjusted in accordance with the detected input. In some implementations that include a touch-screen display (e.g., touch-sensitive display system 112 in FIG. 1A) that enables direct interaction with user interface elements on the touch-screen display, a detected contact on the touch-screen acts as a "focus selector," so that when an input (e.g., a press input by the contact) is detected on the touch-screen display at a location of a particular user interface element (e.g., a button, window, slider or other user interface element), the particular user interface element is adjusted in accordance with the detected input. In some implementations focus is moved from one region of a user interface to another region of the user interface without corresponding movement of a cursor or movement of a contact on a touch-screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch-screen display) that is controlled by the user so as to communicate the user's intended interaction with the user interface (e.g., by indicating, to the device, the element of the user interface with which the user is intending to interact). For example, the location of a focus selector (e.g., a cursor, a contact or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term "characteristic intensity" of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.5, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a "down stroke" of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an "up stroke" of the respective press input).

In some embodiments, the device employs intensity hysteresis to avoid accidental inputs sometimes termed "jitter," where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90% or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an "up stroke" of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the description of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

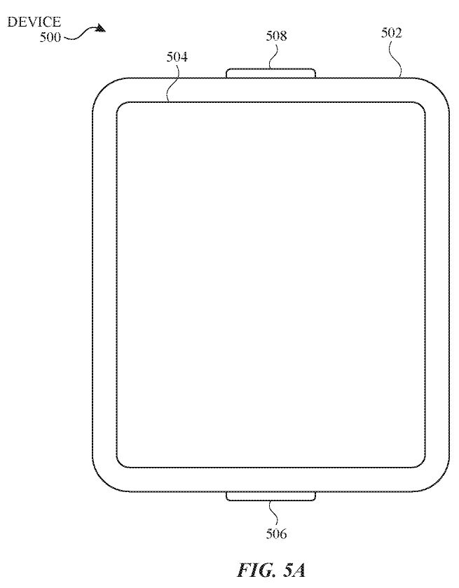

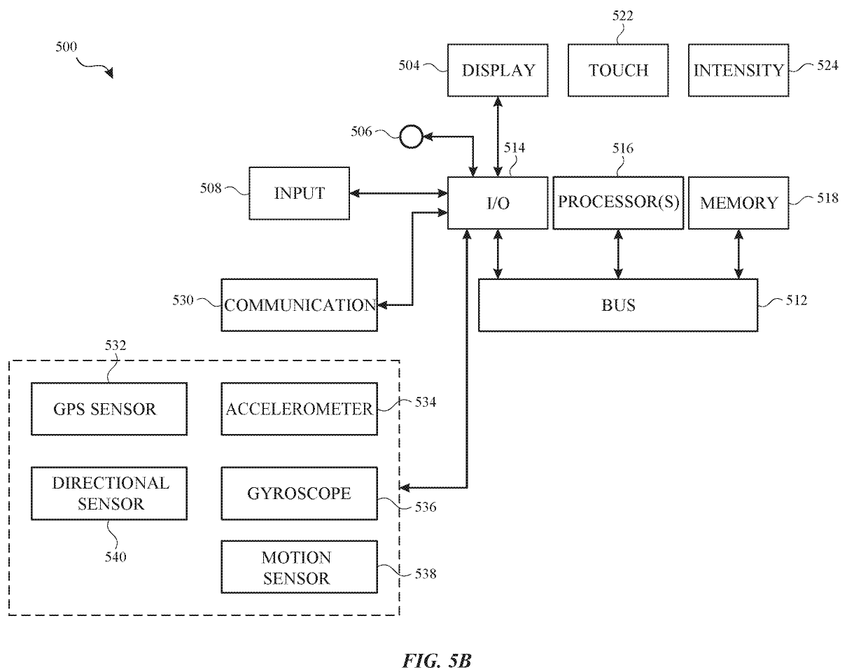

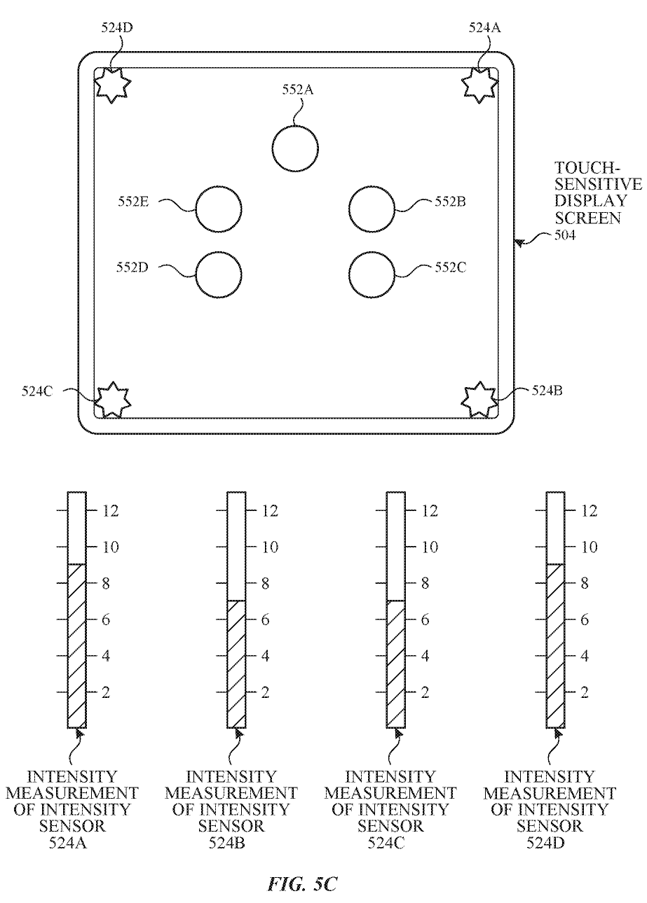

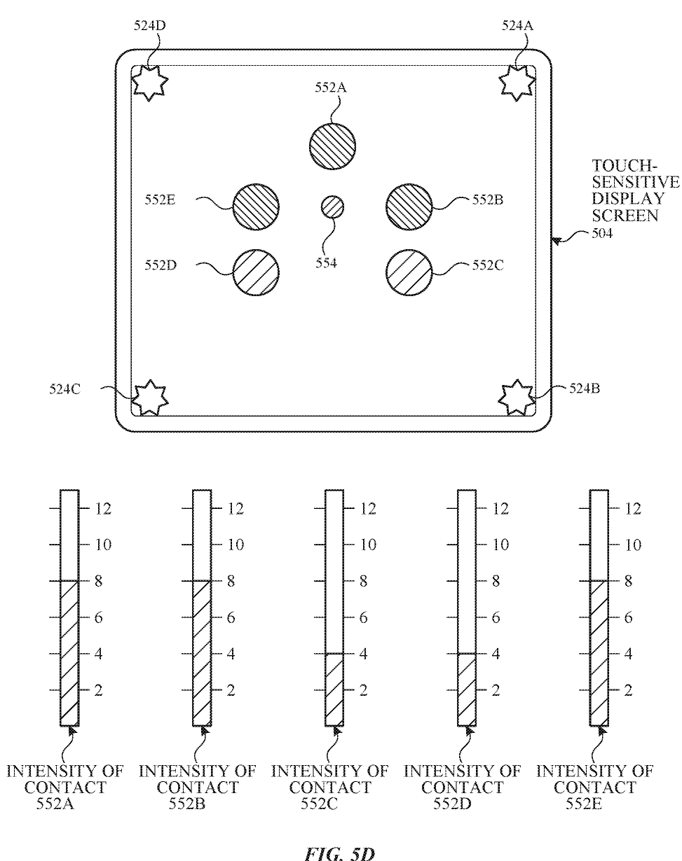

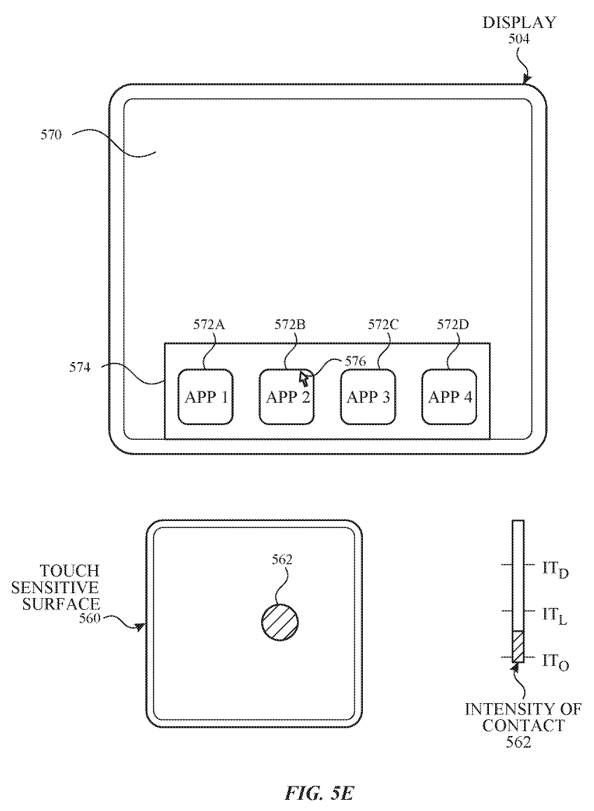

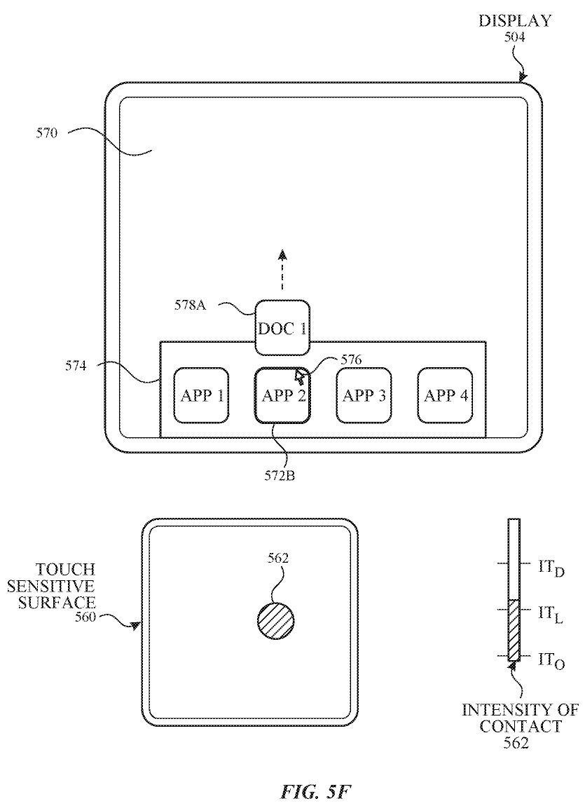

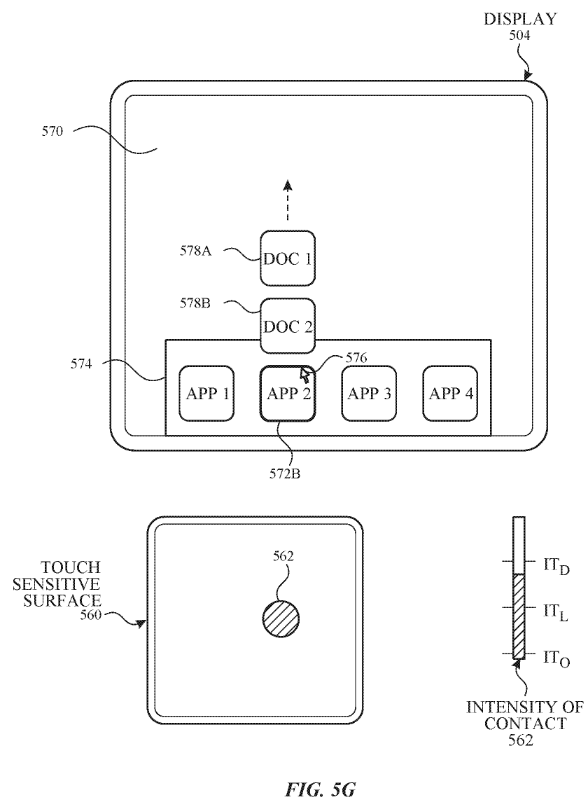

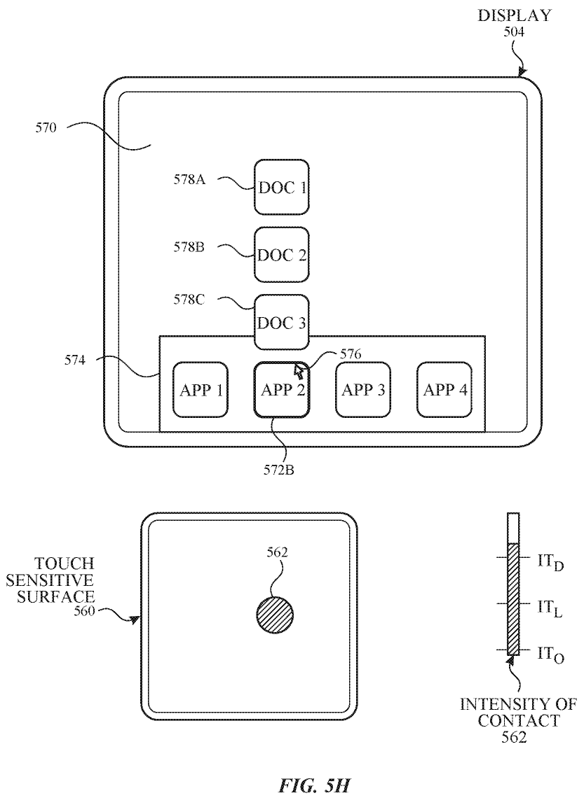

FIG. 5A illustrates a block diagram of an exemplary architecture for the device 500 according to some embodiments of the disclosure. In the embodiment of FIG. 5A, media or other content is optionally received by device 500 via network interface 502, which is optionally a wireless or wired connection. The one or more processors 516 optionally execute any number of programs stored in memory 506 or storage, which optionally includes instructions to perform one or more of the methods and/or processes described herein (e.g., methods 700, and/or 900). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIGS. 5, but can include other or additional components in multiple configurations.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user’s intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.5, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C illustrates detecting a plurality of contacts 552A-552E on touch-sensitive display screen 504 with a plurality of intensity sensors 524A-524D. FIG. 5C additionally includes intensity diagrams that show the current intensity measurements of the intensity sensors 524A-524D relative to units of intensity. In this example, the intensity measurements of intensity sensors 524A and 524D are each 9 units of intensity, and the intensity measurements of intensity sensors 524B and 524C are each 7 units of intensity. In some implementations, an aggregate intensity is the sum of the intensity measurements of the plurality of intensity sensors 524A-524D, which in this example is 32 intensity units. In some embodiments, each contact is assigned a respective intensity that is a portion of the aggregate intensity. FIG. 5D illustrates assigning the aggregate intensity to contacts 552A-552E based on their distance from the center of force 554. In this example, each of contacts 552A, 552B, and 552E are assigned an intensity of contact of 8 intensity units of the aggregate intensity, and each of contacts 552C and 552D are assigned an intensity of contact of 4 intensity units of the aggregate intensity. More generally, in some implementations, each contact j is assigned a respective intensity Ij that is a portion of the aggregate intensity, A, in accordance with a predefined mathematical function, Ij = A·(Dj/ΣDi), where Dj is the distance of the respective contact j to the center of force, and ΣDi is the sum of the distances of all the respective contacts (e.g., i=1 to last) to the center of force. The operations described with reference to FIGS. 5C-5D can be performed using an electronic device similar or identical to device 100, 300, or 500. In some embodiments, a characteristic intensity of a contact is based on one or more intensities of the contact. In some embodiments, the intensity sensors are used to determine a single characteristic intensity (e.g., a single characteristic intensity of a single contact). It should be noted that the intensity diagrams are not part of a displayed user interface, but are included in FIGS. 5C-5D to aid the reader.

In some embodiments, a portion of a gesture is identified for purposes of determining a characteristic intensity. For example, a touch-sensitive surface optionally receives a continuous swipe contact transitioning from a start location and reaching an end location, at which point the intensity of the contact increases. In this example, the characteristic intensity of the contact at the end location is, optionally, based on only a portion of the continuous swipe contact, and not the entire swipe contact (e.g., only the portion of the swipe contact at the end location). In some embodiments, a smoothing algorithm is, optionally, applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is, optionally, characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

FIGS. 5E-5H illustrate detection of a gesture that includes a press input that corresponds to an increase in intensity of a contact 562 from an intensity below a light press intensity threshold (e.g., “IT_{L}”) in FIG. 5E, to an intensity above a deep press intensity threshold (e.g., “IT_{D}”) in FIG. 5H. The gesture performed with contact 562 is detected on touch-sensitive surface 560 while cursor 576 is displayed over application icon 572B corresponding to App 2, on a displayed user interface 570 that includes application icons 572A-572D displayed in predefined region 574. In some embodiments, the gesture is detected on touch-sensitive display 504. The intensity sensors detect the intensity of contacts on touch-sensitive surface 560. The device determines that the intensity of contact 562 peaked above the deep press intensity threshold (e.g., “IT_{D}”). Contact 562 is maintained on touch-sensitive surface 560. In response to the detection of the gesture, and in accordance with contact 562 having an intensity that goes above the deep press intensity threshold (e.g., “IT_{D}”) during the gesture, reduced-scale representations 578A-578C (e.g., thumbnails) of recently opened documents for App 2 are displayed, as shown in FIGS. 5F-5H. In some embodiments, the intensity, which is compared to the one or more intensity thresholds, is the characteristic intensity of a contact. It should be noted that the intensity diagram for contact 562 is not part of a displayed user interface, but is included in FIGS. 5E-5H to aid the reader.

In some embodiments, the display of representations 578A-578C includes an animation. For example, representation 578A is initially displayed in proximity of application icon 572B, as shown in FIG. 5F. As the animation proceeds, representation 578A moves upward and representation 578B is displayed in proximity of application icon 572B, as shown in FIG. 5G. Then, representations 578A moves upward, 578B moves upward toward representation 578A, and representation 578C is displayed in proximity of application icon 572B, as shown in FIG. 5H. Representations 578A-578C form an array above icon 572B. In some embodiments, the animation progresses in accordance with an intensity of contact 562, as shown in FIGS. 5F-5G, where the representations 578A-578C appear and move upwards as the intensity of contact 562 increases toward the deep press intensity threshold (e.g., “IT_{D}”). In some embodiments, the intensity, on which the progress of the animation is based, is the characteristic intensity of the contact. The operations described with reference to FIGS. 5E-5H can be performed using an electronic device similar or identical to device 100, 300, or 500.

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards embodiments of user interfaces (“UI”) and associated processes that are implemented on an electronic device, such as device 100, device 300, or device 500.

Communications with respect to travel is often fraught with unknowns as related to usage fees, roaming charges, and other complications which a user does not experience when in a home geographic location. In some circumstances, a user may travel to an alternate geographic location expecting their Home SIM (Subscriber Identity Module) to provide the services included in their home cellular service plan without interruptions to their service or additional fees beyond their subscribed service plan. The use of multiple SIM profiles, inclusive of electronic SIMS (eSIM), provide an avenue to alleviate the confusion of travel service plans by providing a user a SIM which operates normally with local service providers corresponding to a destination.

The use of multiple SIM profiles comes with challenges specific to the management, usage, and activation of the respective SIMs in a manner which maximizes connectivity, minimizes excess fees and communication interruptions, as well as understanding how/where to source alternate SIM profiles. The embodiments below are directed toward providing feedback, notifications, queues, reminders, and/or automated processes surrounding the sourcing, application, activation, and/or management of multiple SIM profiles. It will be appreciated by those skilled in the art that a home geographic location as it relates to cellular service is optionally dependent upon the SIM profile, the service provider, a subscription plan corresponding to a Home SIM, and/or local settings at the electronic device. In some embodiments, traveling to a geographic location that requires a Travel SIM profile to mitigate continuity of communication functionalities, and/or excess fees corresponds to traveling to a different city, country, province, territory, and/or traveling to a region which is serviced by a different cellular service provider. The below examples are provided with the context of travelling from a first region corresponding to a first country (e.g., the United States) to a region (e.g., the European Union) corresponding to a plurality of countries.

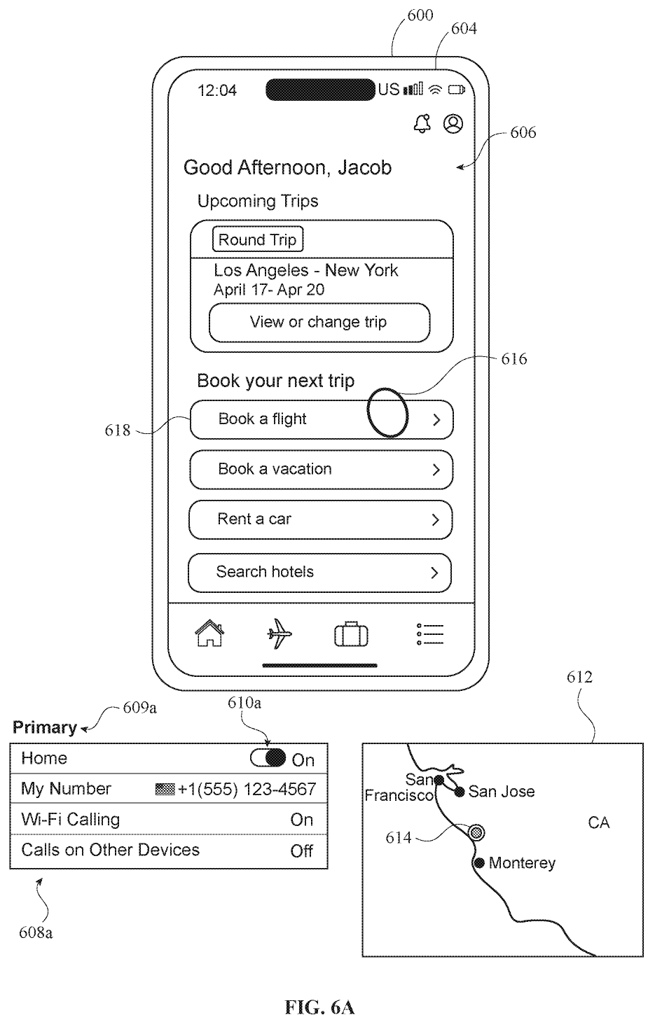

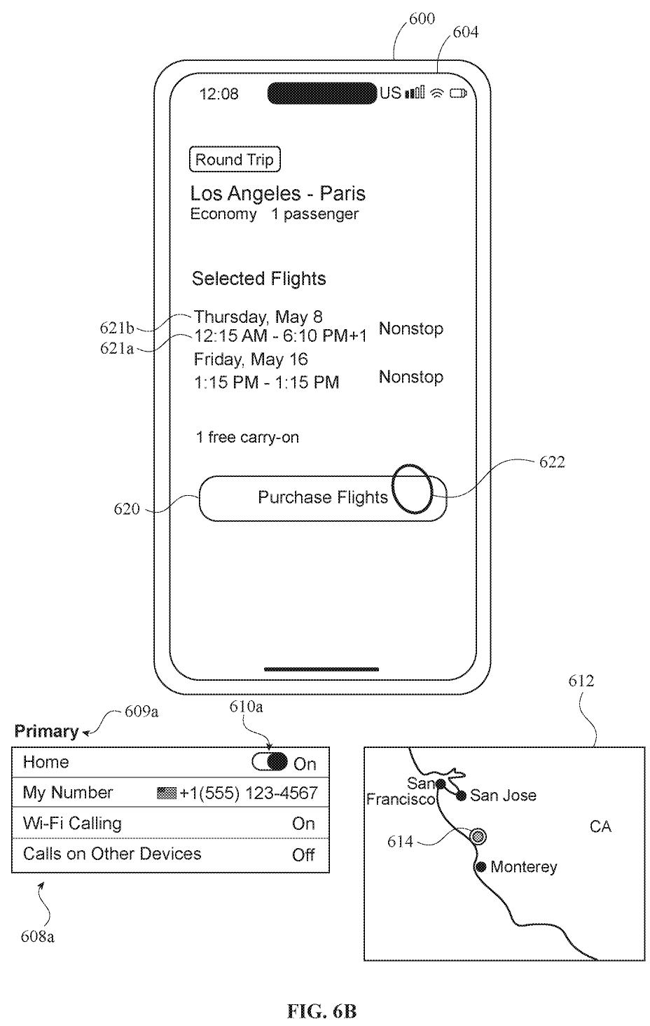

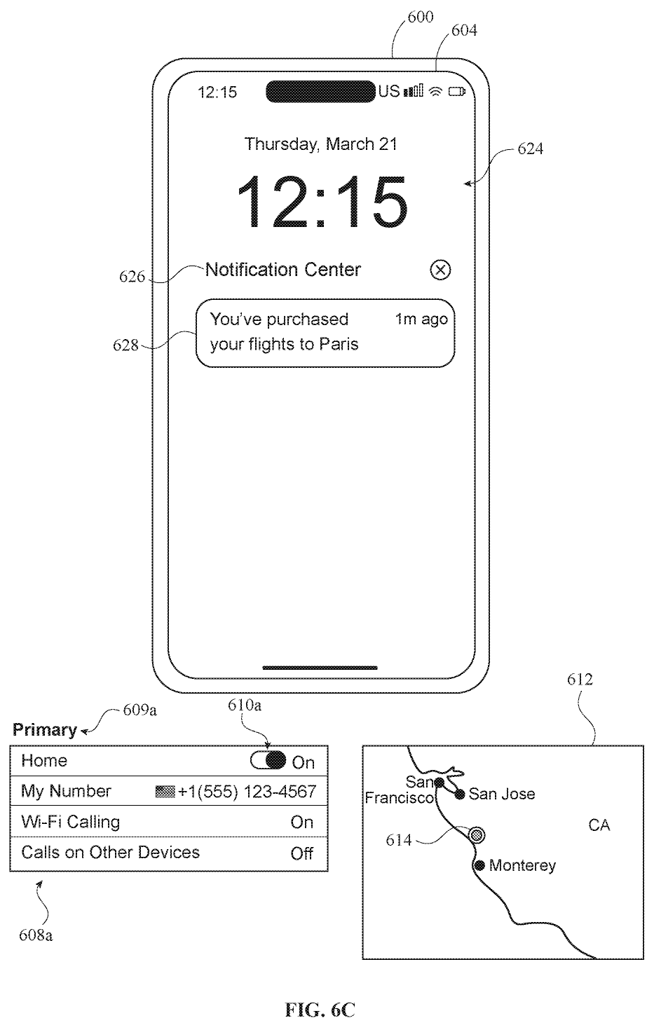

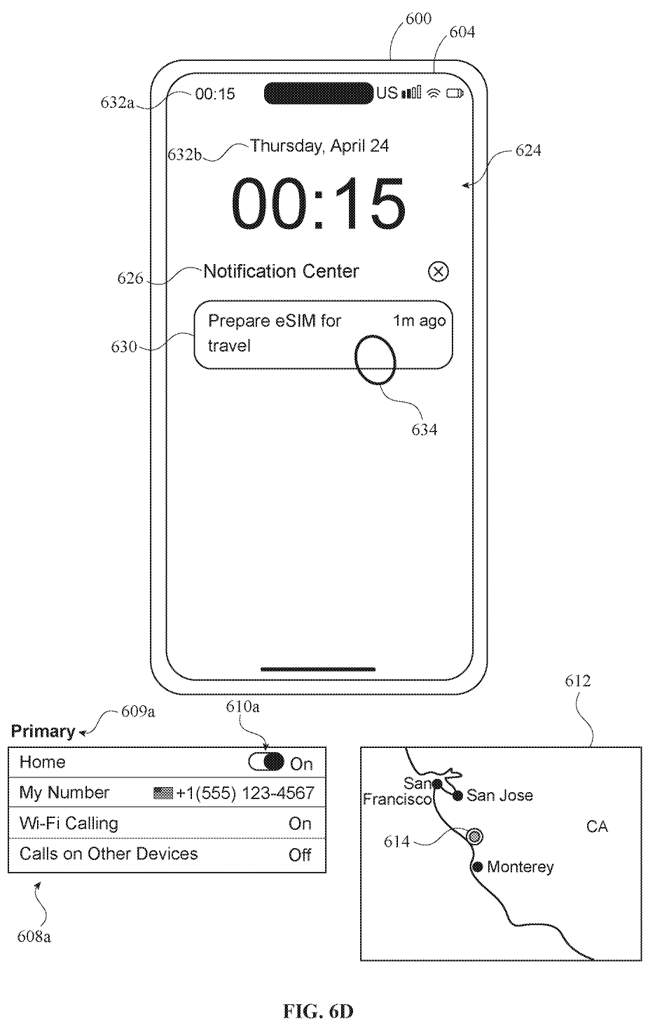

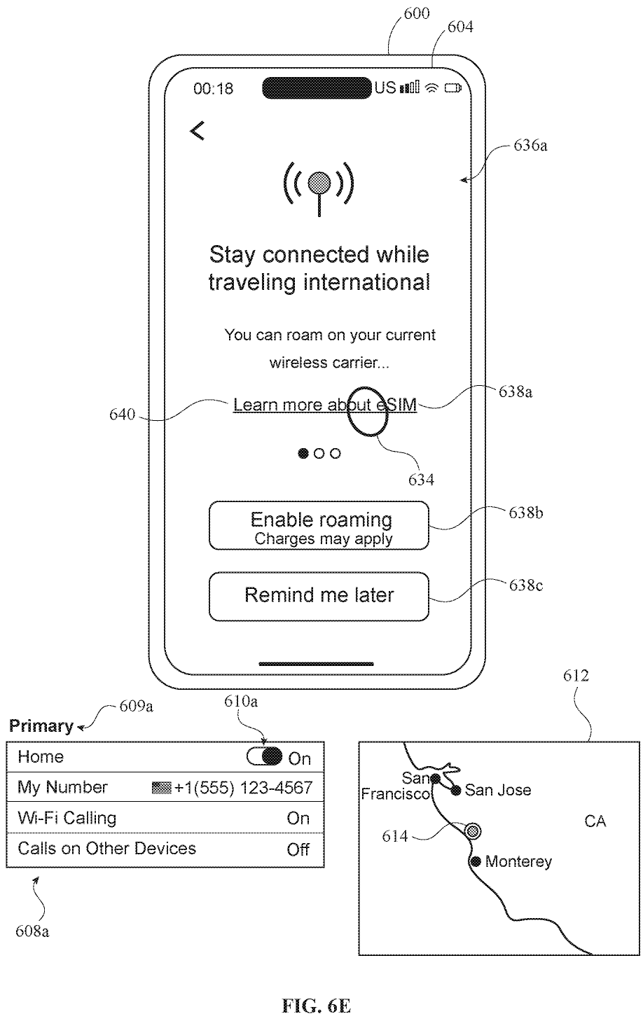

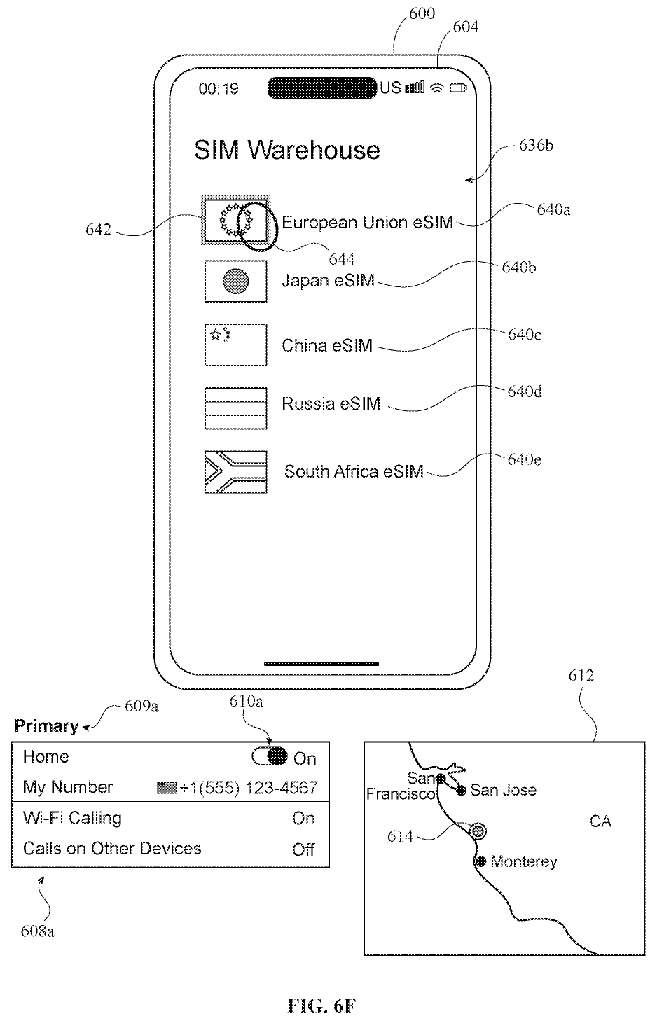

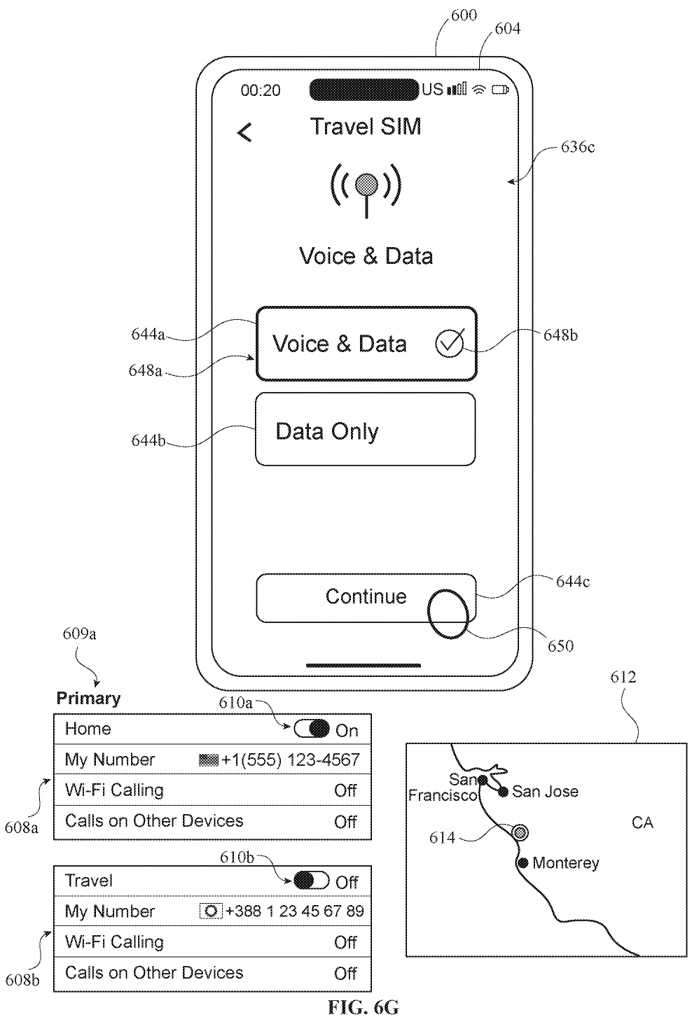

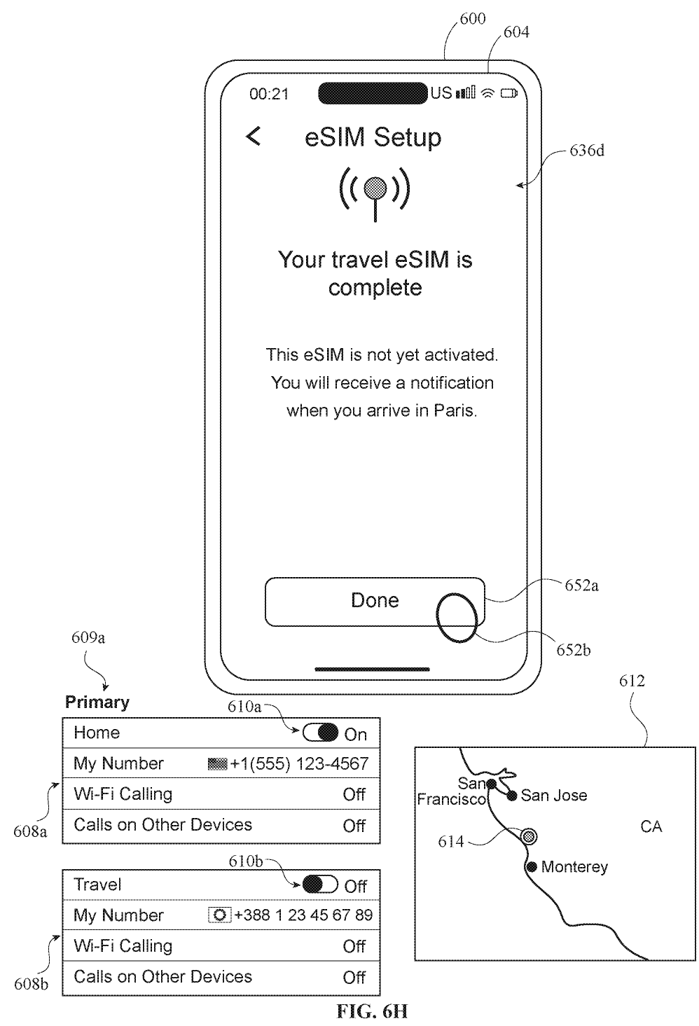

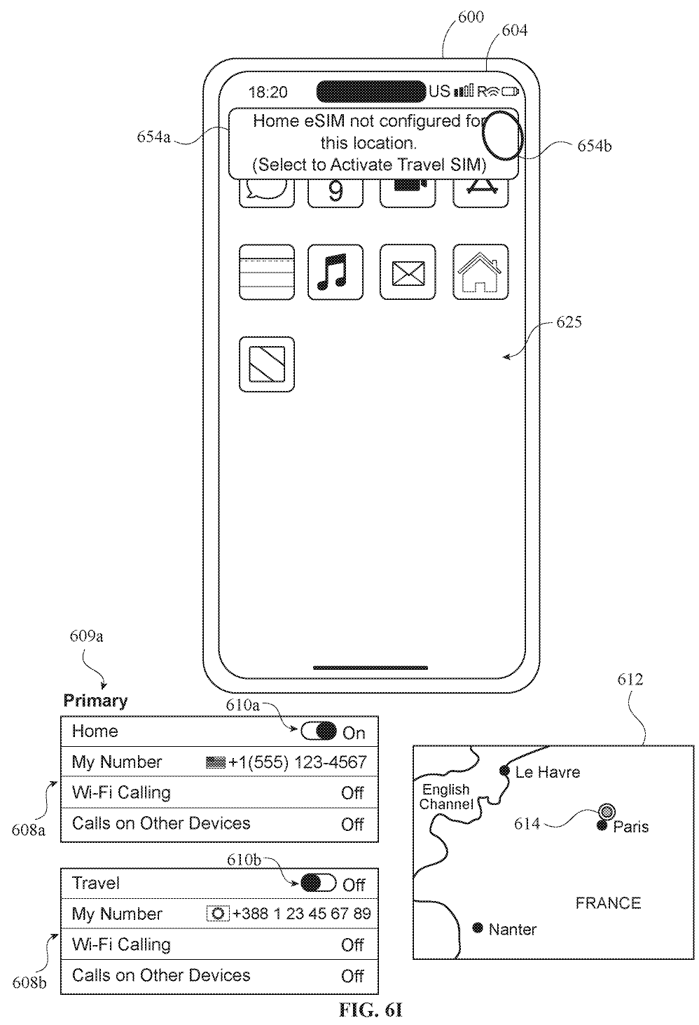

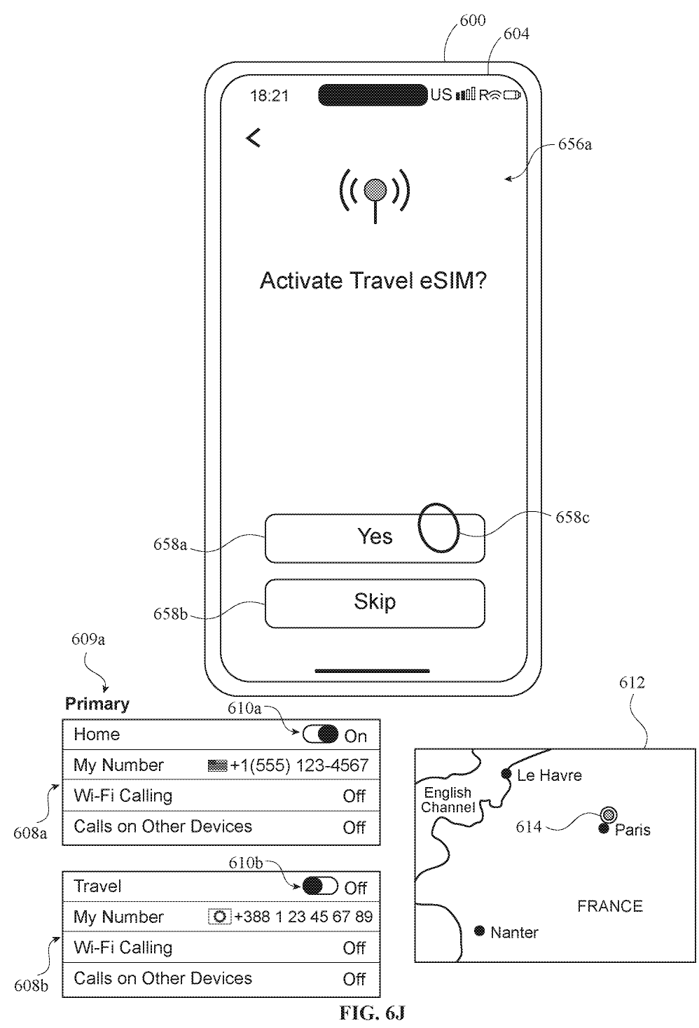

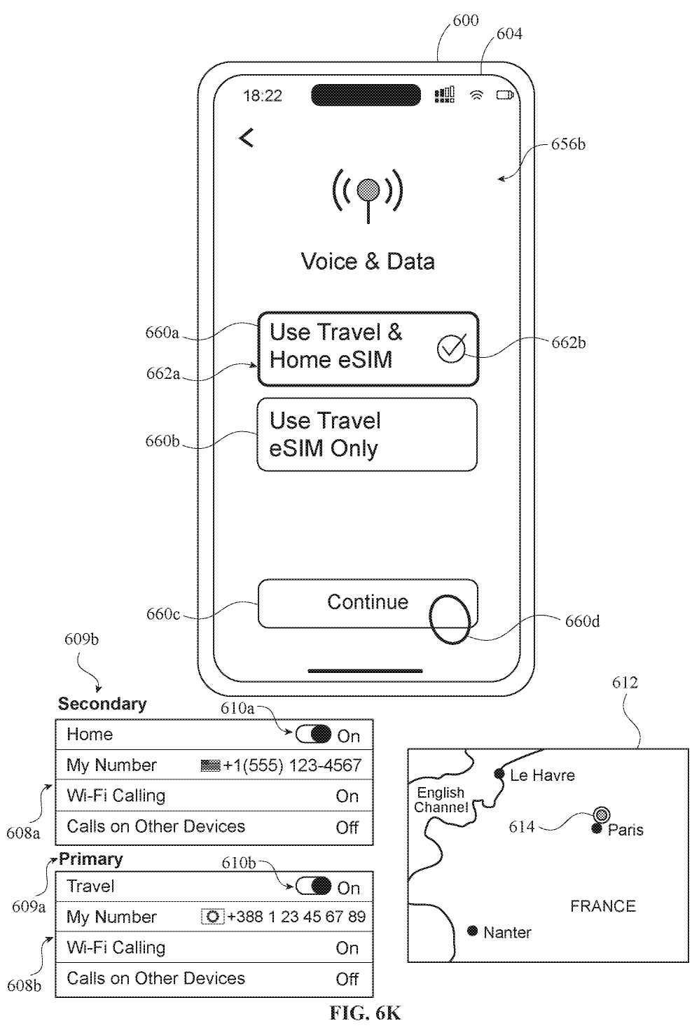

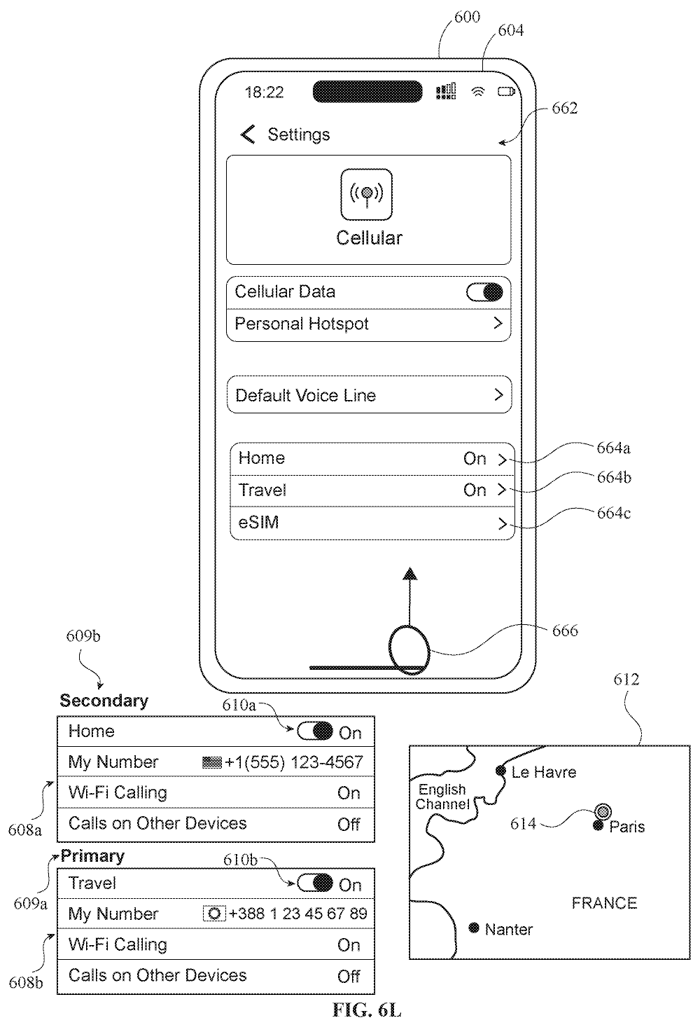

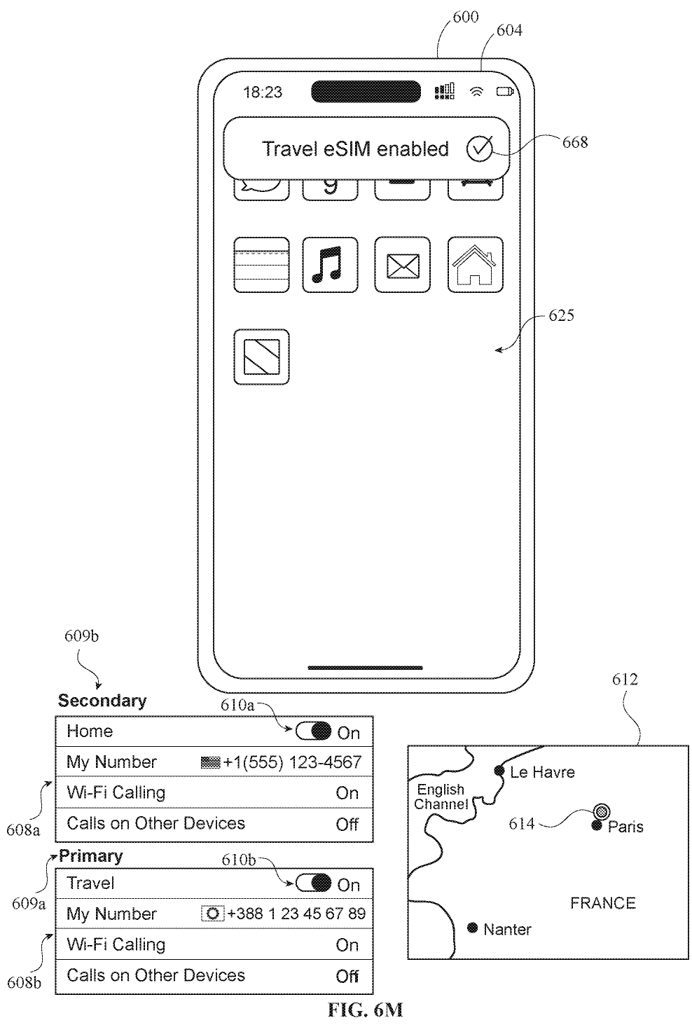

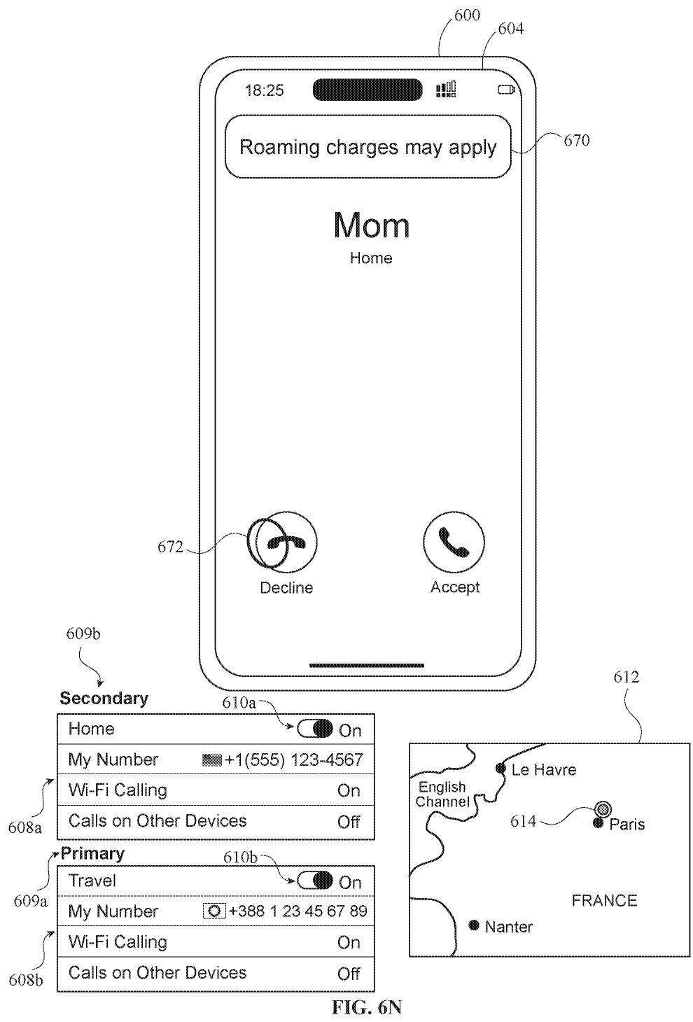

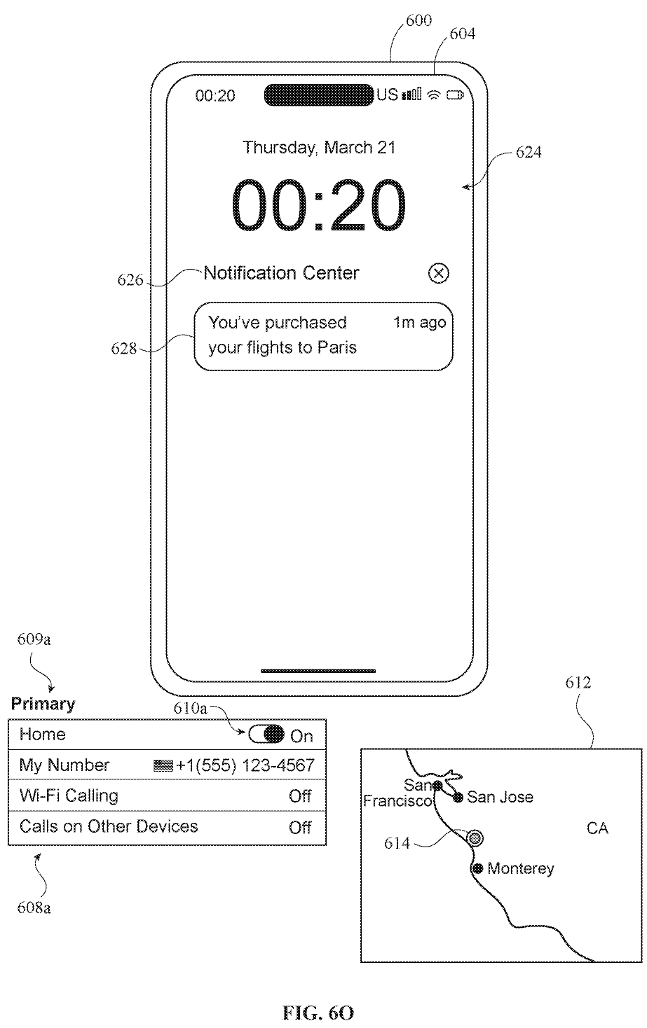

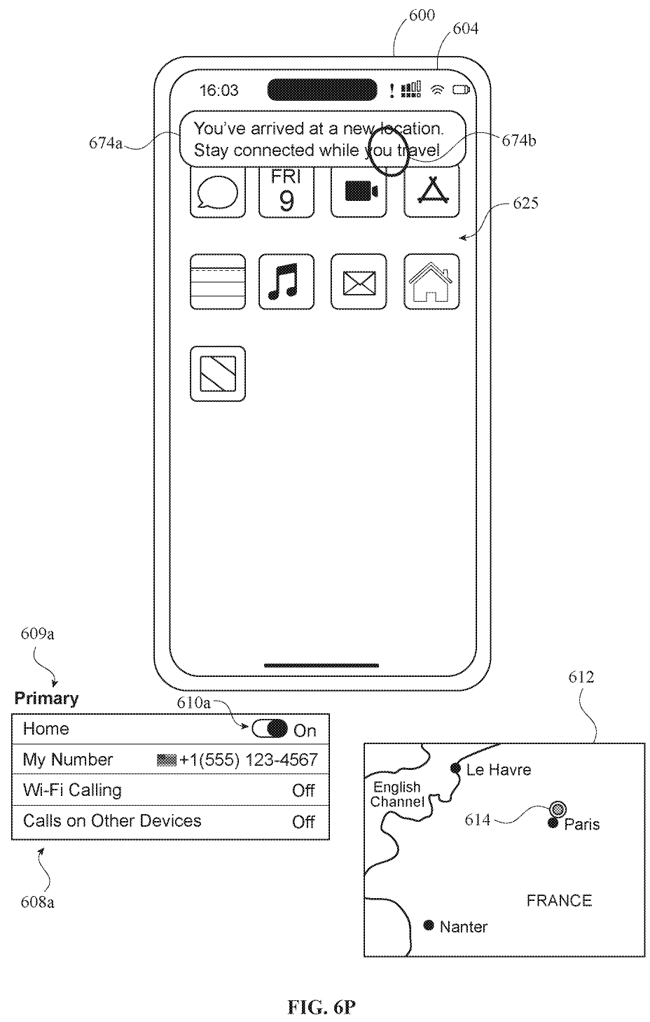

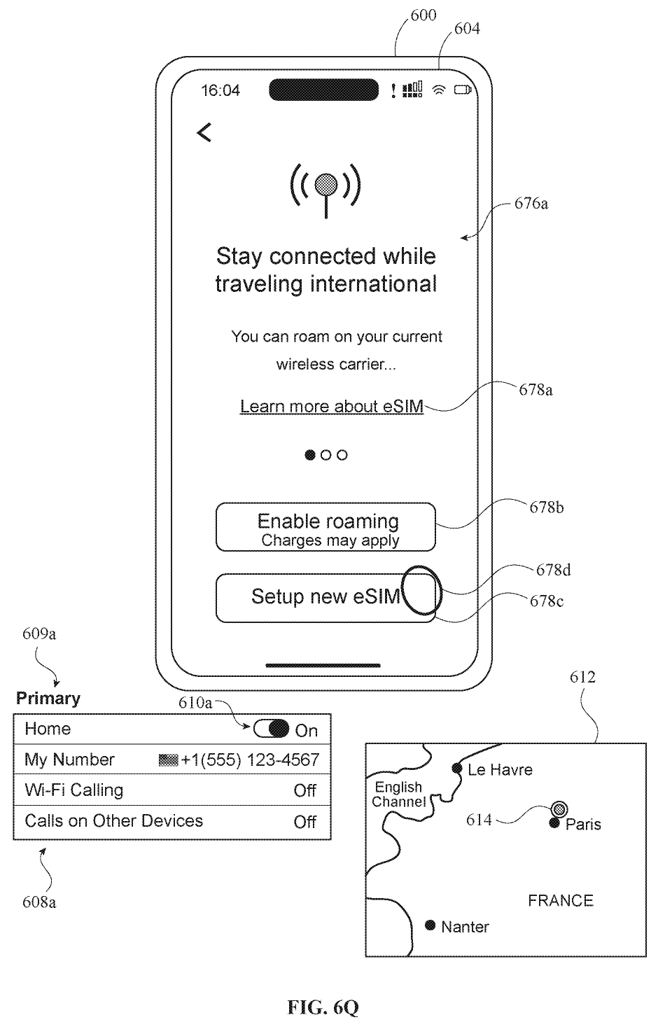

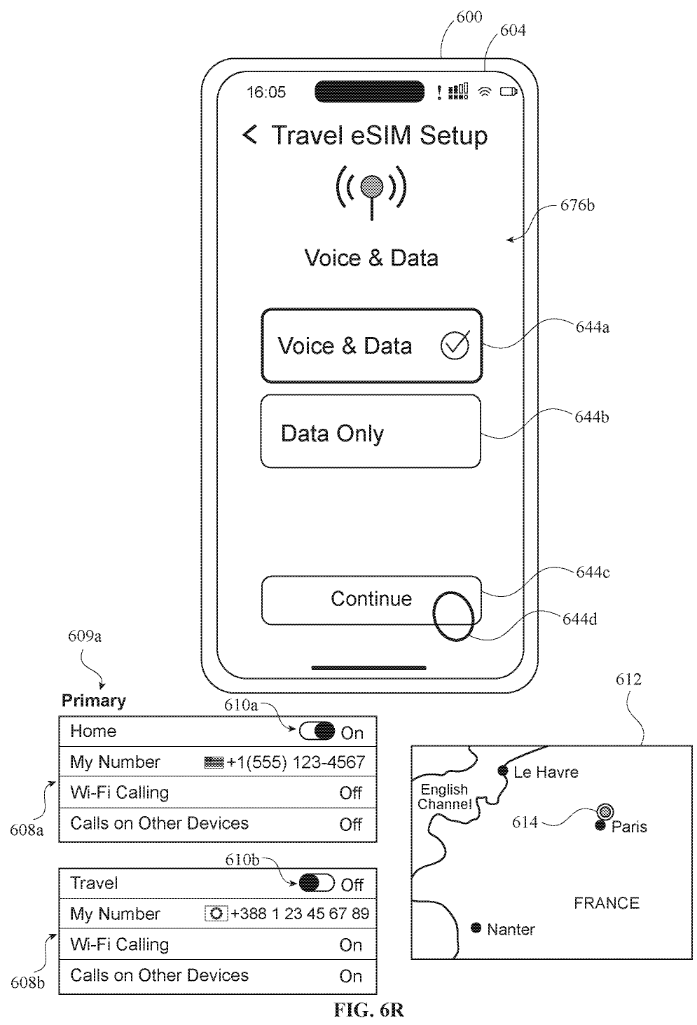

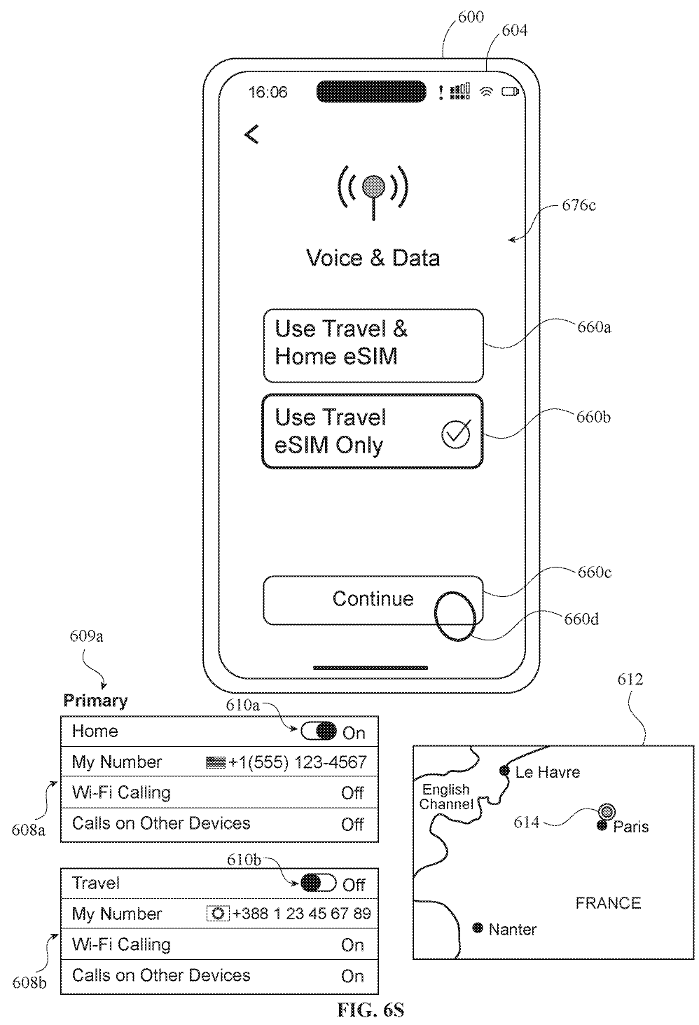

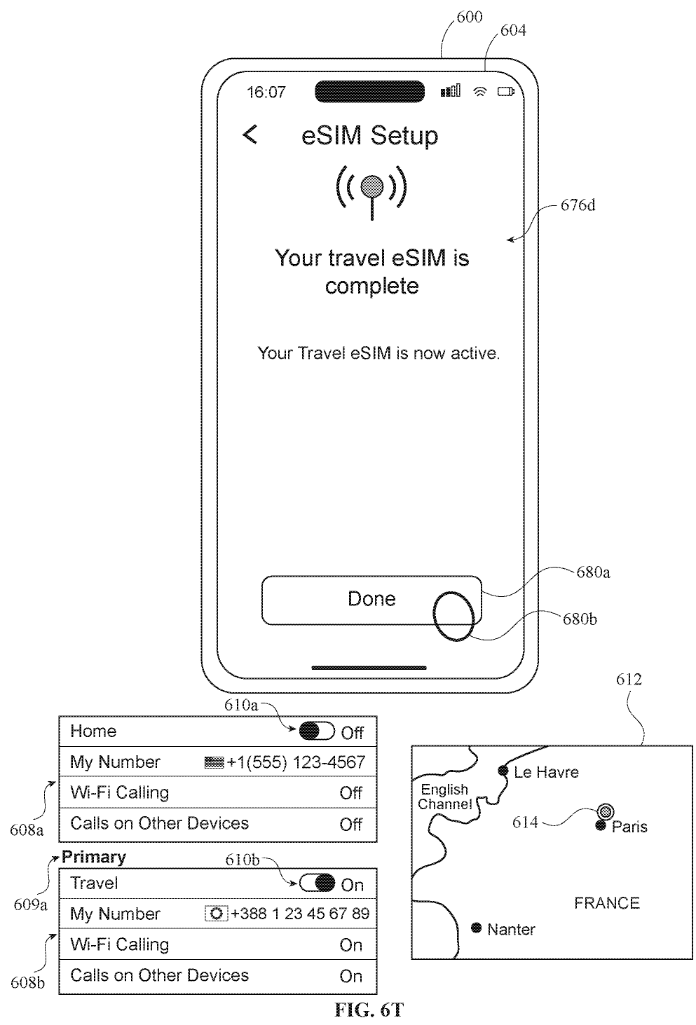

FIG. 6A–6T illustrate exemplary ways, based on one or more criteria, in which an electronic device initiates one or more operations to source, install, activate, provide notifications pertaining to and/or otherwise manage multiple SIM profiles based on the geographic location of the electronic device. The embodiments in these figures are used to illustrate the processes described below, including the processes described in FIG. 7 of how an electronic device is able to perform the forementioned operations and/or functionalities described below with respect to FIG. 7, it should be understood that these examples are not meant to be limiting, and the electronic device is able to perform one or more processes described below with reference to FIG. 7 in ways not expressly described with reference to FIGS. 6A–6T. In some embodiments, while the methods for managing multiple SIM profiles with respect to the geographic location of the electronic device are described in the context of user interface corresponding to a limited number of geographic locations and cursory examples, the context should be seen as exemplary, and should not be viewed as limiting to the disclosure. In some embodiments, the methods and processes described herein can be applied in multiple contexts where the use and/or management of alternate SIM profiles (e.g., other than a home SIM profile) are required at least partially based on the current geographic location of the electronic device.

As shown in FIG. 6A, the electronic device 600 is displaying, via a display generation component 604, a user interface which corresponds to travel plans for a first user (“Jacob”) at the electronic device. Also illustrated herein are SIM status panels such as the first SIM status panel 608a corresponding to the “Home” SIM profile which is indicated as being active via the toggle 610a, wherein the first SIM status panel 608a includes information corresponding to the number associated with the home SIM, and the status (e.g., on, or off) certain functionalities (e.g., Wi-Fi calling, allowing calls on other devices, etc.) associated with the home SIM. As shown, the SIM which is used as the primary SIM profile is indicated via a “primary” status indicator 609a. As shown the home SIM is the only SIM profile, and accordingly is the primary SIM profile in use. The first SIM status panel, and other SIM status panels illustrated herein, are for informational purposes corresponding to the status of a respective SIM, but may optionally correspond to one or more user interface which are accessible at the electronic device based on user input. For further informational purposes, the geographic location panel 612 provides the current geographic location of the electronic device, as detected by the electronic device. As illustrated, the electronic device is currently detected in Sata Cruz, California. While displaying the user interface corresponding to travel plans, the electronic device detects a user input 616 directed to a selectable user interface element which initiates one or more operations for purchasing flights from Los Angeles (LA) to Paris, as shown in FIG. 6B.

In FIG. 6B, based on the one or more operations resulting in purchasing a flight from LA to Paris, the electronic device is displaying a user interface including a selectable user interface element 620 which when selected corresponds to a purchase of the flights shown via the display generation component 604 at the electronic device 600. As shown via the geographic location panel 612, the electronic device is still detected as being in Santa Cruz when the user purchases the flights from LA to Paris.

As shown in FIG. 6C, after the operations corresponding to purchasing the fight from LA to Paris are complete, the electronic device now displays, based on user input and/or automatically, a home user interface 625. While displaying the lock screen interface, the electronic device detects an indication confirming purchase of the flight from LA to Paris, and notifies the user via a visual notification 628 displayed in a notification center 626 which is overlaid over the lock screen interface 624. The detection that the user has purchased a flight (as shown in FIG. 6A–6B), optionally results in the electronic device determining that the electronic device will travel from the home geographic location to a destination (Paris) which does not correspond to the home geographic location, such as when attempts to the use the Home SIM in Paris would result in inconsistent, or interrupted communications and/or result in increased cost due to roaming fees and the like, and thus requires a second SIM profile which ius configured for the destination of Paris. The determination that the electronic device is traveling to a destination that requires a second SIM is optionally based on the display of the visual notification 628, an addition of the departure of the flight to calendar application installed on the electronic device, or other indication of travel in advance of the electronic device detecting that it has arrived in the destination.

As shown in FIG. 6D, the electronic device displays a user interface element 630 which is selectable to initiate one or more operations to install a travel SIM corresponding to Paris, the destination of the LA to Paris flight. In the example shown, the electronic device displays the user interface element 630 based on the time remaining between the current time 632a and date 632b at the electronic device as compared to a time and date of the detected planned travel to be two weeks or less. As shown, the current time and date at the electronic device are within a predetermined time period (e.g., two weeks as illustrated) of the time 621a and date 621b of travel departure (see FIG. 6B). As further shown in 6D, the user interface element 630 includes information alerting the user to prepare a SIM for the destination in advance of the date of travel, and selection of the user interface element results in initiating one or more operations for sourcing and installing a Travel SIM profile for use in the destination. Alternate embodiments, not illustrated, optionally include a predetermined time period corresponding to more than 2 weeks, 1 week, 3 days, 12, hours, 1 hour, and/or less than an hour from the time and date corresponding to travel departure. While displaying the user interface element 630, the electronic device detects a user input 634 corresponding to the selection of the user interface element 630.

In response to detecting the user input 634 in FIG. 6D, the electronic device displays, as shown in FIG. 6E, a first SIM setup user interface 636a which includes multiple selectable user interface elements. A first user interface element 638a is selectable to initiate learning about the options for setting up a travel SIM. A second user interface element 638b is selectable to activate the current primary SIM profile 609a to allow roaming and allow the use of the Home SIM in the destination, which may result in additional fees corresponding to using the Home Sim on a network which it isn’t configured for use on. A third user interface element 638c is selectable to defer the decision of installing a travel SIM profile on the electronic device until a later date when the electronic device optionally reminds the user and/or the user initiates the installation process without further prompt from the electronic device. As illustrated, the electronic device detects a user input 634 directed to the first user interface element 638a which corresponds to a request to source and/or activate a SIM for the destination of Paris.

In response to detecting the user input 634, shown in FIG. 6F, the electronic device displays a second SIM setup user interface 636b which corresponds a website and/or application installed on the electronic device which includes a plurality of SIM profiles 640a–640e for sourcing (e.g., purchase, or free with paid usage) which a user is able to purchase for installation on the electronic device. As shown, the SIM profile which is configured for the destination of Paris (e.g., European Union eSIM 640a) includes highlighting 642 to indicate to a user that the respective SIM profile is configured for use in the destination of Paris. While displaying the second SIM setup user interface 636b including the plurality of SIM profiles, the electronic device detects a user input corresponding to a selection of the European Union eSIM 640a which corresponds to a selection to source the respective eSIM for installation on the electronic device as a Travel SIM. After completing the sourcing of the European Union eSIM 640a (e.g., including payment and/or completing additional information) the electronic device proceeds to display a third SIM setup user interface 636c (shown in FIG. 6G) which allows the user to provide one or more inputs to configure the selected SIM profile.

In some embodiments, the operating system of the electronic device provides an Application Programming Interface (API) for use by developers of sources (e.g., applications) for obtaining eSIMs or other configurations to provide, to the electronic device and/or the operating system of the electronic device, information about the obtained eSIM or other configuration. For example, in response to detecting input for obtaining the European Union eSIM in the user interface displayed in FIG. 6F, the application associated with that user interface is able to provide, via the API, information about the European Union eSIM that was obtained to the electronic device and/or the operating system of the electronic device. The information provided optionally includes information about the regions and/or countries in which the obtained eSIM can operate or is compatible (e.g., the European Union), and/or whether the obtained eSIM supports voice and data functionality, or only data functionality (without voice functionality), or only voice functionality (without data functionality). In some embodiments, the electronic device and/or the operating system of the electronic device is able to determine or extract the above information based on the content of the eSIM, without the need for the above-described API or information provided via the above-described API.

In some embodiments, the response of the electronic device to the above-described information about the eSIM differs depending on the existence of the information and/or the content of the information (e.g., the electronic device optionally modifies aspects of the setup process for the obtained eSIM based on the information). For example, if the electronic device does not have access to the above-described information (e.g., because the application has not provided it via the API, and because the electronic device is not able to determine or extract the information based on the content of the eSIM), the electronic device optionally displays a user interface (e.g., after FIG. 6F, and before FIG. 6G, or at a different time during the setup process for the obtained eSIM) that requests input from the user to indicate whether the obtained eSIM is going to be used in the user’s home geography, or in a travel location – and if in a travel location, which travel location (e.g., which country and/or region). In response to user input in that user interface, the electronic device optionally associates the obtained eSIM with a particular geography based on the user input, and uses that geography information in the ways described with reference to methods 700 and/or 900. As another example, if the above-described information indicates that the obtained eSIM supports only data functionality (without voice functionality), the electronic device optionally skips display of (e.g., does not display) the user interface shown in FIG. 6G after the user interface shown in FIG. 6F, and instead proceeds to display of the user interface shown in FIG. 6H.

As shown in FIG. 6G, the electronic device displays the third SIM setup user interface 636c including a first user interface element 644a which is selectable to configure the Travel SIM (e.g., European Union eSIM) for use with voice functionalities and data functionalities, a second user interface element 644b which is selectable to configure the Travel SIM for use with data functionalities only, and a third user interface element 644c which is selectable to save the elections of the user with regard to the forementioned selected functionalities. As shown the Travel SIM profile, as represented in second SIM status panel 608b, is installed on the electronic device but is not yet activated as indicated by toggle 610b. Furthermore, the location of the electronic device is still detected as being in Santa Cruz, which corresponds to being in the home geographic location which corresponds to the Home SIM. When displaying the third SIM setup user interface 636c, the electronic device indicates that the first user interface element 644a has been preselected (e.g., by default) as indicated by the bold outline 648a and checkmark 648b. While displaying the third SIM setup user interface, the electronic device detects a user input 650 to the third user interface element 644c corresponding to a request to save the setup of the Travel SIM to include voice functionalities and data functionalities.

As shown in FIG. 6H, in response to detecting the user input 650 (seen in FIG. 6G) the electronic device displays a fourth SIM setup user interface 636d including information corresponding to the configuration of the Travel SIM, the status of the Travel SIM (e.g., inactive) and when the user should expect a notification corresponding to the activation of the Travel SIM. Included in the fourth SIM setup user interface 636d is a user interface element 652a which is selectable to save the configuration elections and exit the SIM setup user interface and return to the home screen and/or other application which was actively used when the user initiated the SIM setup user interface process. As shown, the electronic device detects a user input 652b to the user interface element 652a corresponding to saving the configuration elections for the Travel SIM and exit the SIM setup user interface. Accordingly, as indicated by the geographic location panel 612, the user has successfully sourced, installed, and configured their Travel SIM for the destination (e.g., Paris) while the electronic device is still detected in the Home geographic location (e.g., Santa Cruz).

As shown in FIG. 6I, the electronic device detects that the current geographic location of the electronic device no longer corresponds to the Home geographic location, and now corresponds to the Destination and corresponds to the Travel SIM which was sourced and installed on the electronic device prior to the electronic device’s arrive in the Destination. In response to detecting the arrival of the electronic device in the Destination (e.g., Paris), the electronic device presents a notification 654a which is overlaid over the home user interface 625, which is selectable to initiate activation of the Travel SIM which corresponds to the Destination. The notification 654a includes information corresponding to the Home SIM in relation to the Destination, wherein the Home SIM is not configured for use in the Destination. The notification 654 optionally includes information including that selection of the notification 654 corresponds to a request to initiate the one or more operations for activating the Travel SIM. When the electronic device detects a user input 654b to the notification 654a, the electronic device initiates one or more operations to activate the Travel SIM.

As shown in FIG. 6J, in response to detecting the user input 654b to the notification 654a, the electronic device displays a first SIM activation user interface 656a including a first user interface element 658a which is selectable to activate the Travel SIM, and a user interface element 658b which is selectable to skip activation of the Travel SIM. As shown, the electronic device detects a user input 658c which corresponds to the selection of the first user interface element 658a to activate the Travel SIM.

As shown in FIG. 6K, the electronic device displays a second SIM activation user interface 656b, in response to detecting the user input 658c which corresponds to the selection of the first user interface element 658a to activate the Travel SIM (shown in FIG. 6J). The second SIM activation user interface includes a first selectable user interface element 660a which corresponds to configuring the electronic device to use the Travel SIM as a primary SIM profile, a second user interface element 660b, the selection of which corresponds to configuring the electronic device to use the Travel SIM as the primary SIM profile and deactivating the Home SIM, and a third user interface element 660c which corresponds to saving the elected configuration option. As shown, the first user interface element 660a includes a bold outline 662a and checkmark 662b to indicate preselection (e.g., by default) the first user interface element. At this time, as indicated by the status panels 608a–608b, the Home SIM and the Travel SIM are currently active, with the Travel SIM serving as the primary SIM profile 609a and the Home SIM serving as the Secondary 609b SIM profile. Proceeding with the selection of the first user interface element 660a (e.g., as preselected by the electronic device) would maintain the default configuration as presented in FIG. 6K. Proceeding with a selection of the second user interface element 660b would result in the deactivation of the Home SIM and proceeding with the Travel SIM as the Primary (and only) active SIM profile. As further shown, the preselected configuration includes the activation of the Wi-Fi calling for calls made and/or received via the Home SIM to reduce the possibility of incurring usage and/or roaming fees while in the second geographic location which the Home SIM is not configured for use in. As further shown in FIG. 6K, the electronic device detects a user input 660d to the third user interface element 660c which saves the election, corresponding to the first user interface element 660a in this scenario.

In some embodiments, as part of the activation process shown in FIGS. 6J to 6K for the Travel SIM, the electronic device displays a user interface that requests input from the user relating to whether or not to enable a low data mode for the Travel SIM. In response to detecting selection of a selectable option to enable low data mode for the Travel SIM, the electronic device optionally enables low data mode for the Travel SIM, and in response to detecting selection of a selectable option to not enable low data mode for the Travel SIM, the electronic device optionally does not enable low data mode for the Travel SIM. In some embodiments, if low data mode is turned on for the Travel SIM, when the electronic device is configured to use the Travel SIM for data, one or more of the following changes may occur: applications might stop using cellular data when the user is not actively using them; applications that have been sent to the background on the device (e.g., applications that are currently active, but do not currently have a full user interface displayed on the device), optionally based on user input, may not be refreshed; the quality of streaming content might be reduced; automatic downloads and backups may be turned off; and/or services such as cloud-based content storage services may pause updates.

As shown in FIG. 6L, in response to detecting the user input 660d to save the elections pertaining to the configuration of the Travel SIM and the Home SIM, the electronic device displays a settings user interface 662 which includes options to view, and/or modify configuration settings pertaining to one or more installed SIM profiles on the electronic device. For instance a first user interface element 664a is selectable to view and/or modify configuration settings for the Home SIM, a second user interface element 664b is selectable to view and/or modify configuration settings for the Travel SIM, and a third user interface element 664c is selectable to source a SIM which is not already installed on the electronic device, such as illustrated in FIGS. 6F-6H. In some embodiments, when the electronic device receives the user input 660d to save the elections pertaining to the configuration of the Travel SIM and the Home SIM, the electronic device optionally foregoes displaying the settings user interface 662 and reverts to displaying a home user interface or other application which was actively being used when the user input 654b was detected to the notification 654a such as shown in FIG. 6I. As shown in FIG. 6L, the electronic device detects a user input, such as an upward swipe 666 which corresponds to a request to dismiss the settings user interface 662 and display a home user interface.

As shown in FIG. 6M, the electronic device now displays the home user interface 625 with a visual notification 668 indicating to the user that the Travel SIM is activated. As indicated by the SIM status panels 608a–608b, the Travel SIM is active and configured for use as the Primary SIM profile 609a and the Home SIM is active and configured for use as the secondary SIM profile 609b.

As shown in FIG. 6N, the electronic device receives a call from “Mom” while in Paris, wherein the call from “Mom” is directed to the phone number associated with the Home SIM. The electronic device does not currently have Wi-Fi reception and thus in order to answer the call, the electronic device would require the use of the Home SIM with potential roaming fees. As a result, the electronic device displays a notification 670 which alerts the user to the possible roaming charges which may apply in the event the user answers the call as received. As shown, the electronic device detects the user input 672 corresponding to a request to dismiss the phone call, thereby allowing the user to optionally call “Mom” back via cellular functions using the Travel SIM, and/or via an application installed on the electronic device using a voice-over-internet functionality or the like to be able to call back without the costs associated with roaming usage.

FIG. 6O–6T provides an example of one or more operations for sourcing and/or activating a Travel SIM such as if the Travel SIM was not installed at the electronic device prior to the arrival of the electronic device 600 to a destination (e.g., Paris) for which the Home SIM profile is not configured for use.

As shown in FIG. 6O, the electronic device 600 receives an indication of future travel and displays a visual notification 628 indicating future travel, however a Travel SIM is not installed at the second electronic device such as if the user provides an input to dismiss sourcing and/or installation of a Travel SIM via selection of the third user interface element 638c corresponding to “Remind me later” when the electronic device displays the first SIM setup user interface 636a as shown in FIG. 6E.

As shown in FIG. 6P, when the electronic device detects that the electronic device has arrived in a geographic location that the Home SIM profile Is not configured for, the electronic device displays a visual notification 674a overlaid on the home user interface 625 alerting the user that they have arrived at a geographic location (e.g., Paris) that the Home SIM, currently in use as the primary SIM profile 609a, is not configured for use in, and may result in communication interruptions and/or additional usage fees. The visual notification 674a is selectable to initiate one or more operations for sourcing, installing, and/or activating a Travel SIM for use in the destination. As shown, the electronic device detects the user input 674b directed to the visual notification corresponding to a request to initiate the one or more operations to install a Travel SIM.

As shown in FIG. 6Q, the electronic device displays a first SIM setup user interface 676a which includes a first user interface element 678a which is selectable to learn more about eSIMs, a second user interface element 678b which is selectable to enable roaming for the primary SIM profile 609a (e.g., Home SIM profile 608a), and a third user interface element 678c which is selectable to continue the one or more operations for installing a Travel SIM profile. As shown the electronic device detects a user input 678d to the third user interface element which corresponds to a request to continue the one or more operations for installing a Travel SIM profile. Following the detecting of the user input 678d to continue the one or more processes to install a Travel SIM profile, the electronic device optionally directs the user to a digital location such as a website for sourcing a SIM which corresponds to the destination such as shown in FIG. 6F previously.

After the Travel SIM profile is selected and installed at the electronic device, such as shown via the second SIM status panel 608b in FIG. 6R, the electronic device displays a second SIM configuration user interface 676b for the Travel SIM which corresponds to selecting the functionalities for which the Travel SIM will be used for. The first SIM configuration user interface includes first user interface element 644a which is selectable to configure the Travel SIM (e.g., European Union eSIM) for use with voice functionalities and data functionalities which is preselected by default by the electronic device, a second user interface element 644b which is selectable to configure the Travel SIM for use with data functionalities only, and a third user interface element 644c which is selectable to save the elections of the user with regard to the forementioned selected functionalities. As shown the Travel SIM profile, as represented in second SIM status panel 608b, is installed on the electronic device but is not yet activated as indicated by toggle 610b. As shown, the electronic device detects a user input 644d to the third user interface element 644c corresponding to a request to save the setup of the Travel SIM to include voice functionalities and data functionalities.

As shown in FIG. 6S, after detecting the user input 644d to the third user interface element 644c as shown in FIG. 6R, the electronic device displays a third SIM configuration user interface 676c which includes a first user interface element 660a, the selection of which corresponds to configuring the electronic device to use the Travel SIM as a primary SIM profile, a second user interface element 660b, the selection of which corresponds to configuring the electronic device to use the Travel SIM as the primary SIM profile and deactivating the Home SIM, and a third user interface element 660c which corresponds to saving the elected configuration option. As shown, the electronic device has detected a user input 660d which corresponds to a selection of the second user interface element 660b, electing to use only the Travel SIM and is shown detecting a user input 660d to save the election.

Accordingly, following detecting the selection to the second user interface element 660b, corresponding to electing to use only the Travel SIM, the electronic device displays a confirmation user interface 676d which indicates that the Travel SIM 608b has been installed and activated, as further shown with respect to the second SIM status panel 608b. According to the detected user inputs, the Travel SIM as indicated by the toggle 610b in the second SIM status panel 608b, and is being used as the primary SIM profile 609a, while the Home SIM 608a has been deactivated as indicated by the toggle 610a. The detection of a user input 680b directed toward a first user interface element 680a corresponding to a termination of the one or more operations to install the Travel SIM optionally exits the SIM setup user interface and reverts the electronic device to displaying the home user interface and/or user interface of an application which was actively being used when the electronic device initiated the one or more operations for installing a Travel SIM.

FIG. 7 illustrates a flow diagram illustrating a method in which an electronic device detects an indication of future travel to a second geographic location, and initiates one or more operations for installing a configuration for use in a second geographic location. The method 700 is optionally performed at first electronic device and/or electronic devices such as device 100, device 300, or device 500 as described above with reference to FIGS. 1A-1B, 2-3, 4A-4B and 5A-5H. Some operations in method 700 are, optionally combined and/or order of some operations is, optionally, changed.

The devices, methods, and/or computer-readable storage mediums described below enhance the operability of the device and makes the user-device interface more efficient (e.g., by helping the user to provide proper inputs and reducing user mistakes when operating/interacting with the device) which, additionally, reduces power usage and/or improves battery life of the device by enabling the user to use the device more quickly and efficiently. Performing an operation when a set of conditions has been met without requiring further user input (such as by initiating the one or more operations corresponding to installing the second configuration when the electronic device detects an indication of future travel that will include the electronic device traveling from the current geographic location of the electronic (e.g., first geographic location) to a different geographic location (e.g., second geographic location) enhances the operability of the device by reducing unnecessary inputs and/or steps to navigate through different user interfaces or sets of controls, reducing energy usage by the device.

In some embodiments, method 700 at FIG. 7 is performed at an electronic device, in communication with a display generation component and one or more input devices. For example, the electronic device is a mobile device (e.g., a tablet, a smartphone, a media player, or a wearable device) including wireless communication circuitry, optionally in communication with one or more of a mouse (e.g., external), trackpad (optionally integrated or external), touchpad (optionally integrated or external), remote control device (e.g., external), another mobile device (e.g., separate from the electronic device), a handheld device (e.g., external), and/or a controller (e.g., external), etc.). In some embodiments, the display generation component is a display integrated with the electronic device (optionally a touch screen display), external display such as a monitor, projector, television, or a hardware component (optionally integrated or external) for projecting a user interface or causing a user interface to be visible to one or more users, etc. In some embodiments, the first electronic device to a first user wherein inputs received at the first electronic device are associated with the first user.

In some embodiments, such as shown in FIG. 6C, while in a first geographic location and while a first configuration corresponding to the first geographic location is installed and active at the electronic device (e.g., method step 701 at FIG. 7), the electronic device detects (e.g., method step 702 at FIG. 7) an indication of future travel (e.g., notification 628) (e.g., email, text confirmation, application generated confirmation, message from a second electronic device, etc.) of the electronic device from the first geographic location (e.g., current geographic location 614) to a second geographic location (e.g., Paris) , different than the first geographic location. (e.g., first country, area served by a first carrier, etc.). In some embodiments the electronic device detects, (e.g., via GPS module, communications module, etc.) the geographic location of the electronic device. While the geographic location of the electronic device (e.g., first geographic location) corresponds with the first configuration (e.g., first Subscriber Identity Module (SIM)), the electronic device uses the first configuration. While examples provided surround configurations corresponding to SIM configurations (e.g., SIM, electronic SIM (eSIM), and/or integrated SIM (iSIM) configurations), the disclosure provided herein is not limited thereto. In some embodiments the various configurations discussed herein (e.g., first configuration, second configuration, etc.) include, but are not limited to, configurations changes based on the geographic location of the electronic device. For instance, a configuration optionally corresponds to power profiles (e.g., 110V, 220V, etc.), language profiles (e.g., English, Italian, Japanese, etc.), and/or units (e.g., Imperial or metric). The electronic device optionally includes configurations which are installed (e.g., saved) to the memory of the electronic device which are configured for use in certain regions and/or certain carriers which are inactive such that they are not used for communications while inactive (e.g., and are optionally not powered). Inactive configurations are optionally activated (e.g., optionally powered up) in response to an activation event (e.g., activation process, user input, etc.), and active configurations are optionally deactivated in response to a deactivation event (e.g., deactivation process, user input, etc.) wherein deactivated configurations are not required to be deleted from memory. In some embodiments, the electronic device is only able to maintain a predetermined number (e.g., two, three, four, etc.) of configurations in an active state, and when the maximum number of active configurations are reached, an active configuration must be deactivated to allow for the activation of an inactive configuration. For instance, while a smart phone detects that it is within services provided corresponding to the United States the electronic device optionally uses a SIM, installed on the electronic device, which is configured for use within the boundaries of the United States. For further example, while a smart phone detects that it is within a geographic location served by a first wireless communications carrier (e.g., cellular communications carrier, and/or other wireless networking technology carrier), the smart phone uses a SIM which corresponds to the first wireless communications carrier which serves the geographic location which corresponds to the current geographic location of the electronic device. In some embodiments, the electronic device includes a first configuration (e.g., first SIM) installed on the electronic device and a second configuration installed on the electronic device. In some embodiments, when the electronic device includes a first configuration and a second configuration installed on the electronic device, the first configuration and the second configuration are optionally active (e.g., the first configuration and the second configuration correspond to the first geographic location), the first configuration is optionally active and the second configuration is optionally inactive (e.g., the first configuration corresponds with the current geographic location of the electronic device, and the second configuration does not correspond with the current geographic location of the electronic device), and/or the first configuration and the second configuration are both inactive (e.g., both the first configuration and the second configuration do not correspond to the current geographic location of the electronic device). In some embodiments, a configuration can be activated and/or deactivated via user input requesting such a change. A user input, as referred to herein, optionally includes touch input, input via a device in digital communication with the electronic device (e.g., keyboard, mouse, stylus, etc.), voice input, gaze, and/or user movement of the electronic device. Additionally or alternatively, a user may optionally activate or deactivate a configuration regardless of the compatibility or incompatibility with the current geographical location of the electronic device. In some embodiments, the status (e.g., active or inactive) of the first configuration and/or the second configuration rely upon the current geographic location of the electronic device, predetermined criteria (e.g., preferences as determined by the user of the electronic device), and/or subject to actions performed by a user or one or more automated processes to active and/or deactivate the configurations. In some embodiments the electronic device detects and/or receives an indication of potential travel corresponding to a user of the electronic device. In some embodiments, an indication of travel includes confirmation of travel booking (e.g., flight, hotel, car rental, and/or other travel related arrangements) received via one or more communication methods (e.g., text, email, text message), content of a digital wallet (e.g., corresponding to airline tickets), and/or notification corresponding to a travel related application) wherein the indication of travel corresponds to travel from a first geographic (e.g., the current geographic location of the electronic device) location to a second geographic location. In some embodiments, the indication of travel is sent to and/or received via a phone number of the user, email of the user, or other communication-based identity corresponding to the user. In some embodiments an indication of travel corresponds to a message received at the electronic device addressed to a first user (e.g., user of the electronic device) from a second user, such as an email including travel information (e.g., travel arrangements (e.g., flights, hotel, rental car, etc.), travel itinerary, etc.) booked by the second user. In some embodiments communications corresponding to the first user are analyzed (e.g., by the user, the electronic device, a server in digital communication with the electronic device, a server digitally connected with the one or more communication identities of the user, and/or one or more AI based models) to determine when a communication includes an indication of future travel as described herein.

In some embodiments, such as shown in FIGS. 6C-6D, in response to detecting the indication of future travel (e.g., notification 628) of the electronic device from the first geographic location (e.g., current location 614 corresponding to Santa Cruz) to the second geographic location (e.g., Paris) and in accordance with a determination that one or more criteria are satisfied, including a criterion that is satisfied when the first configuration(e.g., Home SIM) does not correspond to the second geographic location (e.g., Paris) (e.g., second country, area served by a second carrier, etc.), the electronic device initiates one or more operations for installing a second configuration (e.g., second SIM (e.g., Travel Sim such as shown in FIG. 6G)) corresponding to the second geographic location on the electronic device. In some embodiments, when the electronic device determines that the second geographic location includes an area which does not correspond to the first geographic location, the electronic device initiates the one or more operations corresponding to installing the second configuration. For instance, when the electronic device is in a second geographic location the electronic device optionally determines that the first SIM which is currently active on the electronic device, would result in roaming charges and/or international calling fees if used in the second geographic location. Additionally or alternatively, the electronic device optionally determines that the first SIM which is currently active on the electronic device is unable to communicate with the network in the second geographic location. In some embodiments, the first configuration corresponds to a first SIM, and installing a second configuration corresponds to installing a second SIM which is configured for operation in the second geographic location (e.g., compatible with the local network, and/or would not result in roaming charges. For instance, when the first configuration is configured for a first country, and the electronic device determines that the current geographic location of the electronic device changes from the first country to the second country, the electronic device initiates the one or more operations corresponding to installing the second configuration. In some embodiments, detecting that the electronic device has left the first geographic location and arrived at the second geographic location corresponds to leaving a first service area, (e.g., served by a first communications carrier, corresponding to a first geographic location, and/or an area controlled by a first governing body) and arriving in a second service area (e.g., served by a second communications carrier, corresponding to a second geographic location, and/or an area controlled by a second governing body), the electronic device initiates the one or more operations corresponding to installing the second configuration. The one or more operations corresponding to installing the second configuration optionally correspond to presenting information that the first configuration is not compatible with the second geographic location, that use of the first configuration in the second geographic location would result in increased fees (e.g., monetary), that the use of a second configuration in the second geographic location would provide improved communications (e.g., sound quality, data rate, etc.), and/or that the use of a second configuration would provide an identity (e.g., phone number) which corresponds) to the second geographic location (e.g., area code and/or country code which is associated with the second geographic location). In some embodiments, the notification is displayed while displaying a user interface corresponding to switching the configuration of the electronic device, overlaid on a lock screen, overlaid on a home screen, overlaid over a user interface of an application that is not associated with the change of configurations, etc. In Additionally or alternatively, the one or more operations corresponding to installing a second configuration optionally includes displaying the notification, wherein the notification is selectable to initiate one or more operations to install the second configuration or automatically install the second configuration which corresponds to the second geographic location.

In some embodiments, such as shown in FIG. 6D, the one or more criteria include a criterion that is satisfied when the electronic device does not include the second configuration corresponding to the second geographic location installed at the electronic device, such as shown in FIG. 6D wherein the electronic device only has the Home SIM installed. For instance, when the electronic device has a SIM which is configured for use in the United States, and the electronic device detects an indication of future travel from Los Angeles to Paris, and the electronic device does not include a SIM for the European Union (EU), the one or more criteria are optionally satisfied, and optionally triggers initiating one or more operations for installing a second configuration (e.g., second SIM) which is configured for use in the EU.

In some embodiments, such as shown in FIG. 6D, initiating the one or more operations for installing the second configuration includes installing the second configuration on the electronic device without activating the second configuration on the electronic device, such as if the electronic device did not require user input 634 to the notification 630 in FIG. 6D. For instance, when an indication of travel is detected from Los Angeles to Paris, the electronic device installs a second SIM configured for use in the EU on the electronic device without activating the second SIM.

In some embodiments, the electronic device initiates one or more operations for installing a third configuration at the electronic device, such as operations shown with respect to FIGS. 6O-6T to install a Travel SIM. For instance, when the electronic device detects an indication for travel to a location other than the current and/or default location of the electronic device such as an indication of travel from Los Angeles to Paris, or Los Angeles to Japan, the electronic device initiates one or more operations for installing the configuration corresponding to the respective geographic location. The third configuration optionally correspond to the first configuration, the second configuration, or a third configuration that is different than the first configuration and the second configuration.

In some embodiments, the one or more operations for installing a third configuration at the electronic device, includes the electronic device installing the third configuration on the electronic device such as shown in FIG. 6R wherein the Travel SIM is installed on the electronic device. In some embodiments, the electronic device installs the third configuration based on user input (e.g., touch, gaze, voice, and/or motion based) requesting the installation of the third configuration. Additionally or alternatively, the one or more operations to install the third configuration optionally includes installing the third SIM without further user input.

In some embodiments, such as shown in FIGS. 6S-6T, the one or more operations for installing a third configuration at the electronic device, includes in accordance with a determination that the electronic device is in a respective geographic location corresponding to the third configuration, the electronic device activating the third configuration on the electronic device, such as in reference to activation of the Travel SIM (see toggle 610b) based on the current geographic location 614 of the electronic device being in Paris, corresponding to the Travel SIM being configured for use in the EU. . While performing the one or more operations, and after installing the third configuration, the electronic device optionally detects the location of the electronic device. When the electronic device detects that the electronic device is in the respective geographic location (e.g., travel destination location) corresponding to the third configuration, the electronic device optionally activates the third configuration. The activation of the third configuration is optionally performed based on one or more user inputs requesting the activation of the third configuration. For instance, when the electronic device determines that the electronic device is in the respective location corresponding to the third configuration, the electronic device optionally presents one or more notifications to the user which are selectable to initiate one or more operations for the activation of the third configuration. Additionally or alternatively, when the electronic device determines that the electronic device is in the respective location corresponding to the third configuration, the electronic device optionally activates the third configuration without further user input.

In some embodiments, the one or more operations for installing a third configuration at the electronic device, includes, in accordance with a determination that the electronic device is not in a geographic location corresponding to the third configuration, the electronic device delaying activation of the third configuration on the electronic device, such as in relation to FIG. 6H wherein the electronic device 600 delays activation of the Travel SIM based on the currently geographic location 614 not being in Paris or elsewhere in the EU corresponding to the Travel SIM. While performing the one or more operations, and after installing the third configuration, the electronic device optionally detects the location of the electronic device. When the electronic device detects that the electronic device is not in the respective geographic location corresponding to the third electronic device, the electronic device forgoes activating the third configuration.

In some embodiments, the first configuration corresponds to a first SIM, such as the Home SIM as shown in FIG. 6A. In some embodiments the first configuration corresponds to a first SIM which is configured for use in the first geographic location. In some embodiments the first geographic location corresponds with a home and/or default location. In some embodiments the first SIM is configured to be user as the primary SIM when the electronic device is in the first geographic location.

In some embodiments, the one or more operations include presenting information including an option to install a second SIM, different from the first SIM, on the electronic device, such as in relation to notification 630 as shown in FIG. 6D. In some embodiments, when the electronic device initiates the one or more operations to install a second configuration, the one or more operations optionally include installing a second SIM which is different than the first SIM. The second SIM optionally corresponds to the second geolocation which the electronic device has received an indication for travel to from the first geographic location. In some embodiments, the information corresponds to a notification that is displayed indicating that the presently active and/or primary SIM is not configured for the second geographic location. In some embodiments, the information corresponds to one or more user interfaces corresponding to the selection of a second SIM that corresponds to the second geographic location. In some embodiments, the information is displayed in a user interface of an operating system of the electronic device.

In some embodiments, while displaying the option to install the second SIM on the electronic device, the electronic device detects, via the one or more input devices, a user input (e.g., touch, gaze, voice, and/or motion based) corresponding to a request to initiate the one or more operations corresponding to installing the second SIM on the electronic device, such as in response to the user input 634 to user interface element 638a as shown in FIG. 6E. For instance, displaying the option to install the second SIM optionally includes displaying a user interface element that is selectable to initiate installing the second SIM. When the electronic device detects that the user provides input, such as tapping the option a to install the second SIM, the electronic device optionally detects a request to install the second SIM.

In some embodiments, in response to detecting the user input, the electronic device displays a user interface of an application, other than the operating system of the electronic device, corresponding to performing the one or more operations for installing the second SIM on the electronic device, such as displaying the second SIM setup user interface 636b as shown in FIG. 6F. When the electronic device detects the user input corresponding to the request to install the second SIM, the electronic device displays an application for purchasing the second SIM. For instance, when detecting the request to install the second SIM, the electronic device optionally opens a web-browser application installed on the electronic device directed to a URL corresponding to a website for sourcing (e.g., purchasing, downloading, and/or installing) the second SIM. Additionally or alternatively, the electronic device optionally opens an application (e.g., installed on the electronic device, and/or corresponding to a wireless carrier associated with the second geographic location) specifically configured for the sourcing of the second SIM. Via the application, the electronic device optionally sources the second SIM based on user selection, suggests a second SIM (e.g., based on the second geographic location, and/or previous purchase history), and/or automatically sources the second SIM. In some embodiments, when initiating the one or more operations (e.g., based on user input, and/or independent of user input) the electronic device launches an application (e.g., while displaying a home screen corresponding to the operating system of the electronic device) configured for the sourcing of the second SIM.

In some embodiments, the first configuration is enabled for use with a first wireless service network corresponding to a first service provider, such as if the Home SIM shown in FIG. 6E is configured for use on a particular service provider. For instance, when the first configuration corresponds to a first SIM, the first SIM is optionally configured for use with a first wireless service network corresponding a first service provider (e.g., cellular carrier) network. Accordingly, using the first SIM in the second geographic location optionally requires modification of the first configuration to allow roaming operations to be performed using the first SIM to operate on a second service provider network.

In some embodiments, the one or more operations include enabling the use of the first configuration on a second wireless service network corresponding to a second service provider, different than the first service provider, such as if user input is detected selecting second user interface element 638b shown in FIG. 6E to enable roaming. In some embodiments, the one or more operations include updating the first configuration to allow operation (e.g., roaming) in the second geographic location on a second wireless service network corresponding to a second service provider in the second geographic location. In some embodiments, when enabling the use of the first configuration on a second wireless service network, the electronic device optionally requires user input (e.g., touch, gaze, voice, and/or motion based) to enable the first configuration on the second wireless service network, provides a notification indicating the enablement of the first configuration on the second wireless service network, and/or enables the user of the first configuration on the second wireless service network without further user input. In some embodiments, when the electronic device detects the indication of future travel to a second geographic location and/or detects that the electronic device has arrived in the second geographic location, the electronic device requests user input to use the first configuration and the second configuration in the second geographic location, or to use the second configuration in the second geographic location without using the first configuration. When the electronic device detects user input indicating the use of both the first configuration and the second configuration in the second geographic location, the electronic device optionally enables the use of the first configuration for use on the second wireless network without further user input.

In some embodiments, such as shown in FIG. 6I–6J, the one or more operations include presenting information (e.g., notification 654a) corresponding to activating the second configuration, including displaying, via the display generation component, a user interface element (e.g., first user interface element 658a) which is selectable to activate the second configuration. For instance, when the electronic device initiates the one or more operations for installing a second SIM which corresponds to the second geographic location, the electronic device optionally displays a notification (e.g., “Activate travel SIM now? Tap to confirm.”) which is selectable to activate the second SIM. In some embodiments, the one or more operations include one or more operations for selecting a second SIM, such as the selection of an eSIM as shown in relation to FIG. 6F. In some embodiments the one or more operations for installing a second SIM include one or more operations for installing the second SIM. For instance, when initiating the one or more operations for installing the second SIM, the electronic device allows the user to select the second SIM to be installed. For instance, a user optionally selects the second SIM from one or more SIM options which correspond to the second geographic location. The one or more SIM options optionally include one or more SIMS corresponding to the second geographic location with varying characteristics (e.g., carrier, cellular plan, data plan, etc.), and/or one or more SIMs that correspond to a third geographic location.

In some embodiments, the one or more operations include one or more operations for allocating one or more first functionalities of the electronic device to be performed by the first configuration, such as corresponding to the selection of the first user interface element 660a in relation to FIG. 6K, which allocates cellular voice functionalities corresponding the Home Sim, to be performed via the Home SIM. In some embodiments, when performing the one or more operations for installing the second SIM, the electronic device optionally requests user input (e.g., touch, gaze, voice, and/or motion based) to allocate communication functionalities, also referred to herein as communication functions, corresponding to the first SIM while the electronic device is in the second geographic location. In some embodiments, the cellular communication functionalities and/or the cellular data functionalities share one or more characteristics with the cellular communication functionalities and/or the cellular data functionalities as described herein in relation to methods 700 and/or 900. Functionalities which are optionally performed by the first and/or second SIM include cellular voice functionalities (e.g., voice communications, SMS, multimedia messaging service (MMS)), and/or cellular data functionalities.

In some embodiments, the one or more operations include one or more operations for allocating one or more second functionalities of the electronic device to be performed by the second configuration, such as corresponding to the selection of the first user interface element 648a in relation to FIG. 6G, which allocates cellular voice functionalities corresponding the Travel SIM and cellular data functionalities, to be performed via the Travel SIM when the Travel SIM is activated. In some embodiments, when performing the one or more operations for installing the second SIM, the electronic device optionally requests user input to allocate communication functionalities for the second SIM while the electronic device is in the second geographic location. For instance, a user optionally allocates the function of cellular data and voice calling via the second SIM while in the second geographic location to reduce roaming charges and provide an identity which corresponds with the second geographic location. In some embodiments, when using the second SIM (e.g., as a primary configuration) in conjunction with the first SIM (e.g., as a secondary configuration), while in the second geographic location, the cellular data functions are performed via the second SIM, the cellular voice functions associated with the second SIM are performed via the second SIM, and the cellular voice functions associated with the first SIM are performed via the first SIM, wherein performing cellular voice functions associated via the first SIM may result in fees (e.g., roaming fees, usage fees, etc.) based on first SIM having communication incompatibility when used in the second geographic location. In some embodiments, when using the second SIM without using the second SIM, while in the second geographic location, the cellular data functions are performed via the second SIM, the cellular voice functions associated with the second SIM are performed via the second SIM, and cellular voice functions corresponding to the first SIM are deactivated. In some embodiments, internet-based messaging corresponding to the first SIM, and/or corresponding to a third configuration (e.g. corresponding to an email, via an application installed on the electronic device, etc.) is performed via the second SIM while the electronic device is in the second geographic location.

In some embodiments, after initiating the one or more operations for installing the second configuration corresponding to the second geographic location on the electronic device, the electronic device detects that the electronic device has arrived in the second geographic location. In some embodiments, after installing the first configuration, the electronic device detects that the user has traveled to the second geographic location. Detecting that the electronic device has arrived in the geographic location is optionally performed via GPS, wireless network signals, and/or other means for detecting the current geographic location of the electronic device. Additionally or alternatively, when detecting that the ed has arrive in the second geographic location, the electronic device optionally determines that the first configuration is incompatible with the second geographic location.

In some embodiments, in response to detecting that the electronic device has arrived in the second geographic location, the electronic device presents information indicating that the first configuration does not correspond to the second geographic location, such as presenting notification 654a when detecting arrival to Paris (see current geographic location 614) as shown in FIG. 6I. When the electronic device detects that the electronic device has arrived in the second geographic location, the electronic device optionally presents one or more notifications which indicate to the user that the first configuration is incompatible with the second geographic location. In some embodiments, presenting information includes displaying a notification (e.g., overlaid on a home screen of the operating system, overlaid on a lock screen of the operating system, and/or overlaid over an application installed on the electronic device) which when selected initiates one or more subsequent operations. For instance, selecting the notification optionally results in launching the application configured for the sourcing of the second configuration.

In some embodiments, after initiating the one or more operations for installing the second configuration corresponding to the second geographic location on the electronic device, the electronic device detects that the electronic device has arrived in the second geographic location, such as displaying the notification 654a as related to FIG. 6I following installation of the Travel SIM. In some embodiments, after installing the first configuration, the electronic device detects that the user has traveled to the second geographic location. Detecting that the electronic device has arrived in the geographic location is optionally performed via GPS, wireless network signals, and/or other means for detecting the current geographic location of the electronic device. Additionally or alternatively, when detecting that the ed has arrive in the second geographic location, the electronic device optionally determines that the first configuration is incompatible with the second geographic location.

In some embodiments, in response to detecting that the electronic device has arrived in the second geographic location, the electronic device displays, via the display generation component, a selectable user interface element that, when selected, initiates a process to activate the second configuration on the electronic device, such as detecting the user input 654b to the notification 654a as related to FIG. 6I. In some embodiments, in response to detecting that the electronic device has arrived in the second geographic location, the electronic device optionally presents selectable a user interface element, which when selected initiates the activation of the second configuration. For instance, when the electronic device detects the user input to the selectable user interface element, the electronic device optionally initiates activation of the second configuration. In some embodiments activating the second configuration optionally shares one or more characteristics with activating and/or deactivating one or more configurations (e.g., first configuration, second configuration, third configuration, etc.) as described herein in relation to methods 700, and/or 900. In some embodiments, the electronic device activates the second configuration to operate in conjunction with the first configuration, or activates the second configuration and deactivates the first configuration. The process to activate the second configuration optionally requires additional user input (e.g., to allocate functionalities, to indicate primary configuration, etc.). Additionally or alternatively, the process to activate the second configuration optionally requires no further user input wherein the electronic device automatically activates the second configuration upon detecting user input to the selectable user interface element.

In some embodiments, while displaying the selectable user interface element, the electronic device detects, via the one or more input devices, a user input (e.g., touch, gaze, voice, and/or motion based) corresponding to selection of the selectable user interface element, such as detecting the user input 654b to the notification 654a as related to FIG. 6I. In some embodiments, when the electronic device receives the user input corresponding to the selection of the user interface element, and request to initiate the process to activate the second configuration.

In some embodiments, in response to detecting the user input corresponding to selection of the selectable user interface element, the electronic device initiates the process to activate the second configuration such as shown in relation to FIGS. 6I-6L, including presenting information indicating the activation of the second configuration, such as displaying visual notification 668 indicating activation of the Travel SIM as shown in relation to FIG. 6M. When the electronic device detects the input to the selectable user interface element, the detection of the input triggers the process to activate the second configuration. Activating the second configuration optionally includes one or more operations including presenting notification (e.g., displaying, playing an audible notification, and/or providing a haptic notification) to notify the user that the second configuration is activated and/or in process for activation. In some embodiments the one or more operations for activating the second configuration optionally includes activating the second configuration automatically (e.g., without further user input).

In some embodiments, prior to activating the second configuration, the electronic device performs one or more functionalities using the first configuration, such as using the Home SIM as the primary 609a SIM profile including performing cellular voice and cellular data functionalities as shown in relation to FIG. 6J. In some embodiments, while the first configuration is in use in the first geographic location, the first configuration is configured to perform one or more functionalities such as cellular data functions and cellular voice functions associated with the first configuration. For instance, a first SIM corresponding to the first configuration is optionally used to place and receive phone calls, and to send and receive text-based messages via SMS and/or MMS via cellular voice communications, and enable web-browsing, email, and data transfers via cellular data communications.

In some embodiments, the electronic device initiates the process to activate the second configuration includes configuring the electronic device to perform a first functionality, of the one or more functionalities, using the second configuration instead of the first configuration, such establishing the Travel SIM as the primary 609a SIM profile (e.g., for cellular voice and cellular data) and the Home SIM as the secondary 609b SIM profile (e.g., for cellular voice) as shown in relation to FIG. 6K. In some embodiments, the process to activate the second configuration includes reallocating at least a first functionality (e.g., cellular data) of the one or more functionalities from being performed by the first configuration to the second configuration. For instance, initiating the process to activate the second SIM optionally includes reallocating the cellular data functionality from the first SIM to the second SIM. Additionally or alternatively, when activating the second configuration, the electronic device optionally maintains the use of the first configuration for performing a second functionality (e.g., cellular voice functions corresponding to the first SIM).

In some embodiments, the one or more criteria include a criterion that is satisfied when the indication of future travel includes information that the future travel will occur within a threshold period of time from a current time at the electronic device, such as shown in relation to FIG. 6D wherein the notification 630 is presented two weeks prior to departure of the flight to Paris. In some embodiments, in response to detecting an indication of future travel, the electronic device does not initiate the one or more operations for installing the second configuration until the date and/or time of future travel is within a threshold time period. A threshold time period optionally corresponds to less than an hour, an hour, three hours, 12 hours, 24 hours, 3 days, one week, two weeks, one month, three months, or longer than a month. For instance, when the threshold time period is set for two weeks, when an indication that the user of the electronic device will travel to Japan in three months, the electronic device does not initiate the one or more operations for adding the second configuration. When the date of travel is within two weeks from the present time at the electronic device, the electronic device optionally initiates the one or more operations for installing the second configuration.

In some embodiments, the indication of travel corresponds to an event recorded in a calendar application on the electronic device, such as if the flight to Paris (see FIGS. 6A-6C) was recorded to a calendar application installed on the electronic device. In some embodiments, the indication of future travel corresponds to the adding, accepting an invitation for, and/or importing a calendar event to a calendar application on the electronic device. In some embodiments, the travel event corresponds to a primary travel event (e.g., flight departure, cruise departure, train departure, and/or departure via automobile) In some embodiments, the travel event corresponds to a secondary travel event which occurs after the planned arrival in the second geographic location (e.g., hotel check-in, rental car pickup, etc.) corresponding to travel to the second geographic location.

In some embodiments, the indication of travel corresponds to a digital document recorded in a digital wallet application on the electronic device, such as if digital tickets and/or confirmation for the flight to Paris (see FIGS. 6A-6C) were stored to a digital wallet application installed on the electronic device. In some embodiments, the indication of travel corresponds to one or more documents that are saved to a digital wallet on the electronic device. Examples of the digital document optionally include an airline boarding pass, an international driver’s license, or other travel related digital document.

In some embodiments, the indication of travel corresponds to a message received via a messaging application on the electronic device, such as if confirmation of the purchase of the tickets for the flight to Paris (see FIGS. 6A-6C) was received via a messaging application installed on the electronic device. In some embodiments the indication of travel corresponds to the receipt of a message via a messaging application. For instance, the indication of future travel optionally corresponds to the receipt of a message via a messaging application confirming travel arrangements corresponding to a primary or secondary travel event. Additionally or alternatively, when the electronic device receives a message from a known contact (e.g., contact recorded via a contacts application on the electronic device) via the messaging application discussing the purchase and/or timing of a primary or secondary travel event, the electronic device optionally detects the message as an indication of future travel.

In some embodiments, the indication of travel corresponds to a message received via an email client on the electronic device, such as if confirmation of the purchase of the tickets for the flight to Paris (see FIGS. 6A-6C) was received via an email application installed on the electronic device. In some embodiments the indication of travel corresponds to the receipt of a message via an email client. For instance, the indication of future travel optionally corresponds to the receipt of a message via an email client confirming travel arrangements corresponding to a primary or secondary travel event. Additionally or alternatively, when the electronic device receives a message from a known contact (e.g., contact recorded via a contacts application on the electronic device) via the email client discussing the purchase and/or timing of a primary or secondary travel event, the electronic device optionally detects the message as an indication of future travel.

In some embodiments, the one or more operations includes presenting a notification (e.g., displaying, playing an audible notification, and/or providing a haptic notification) indicating that the second configuration corresponding to the second geographic location is not installed on the electronic device, such as if visual notification 674a including information indicating that a Travel SIM is not yet installed on the electronic device in relation to FIG. 6P. In some embodiments, the one or more operations include notifying the user that a second configuration, configured for communications while in the second geographic location, is not currently installed on the electronic device. For instance, when the electronic device initiates the one or more operations and determines that a second configuration corresponding to the second geographic location is not installed on the electronic device, the electronic device displays a notification (e.g., overlaid on a home screen of the operating system, overlaid on a lock screen of the operating system, and/or overlaid over an application installed on the electronic device) to such effect. In some embodiments, when the electronic device determines that a second configuration corresponding to the second geographic location is installed on the electronic device, the electronic device presents a notification to such effect, and optionally allows a user to continue with installing an additional configuration corresponding to the second geographic location and/or to dismiss the notification without installing a configuration corresponding to the second geographic location. In some embodiments, the notification when selected initiates one or more subsequent operations. For instance, selecting the notification optionally results in launching the application configured for the sourcing of the second configuration. Additionally or alternatively, when the electronic device detects selection of the notification, the electronic device optionally installs, sources, and/or activates the second configuration without further input from the user.

In some embodiments, the one or more criteria include a criterion that is satisfied when a current time at the electronic device is within a time threshold of a scheduled start time of the future travel, such as shown in relation to FIG. 6D wherein the notification 630 is presented two weeks prior to departure of the flight to Paris. In some embodiments the one or more criteria and/or detecting that the electronic device is within a time threshold of a scheduled start time of the future travel shares one or more characteristics with the one or more criteria that are satisfied when the indication of future travel includes information that the future travel will occur within a threshold period of time from a current time at the electronic device as described herein.

In some embodiments, the one or more operations include presenting information (e.g., displaying, playing an audible notification, and/or providing a haptic notification) corresponding to use of the first configuration in the second geographic location, such as shown with the first user interface element 678a indicating that use of the Home SIM in Paris may result in additional charges as shown in relation to FIG. 6Q. In some embodiments the one or more operations include presenting information which alerts the user that the first configuration, configured for use in the first geographic location, is not configured for use in the second geographic location. For instance, the information optionally corresponds to compatibility, applicable fees, network availability or other aspects corresponding to incompatibility of the first configuration at the second geographic location. Additionally or alternatively, when the electronic device detects that the first configuration is configured for use in the second geographic location, the electronic device optionally presents information to such effect. In some embodiments, the one or more operations include displaying a notification (e.g., overlaid on a home screen of the operating system, overlaid on a lock screen of the operating system, and/or overlaid over an application installed on the electronic device) which when selected initiates one or more subsequent operations. For instance, selecting the notification optionally results in launching the application configured for the sourcing of the second configuration. Additionally or alternatively, when the electronic device detects that the first configuration is configured for use in the second geographic location, the electronic device optionally forgoes presenting information regarding the compatibility of the first configuration as related to the second geographic location.

It should be understood that the particular order in which the operations in FIG. 7 have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., method 900) are also applicable in an analogous manner to method 700 described above with respect to FIG. 7. For example, the detecting an indication of future travel, and in response initiating one or more operations for installing a second configuration corresponding to the location of future travel as described above with reference to method 700 optionally has one or more of the characteristics initiating one or more operations for activating a second configuration when detecting that the electronic device has arrived in a second geographic location described herein with reference to other methods described herein (e.g., method 900). For brevity, these details are not repeated here.

The operations in the information processing methods described above are, optionally, implemented by running one or more functional modules in an information processing apparatus such as general purpose processors (e.g., a as described with respect to FIGS. 1A-1B, 3, 5A-5H) or application specific chips. Further, the operations described above with reference to FIG. 7 are, optionally, implemented by components depicted in FIGS. 1A-1B. For example, while in a first geographic location and a first configuration is installed 701, detecting operation 702, and initiating operation 704 are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

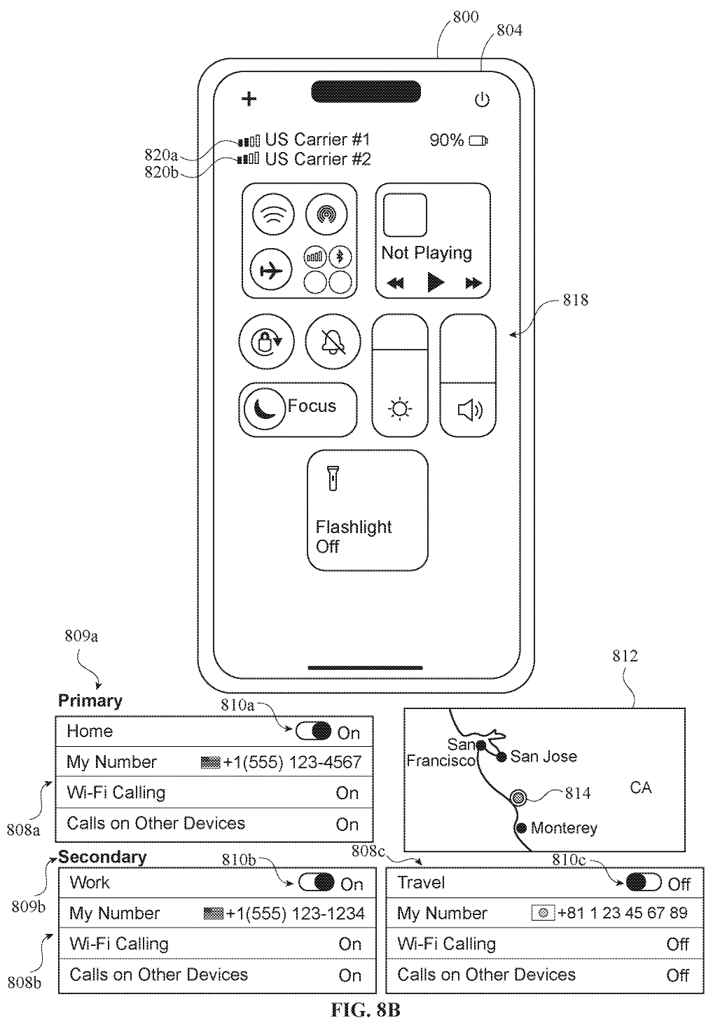

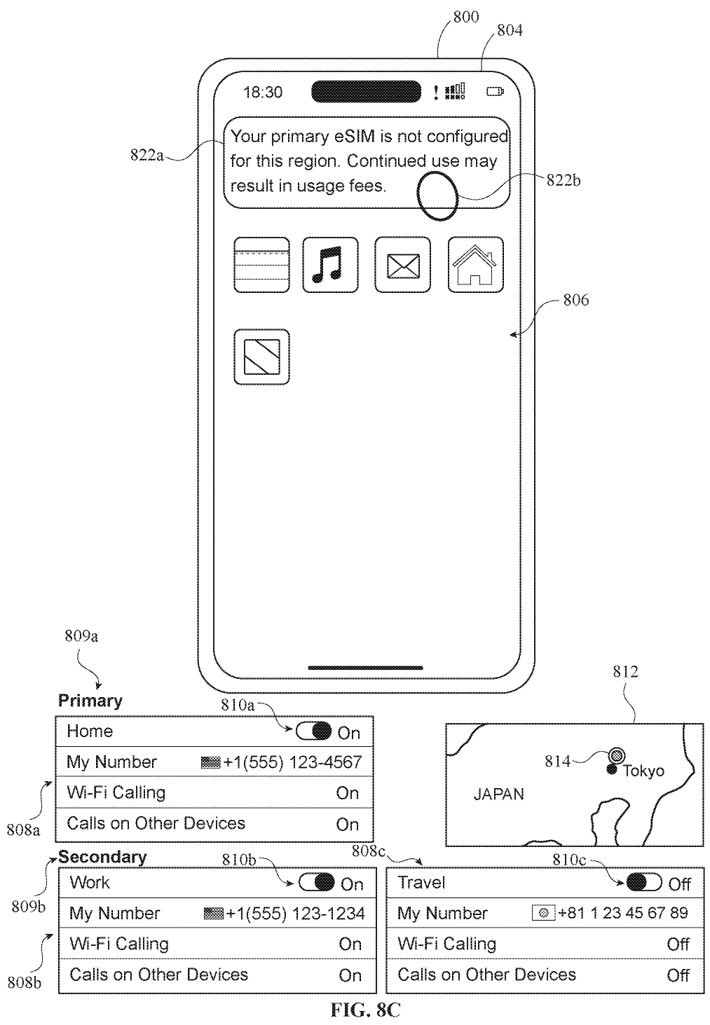

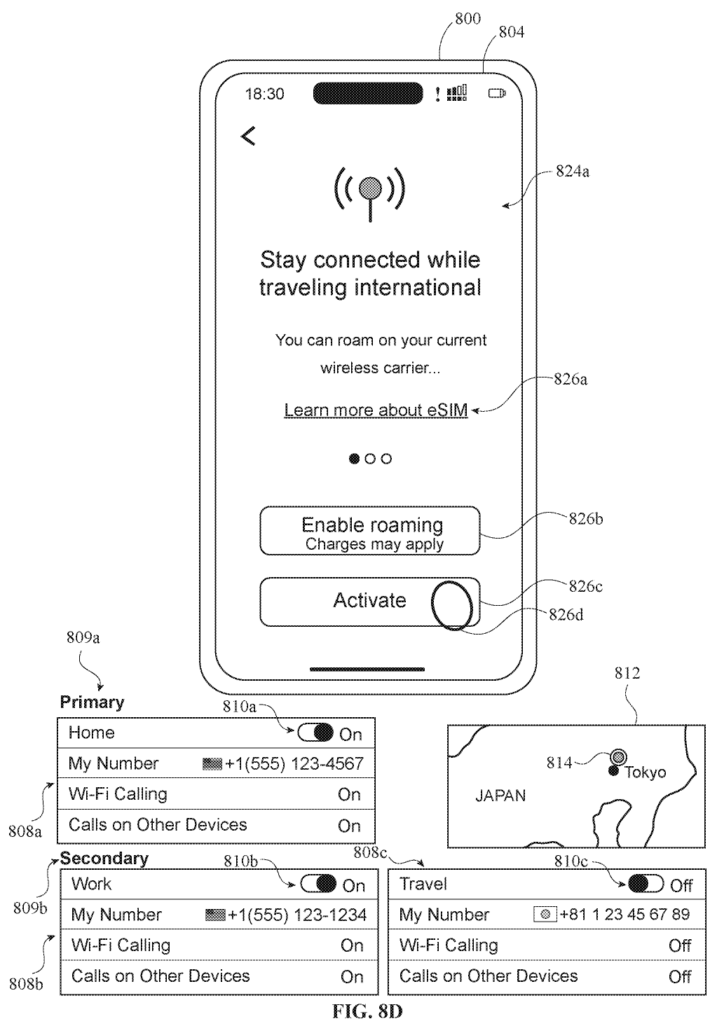

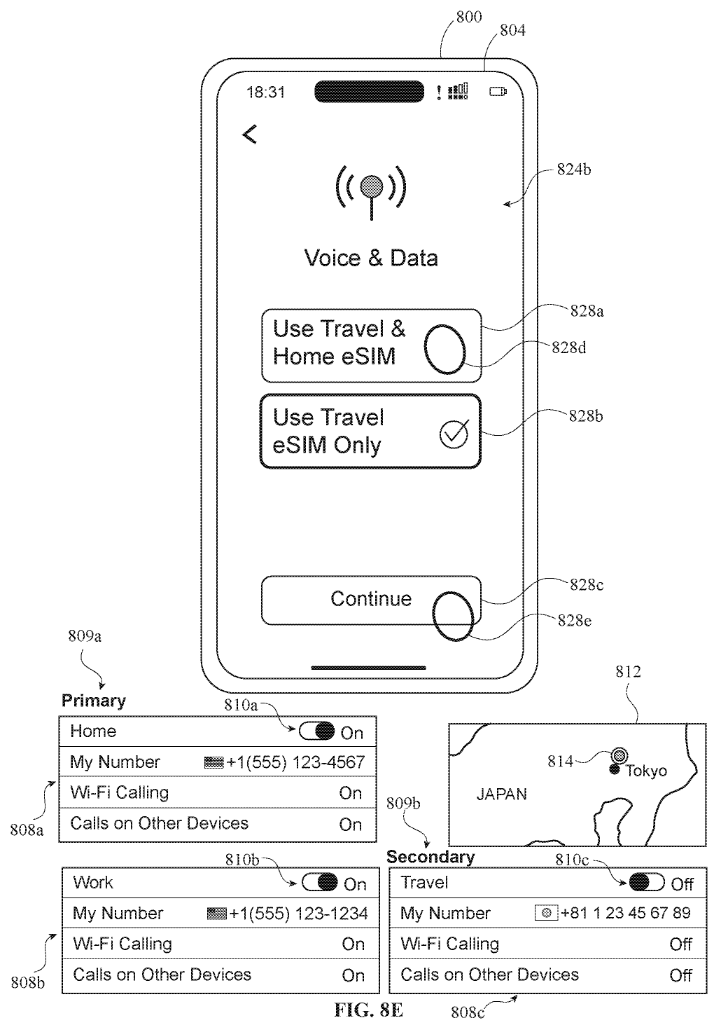

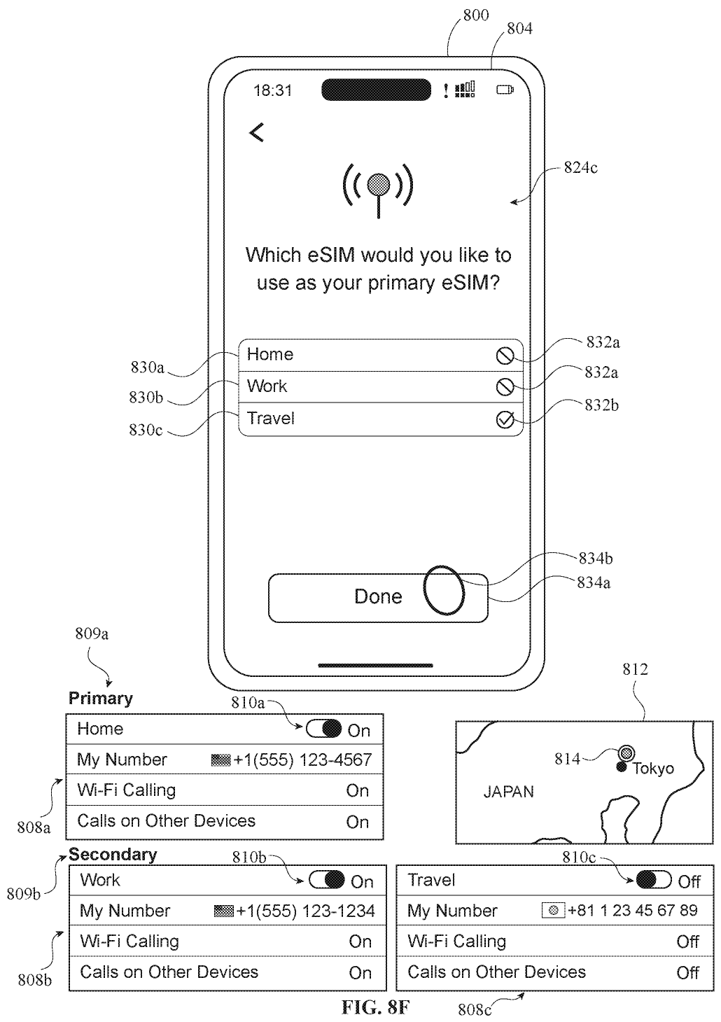

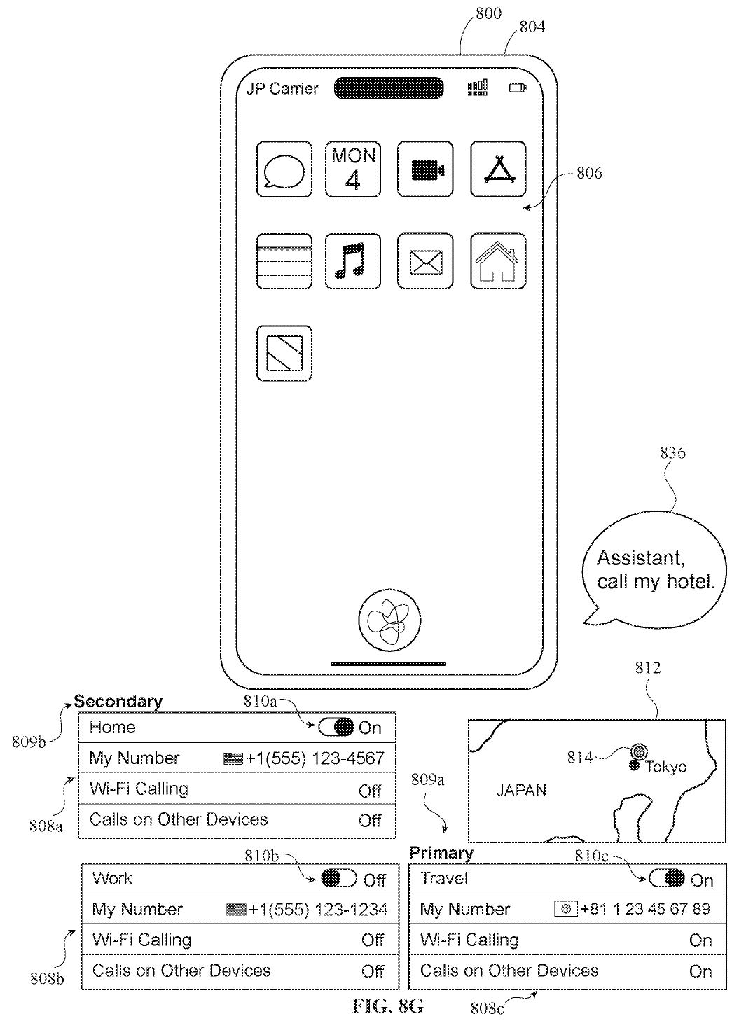

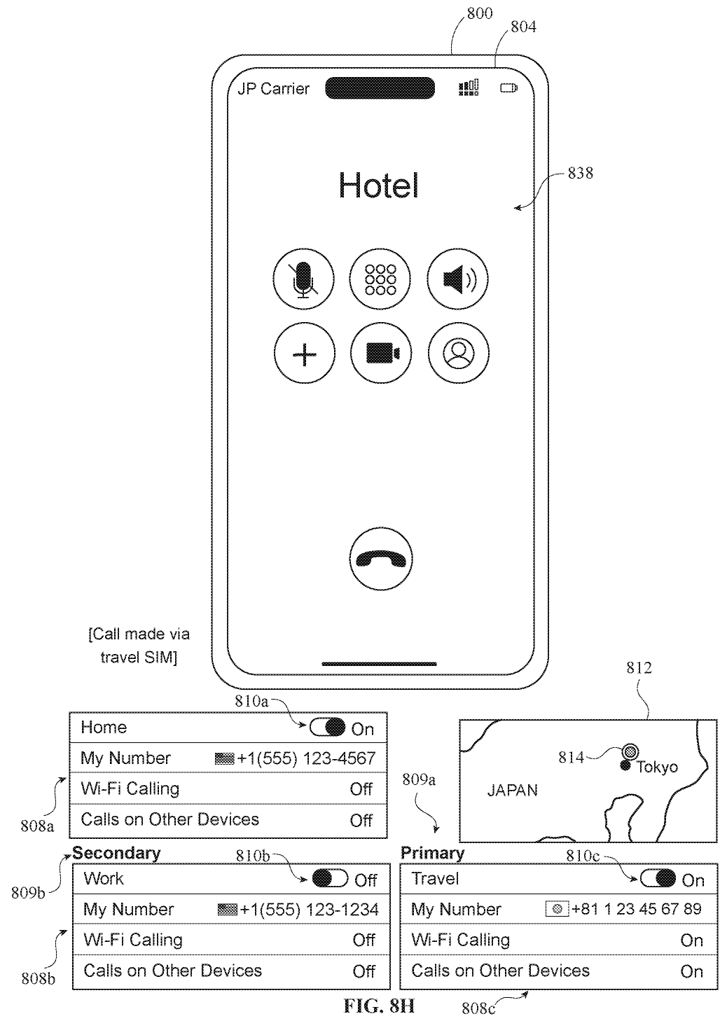

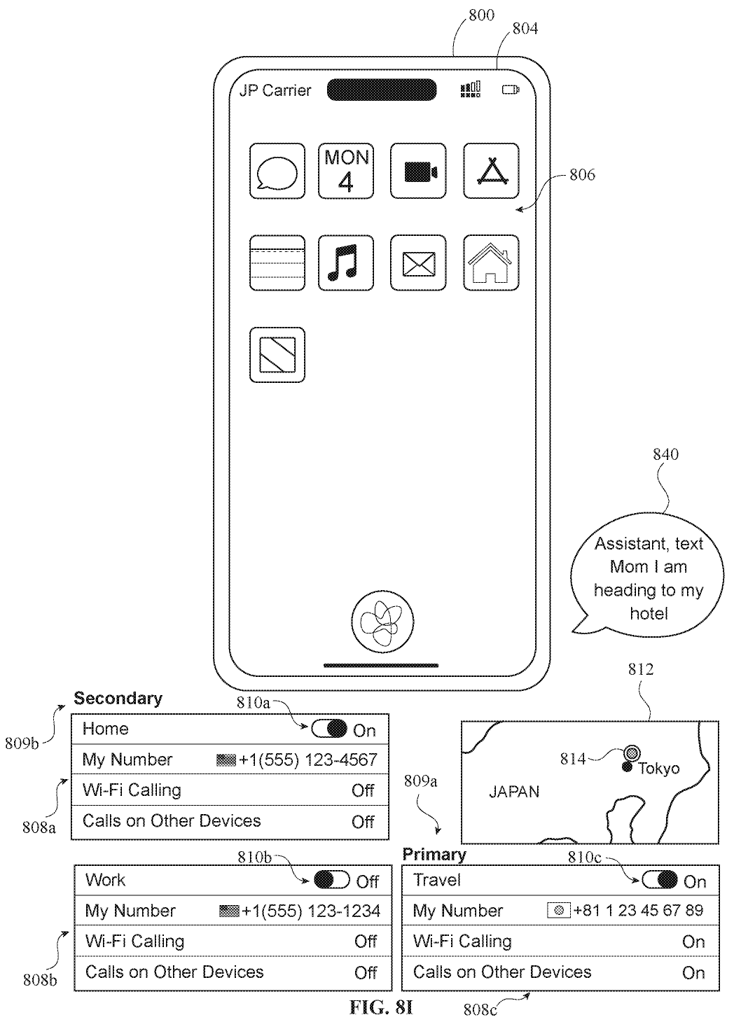

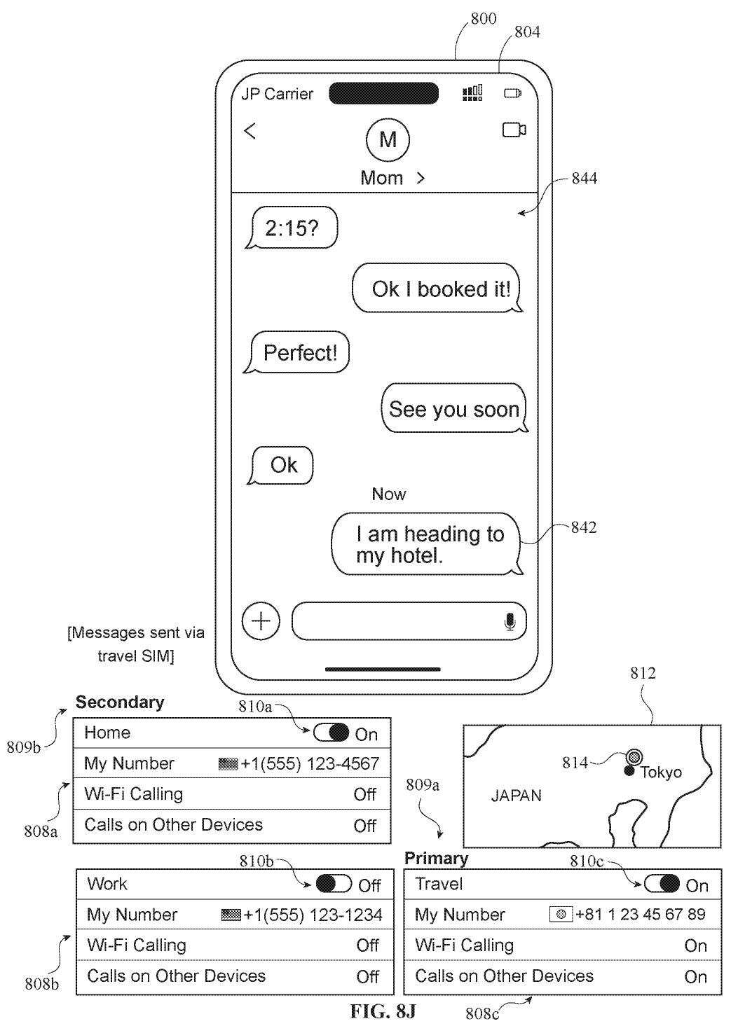

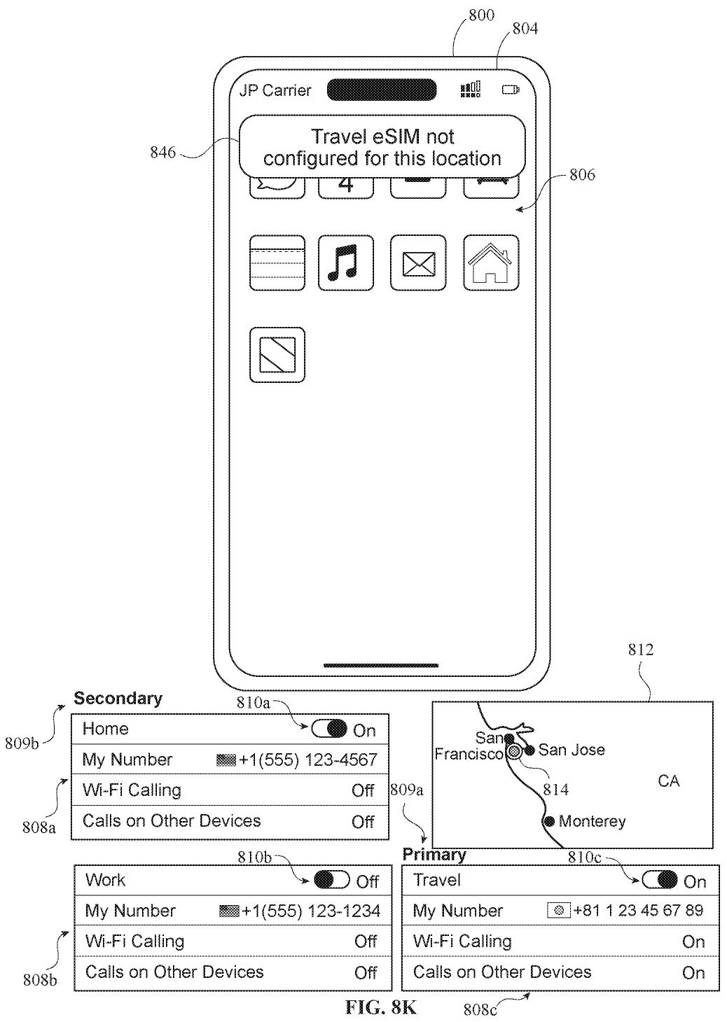

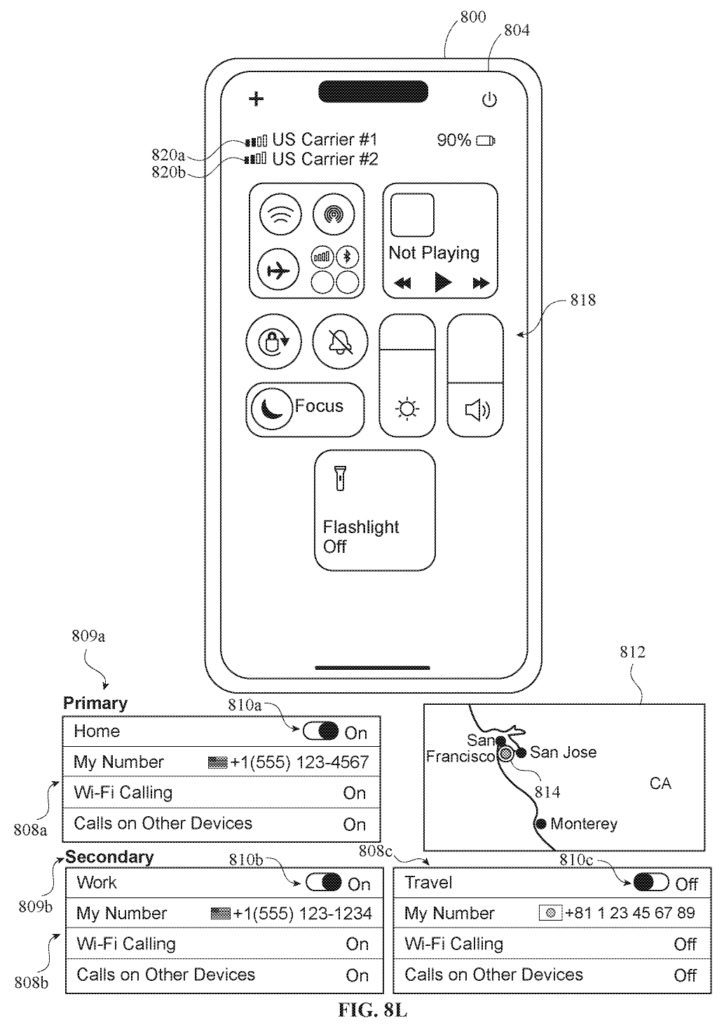

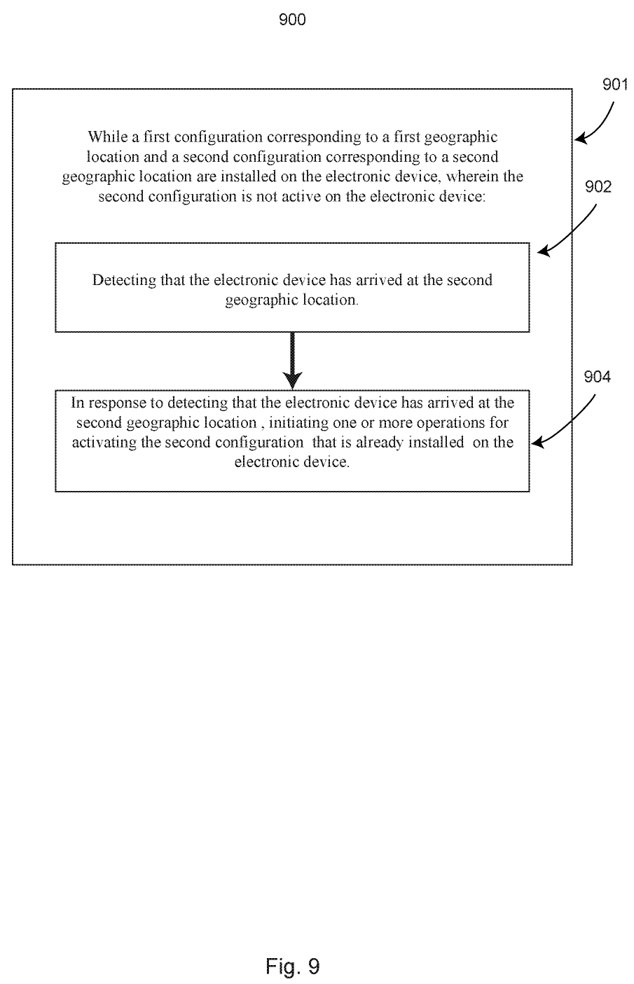

FIG. 8A–8L illustrate exemplary ways, based on one or more criteria, in which an electronic device 800 initiates one or more operations to source, install, activate, provide notifications pertaining to and/or otherwise manage multiple SIM profiles based on the geographic location of the electronic device. The embodiments in these figures are used to illustrate the processes described below, including the processes described in FIG. 9 of how an electronic device is able to perform the forementioned operations and/or functionalities described below with respect to FIG. 9, it should be understood that these examples are not meant to be limiting, and the electronic device is able to perform one or more processes described below with reference to FIG. 9 in ways not expressly described with reference to FIGS. 8A–8L. In some embodiments, while the methods for managing multiple SIM profiles with respect to the geographic location of the electronic device are described in the context of user interface corresponding to a limited number of geographic locations and cursory examples, the context should be seen as exemplary, and should not be viewed as limiting to the disclosure. In some embodiments, the methods and processes described herein can be applied in multiple contexts where the use and/or management of alternate SIM profiles (e.g., other than a home SIM profile) are required at least partially based on the current geographic location of the electronic device.

As shown in FIG. 8A, the electronic device 800 is displaying, via the display generation component 804, a home user interface 806. As indicated by the cellular reception indicator 813, two SIM profiles are in use at the electronic device. Also illustrated herein are SIM status panels such as the first SIM status panel 808a corresponding to the “Home” SIM profile configured for use in the United States (U.S.), a second SIM status panel 808b corresponding to a “Work” SIM profile configured for use in the U.S., and a third SIM status panel 808c which corresponds to a “Travel” SIM profile which is configured for use in Japan. The Home SIM profile, referencing the first SIM status panel 808a, is indicated as being active via the toggle 810a, and in use as the primary SIM profile as indicated by “primary” status indicator 809a. The Work SIM profile, referencing the second SIM status panel 808b, is indicated as being active via the toggle 810b, and in use as the primary SIM profile as indicated by “secondary” status indicator 809b. The Travel SIM profile, referencing the third SIM status panel 808c, is indicated as being inactive via the toggle 810c. The SIM status panels illustrated herein are for informational purposes corresponding to the status of a respective SIM, but may optionally correspond to one or more user interface which are accessible at the electronic device based on user input. For further informational purposes, the geographic location panel 812 provides the current geographic location 814 of the electronic device, as detected by the electronic device. As illustrated, the electronic device is currently detected in Sata Cruz, California. As further illustrated in FIG. 8A, the electronic device detects a user input 816, such as a touch and swipe originating in a top right corner of the display generation component 804, which corresponds to a request to show a user interface including the status of the active SIM profiles. As further shown via the third SIM status panel 808c, a Travel SIM profile corresponding to Japan is currently installed on the electronic device, but is not active.

As shown in FIG. 8B, in response to detecting the user input 816, the electronic device 800 displays a control panel user interface 818 including information corresponding to the active SIM profiles, such as Primary SIM (e.g., Home SIM) status indicator 820a which uses the “US Carrier #1” network and the Secondary SIM (e.g., Work SIM) status indicator 820b which uses the “US carrier #2”) network. While displaying the home user interface 806, the electronic device detects that the current geographic location 814 of the electronic device corresponds to a geographic location (e.g., Tokyo) which does not correspond to one or more of the currently active SIM profiles. As configured, neither the Home SIM profile, nor the Work SIM profile (each configured for use in the U.S.) are configured for use in Japan.

As shown in FIG. 8C, in response to detecting that the currently geographic location of the electronic device 800 has changed to a geographic location which does not correspond to the active one or more SIM profiles, the electronic device presents a notification 822a, overlaid on the home user interface 806, which includes information about the incompatibility of the active one or more SIM profiles with the current geographic location. While the notification 822a is displayed, the electronic device detects a user input 822b directed to the notification which corresponds to a request to initiate one or more operations corresponding installing and/or activating a SIM profile which corresponds to Tokyo. Referencing the SIM status panels 808a–808c, the Home SIM and Work SIM are currently active, and the Travel SIM profile corresponding to Japan is not active. Accordingly, the user input 822b initiates one or more operations to activate the Travel SIM based on the arrival to a geographic location that the currently active SIM profiles do not correspond, and/or based on the arrival to a geographic location that a currently inactive SIM profile corresponds.

As shown in FIG. 8D, in response to detecting the user input 822b (shown in FIG. 8C), the electronic device 800 displays a first SIM setup user interface 824 which includes a user interface element 628a that is selectable to display information corresponding to setting up and/or activating a SIM profile, a second user interface element 826b that is selectable to enable roaming on the one or more currently active SIM profiles, and a third user interface element 826c that is selectable to activate a SIM profile (e.g., Travel SIM) which corresponds to the current geographic location which is already installed on the electronic device. As shown, the electronic device detects a user input 826d directed to the third user interface element 826c which is selectable to activate the Travel SIM.

As shown in FIG. 8E, the electronic device 800 displays a second SIM setup user interface 824b which includes a first user interface element 828a which is selectable to use the Travel SIM and the Home SIM (due to current status as the primary SIM profile as indicated by the primary status indicator 809a), or to use only the Travel SIM while in Japan. When displaying the second SIM setup user interface 824b, the second user interface element 828b is preselected as the use of the Travel SIM profile without the currently active SIM profiles which are configured for use in the U.S. prevents additional roaching charges or additional service fees associated with using the Home SIM or the Work SIM in Japan. Second SIM setup user interface 824b further includes a third user interface element 828c which is selectable to continue with the activation process with the selected option. As further shown in FIG. 8E, the electronic device detects a user input 828d to the first user interface element 828a followed by a user input 828e to the third user interface element 828c which corresponds to a request to continue with the one or more SIM activation operations which will result in the activation of the Travel SIM with the Home SIM.

As shown in FIG. 8F, in response to detecting the user input 828e to the third user interface element 828c (as shown in FIG. 8E), the electronic device 800 displays a third SIM setup user interface 824c which allows the user to select with SIM profile will be used as the primary SIM profile while in Japan. Currently, referencing the SIM status panels 808a–808c, the Home SIM is in use as the primary SIM profile as indicated by primary status indicator 809a, Work SIM is in use as the secondary SIM profile as indicated by secondary status indicator 809b, and the Travel SIM is inactive. The third SIM setup user interface 824c includes selectable user interface elements corresponding to each of the SIM profiles currently installed on the electronic device. As shown, based on the compatibility of the Travel SIM to the current geographic location within Japan, the electronic device has preselected the Travel SIM profile (as indicated by the checkmark 832b) for use as the primary SIM profile, and a circle-backslash symbol 832a indicating that the Home SIM and the Work SIM will not be used as the primary SIM profile. A user selection directed to either the Home SIM or the Work SIM will update the primary profile. In In the event that the electronic device detects user input directed to the user interface element 830b corresponding to the Work SIM would optionally result in maintaining the Work SIM for use with the Travel SIM while in the destination instead of the Home SIM. While displaying the third SIM setup user interface 824c, with the Travel SIM selected for use as the primary SIM profile, the electronic device detects a user input 834b to a user interface element 834a which corresponds to a request to save the SIM configurations as selected and proceed with the activation of the Travel SIM.

As shown in FIG. 8G, in response to detecting the user input 834b to the user interface element 834a to proceed with the activation of the Travel SIM (as shown in FIG. 8F), the electronic device 800 displays the home user interface 806 following the completion of the activation of the Travel SIM which is configured for use in Japan. Referencing the SIM status panels 808a–808c, an in accordance with the SIM setup selections shown in FIGS. 8D-8F, the Travel SIM is active (see toggle 810c) and is in use as the primary SIM profile as indicated by primary status indicator 809a, and the Home SIM is active (see toggle 810a) and is in use as the secondary SIM profile as indicated by secondary status indicator 809b. The Work SIM is currently inactive as indicated by toggle 810b. While in the current configuration as shown in FIG. 8H, the electronic device detects a user input 836 corresponding to a request, optionally via voice assistant, to call their hotel.

As shown in FIG. 8H, in response to receiving the user input 836 corresponding to a request, via voice assistant, to call their hotel (shown in FIG. 8G), based on the hotel being located in Japan, and/or being associated with travels to Japan, the electronic device 800 initiates calling the hotel via a phone application 838 installed on the electronic device, which uses cellular functionality, using the Travel SIM (which is associated with the geography of the phone number of the hotel: Japan) to prevent incurring roaming and/or service fees. In some embodiments, if the user input were instead to initiate a call to a phone number associated with the Home SIM (e.g., a phone number in the United States), the electronic device would have instead initiated the call using the Home SIM. Thus, in some embodiments, the electronic device automatically selects which SIM (e.g., without user input needed to indicate which SIM) to use for communications based on the geography that is associated with the phone number being contacted. In some embodiments, the electronic device automatically suggests which SIM to use (e.g., displays a visual indication of a suggested SIM to use for the communications) based on the geography that is associated with the phone number being contacted, and in response to user input directed to the suggestion (e.g., user input directed to the visual indication, such as selection of a confirmation button in the visual indication), the electronic device uses the suggested SIM for the communication.

As shown in FIG. 8I, while displaying the home user interface 806 following the completion of the activation of the Travel SIM the electronic device 800 detects a user input 840 corresponding to a request, optionally via voice assistant, to send an SMS message, to a contact (e.g., Mom”) which is saved in an application installed on the electronic device. Based on the contact “Mom” being a saved contact, and commonly contacted via the Home SIM, the electronic device initiates the one or more operations resulting in sending the SMS message 842, as shown in FIG. 8J, to “Mom” using a messaging application 844 installed on the electronic device. In some embodiments, the electronic device 800 uses the Travel SIM to send the SMS message to the contact, because the message is an SMS message (as opposed to being a data-based message, such as MMS or other data-based message) and the Travel SIM is the Primary SIM. However, in some embodiments, the electronic device 800 would instead use the Home SIM to send the SMS message to the contact in FIG. 8J, if that SIM was the SIM previously used to send messages to, and receive messages from, the contact. In some embodiments, if the request to send the message were a request to send a data-based message to the contact (as opposed to an SMS message), the electronic device would optionally use the SIM currently configured to be used for data to transmit the message to the contact; however, the phone number indicated as sending the message would optionally be the Home SIM phone number (even if the Home SIM is currently disabled), if the Home SIM was the SIM previously used to send messages to, and receive messages from, the contact. Thus, in some embodiments, the electronic device uses the Home SIM phone number for data-based communications (e.g., data-based messaging, data-based voice calling and/or data-based video calling), whether or not the Home SIM is enabled, in one or more of the examples described with reference to methods 700 and/or 900.

As shown in FIG. 8K, the electronic device 800 detects that the electronic device has arrived in a new geographic location (e.g., San Francisco) which the Travel SIM, currently active (as illustrated via toggle 810c) on the electronic device. When the electronic device determines that the Travel SIM is no longer configured for the current geographic location of the electronic device, and/or that the original or default SIM profile configuration (such as configured in FIG. 8A prior to detecting that the electronic device arrived in the Destination), the electronic device presents a notification 846 overlaid on the current user interface (such as home user interface as shown in FIG. 8K) and automatically reverts (e.g., without user input) SIM profile configuration to the configuration prior to the detecting that the electronic device had arrived in Japan. In some embodiments, the notification 846 is selectable wherein a selection to the notification 846 results in initiating one or more operations to updates the SIM profile configuration such as initiated when the electronic device detected its arrival in Japan such as shown in FIG. 8D–8F.

As shown in FIG. 8L, the electronic device 800 has updated the SIM profile configuration, referencing the SIM status panels 808a–808c, such that the Home SIM is reestablished as the primary SIM profile, as indicated by primary status indicator 809a, the Travel Sim is deactivated, as indicated by toggle 810c, and the Work SIM is reactivated and established as the secondary SIM profile as indicated by toggle 810b and secondary status indicator 809b respectively.

FIG. 9 illustrates a flow diagram illustrating a method in which an electronic device initiates one or more operations for activating a travel configuration based on the arrival in a destination, wherein a first configuration is not configured for the destination. The method 900 is optionally performed at first electronic device and/or electronic devices such as device 100, device 300, or device 500 as described above with reference to FIGS. 1A-1B, 2-3, 4A-4B and 5A-5H. Some operations in method 900 are, optionally combined and/or order of some operations is, optionally, changed.

The devices, methods, and/or computer-readable storage mediums described below enhance the operability of the device and makes the user-device interface more efficient (e.g., by helping the user to provide proper inputs and reducing user mistakes when operating/interacting with the device) which, additionally, reduces power usage and/or improves battery life of the device by enabling the user to use the device more quickly and efficiently. Performing an operation when a set of conditions has been met without requiring further user input (such as by initiating one or more operations to activate the second configuration installed on the electronic device when the electronic device determines that the electronic device has arrived at the second geographic location) enhances the operability of the device by reducing unnecessary inputs and/or steps to navigate through different user interfaces or sets of controls, reducing energy usage by the device.

In some embodiments, method 900 is performed at an electronic device, in communication with a display generation component and one or more input devices. In some embodiments, the first electronic device, first user, display generation component, and one or more input devices share one or more characteristics with the first electronic device, first user, display generation component, and/or one or more input devices as described herein in relation to methods 700 and/or 900.

In some embodiments, such as shown in FIG. 8C, while a first configuration (e.g., Home SIM) corresponding to a first geographic location (e.g., U.S. as shown in SIM status panel 808a) and a second configuration (e.g., Travel SIM) corresponding to a second geographic location (e.g., Japan as shown in SIM status panel 808c) are installed on the electronic device, wherein the second configuration is not active on the electronic device (e.g., method step 901 at FIG. 9), the electronic device detects (e.g., method step 902 at FIG. 9) that the electronic device has arrived at the second geographic location, such as shown in relation to FIG. 8C wherein the Travel SIM is inactive (see toggle 810c) and the electronic device detects arrival in Tokyo (see current geographic location 814). . In some embodiments, the first configuration corresponding a first geographic location, the second configuration corresponding to the second geographic location, the installation of one or more configurations, and the state of a configuration (e.g., active or inactive), share one or more characteristics with the , the first configuration corresponding a first geographic location, the second configuration corresponding to the second geographic location, the installation of one or more configurations, and the state of a configuration respectively as described herein in relation to methods 700 and/or 900. The first geographic location, and the first configuration optionally share one or more characteristics with the first geographic location and/or the first configuration as described herein in relation to methods 700 and/or 900. In some embodiments detecting the current geographic location of the electronic device shares one or more characteristics with detecting the current geographic location of the electronic device as described herein in relation to methods 700 and/or 900. In some embodiments, the second geographic location, and determining that the electronic device arrives at the second geographic location share one or more characteristics with the second geographic location, and/or determining that the electronic device arrives at the second geographic location as described herein with respect to methods 700 and/or 900. In some embodiments, the first configuration and the second configuration are installed on the electronic device prior to the arrival of the electronic device to the second geographic location. For instance, the electronic device (e.g., smart phone, or other communication device) optionally has a first SIM configured for use in the U.S. and/or U.S. territories, and a second SIM configured for use in Europe and/or European territories. While in the U.S., the electronic device optionally uses the first SIM, and the second SIM remains installed on the electronic device wherein the second SIM is inactive and not used for communications unless the electronic device detects that the electronic device has arrived in a geographic location corresponding to the second SIM (e.g., Europe).

In some embodiments, in response to detecting that the electronic device has arrived at the second geographic location (e.g., second country, area served by a second carrier, etc.) ., the electronic device initiates (e.g., method step 904 at FIG. 9) one or more operations for activating the second configuration (e.g., second SIM) that is already installed (e.g., was installed prior to the electronic device detecting that it had arrived at the second geographic location, such as being installed in one or more of the ways described with reference to methods 700 and/or 900) on the electronic device, such as displaying the selectable notification 822a when detecting that the geographic location of the electronic device is in Japan as shown in FIG. 6C. Determining that the electronic device arrives at the second geographic location optionally shares one or more characteristics with determining that the electronic device arrives at the second geographic location as described herein with respect to methods 700 and/or 900.In some embodiments, initiating one or more operations for activating the second configuration shares one or more characteristics with activating the first configuration and/or the second configuration as described herein in relation to methods 700 and/or 900. In some embodiments, initiating one or more operations includes displaying a notification and/or displaying a selectable user interface element which when selected initiates the one or more operations for activating the second configuration, and/or when selected activates the second configuration without further user input. Displaying a notification and/or a selectable user interface element optionally shares one or more characteristics with displaying a notification as described herein in relation to methods 700 and/or 900. In some embodiments, when the electronic device detects that the electronic device has arrived at the second geographic location, the electronic device initiates one or more operations to activate the second configuration and/or deactivate the first configuration. For instance, when the electronic device detects that the current geographic location of the electronic device is Europe, the electronic device optionally activates the second SIM corresponding to Europe. Additionally or alternatively, when the electronic device detects that the current geographic location of the electronic device no longer corresponds to the activated configuration, the one or more operations for activating the second configuration optionally includes deactivating and/or demotes the first configuration. In some embodiments, while a first configuration is active on the electronic device, and the electronic device determines that the current geographic location of the electronic device ceases to correspond with the first geographic location, the electronic device optionally deactivates the first configuration prior to detecting arrival of the electronic device in the second geographic location. Additionally or alternatively, when the electronic device detects that the current geographic location of the electronic device corresponds with the second geographic location, the electronic device optionally deactivates the first configuration. In some embodiments, when the electronic device determines that the geographic location of the electronic device no longer corresponds with the first electronic device, and does not detect arrival in the second geographic location, the electronic device forgoes deactivating the first configuration.

In some embodiments, the first configuration corresponds to a first SIM, and the second configuration corresponds to a second SIM, such as the Home SIM and the Travel SIM as shown in FIG. 8C. In some embodiments, the first configuration and the second configuration correspond to a first SIM and a second SIM respectively. The first SIM and the second SIM optionally share one or more characteristics with the one or more SIMs (e.g., first SIM, second SIM, etc.) described herein in relation to methods 700 and/or 900. The first SIM is configured for use in a first geographic location wherein the first geographic location optionally corresponds to a default location for the electronic device. For instance, the first geographic location optionally corresponds to the geographic location (e.g., city, state, country, or geographical region) which a user of the electronic device resides. The second SIM optionally corresponds to a second geographic location which corresponds to geographic location which the user of the electronic device is travelling to currently and/or in the future.

In some embodiments, the one or more operations include presenting information indicating that the first configuration does not correspond to the second geographic location, such as shown via notification 822a as displayed in relation to FIG. 8C. In some embodiments, the one or more operations includes presenting information (e.g., via the one or more display generation components, via audible notification, and/or haptic notification) which relays to the user of the electronic device that the first configuration being used on the electronic device does not corresponds to the second geographic location. In some embodiments, presenting information associated with the first configuration shares one or more characteristics with presenting information as described herein in relation to methods 700 and/or 900. In some embodiments, the information includes details corresponding to incompatibility issues which exist as related to the user of the first configuration in the second geographic location. In some embodiments, the information includes details corresponding to roaming, excess fees, or other communication incompatibility issues described herein. In some embodiments, presenting information includes displaying a notification corresponding to the first configuration in relation to the second geographic location (e.g., compatibility, fees, usage, and/or incompatibility), wherein the notification is selectable to initiate the one or more operations for activating the second configuration. In some embodiments, when the notification is selected, the electronic device activates the second configuration without further input from the user. In some embodiments, the notification is selectable to forgo activating the second configuration, wherein the electronic device activates the second configuration when no input is detected in relation to the notification within a threshold period of time (e.g., 0.5 seconds, 1, second, 5, seconds, 30 seconds, more than 30 seconds), prior to a user input corresponding to the dismissal of the notification, and/or prior to detecting a user input directed to a portion of the electronic device which does not correspond to the notification.

In some embodiments, the one or more operations includes displaying, via the display generation component, a selectable user interface element which when selected activates the second configuration for use in the second geographic location, such as third user interface element 826c as shown in FIG. 8D which when selected results in the activation of the Travel SIM. In some embodiments, the one or more operations include displaying a user interface element, the selection of which corresponds to the activation of the second configuration for use in the second geographic location. Displaying the selectable user interface optionally shares one or more characteristics with displaying a notification and/or displaying a user interface as described herein in relation to methods 700 and/or 900. Detecting the selection of the selectable user interface optionally shares one or more characteristics with the selection of a notification and/or a selectable user interface as described herein in relation to methods 700 and/or 900. In some embodiments, the user interface element is displayed in response to or after the arrival of the electronic device in the second geographic location. In some embodiments, the electronic device displays the selectable user interface element when the second configuration is configured for use in the geographic location that the electronic device is currently in. When the electronic device detects selection of the user interface element, the electronic device optionally activates the second configuration without further input from the user. Additionally or alternatively, selection of the user interface element optionally initiates one or more operations for activating the second configuration.

In some embodiments, the selectable user interface element is a notification, such as if selection of notification 822a as displayed in relation to FIG. 8C results in the activation of the Travel SIM. In some embodiments, the selectable user interface element is a notification with information to alert the user that the first configuration does not correspond to the second geographic location and/or will result in communication interruption and/or accrual of excess fess. In some embodiments, the notification includes information corresponding to usage (e.g., time corresponding to voice calls, number of messages, amount of data) of the first configuration in the second geography that are potentially subject to excess fees. In some embodiments, the notification includes information corresponding to the fees accrued due to usage of the first configuration in the second geographic location. In some embodiments, the notification is displayed in a notification user interface wherein the notifications accrue (e.g., operating system notifications, communication status notifications, notifications associated with an application installed on the electronic device, and/or notifications which do not correspond to communication status) until otherwise dismissed, address, and/or deleted by a user. In some embodiments, the notification is displayed at a location in the user interface and/or on the display that is the same location that other types of notifications on the device are displayed (e.g., new email notifications, new message notifications, phone call notifications, application notification, and/or the like).

In some embodiments, the notification is displayed overlaid on a lock screen user interface of the electronic device, such as if notification 822a is displayed while displaying a lock screen in relation to FIG. 8C. In some embodiments, the notification is overlaid on a lock screen user interface of the electronic device, wherein the notification is displayed even when the electronic device is locked. A lock user interface optionally restricts notifications to those corresponding to one or more notifications, prioritized notifications, and/or restrict unwanted screen interactions while the lock screen user interface is activated. The lock screen user interface optionally corresponds to a default screen associated with the operating system which requires user authentication to access further features of the electronic device (e.g., the lock screen user interface is displayed while access to one or more functionalities or features of the electronic device is restricted or locked), and/or user interface corresponding to first application which prevents notifications which are not associated with the first application from being displayed. The lock screen user interface is optionally the first user interface that is displayed when the electronic device is first powered on and/or moves into a high power state from a lower power state (e.g., exiting sleep mode).

In some embodiments, the notification is displayed overlaid on a home screen user interface of the electronic device, such as notification 822a as displayed over the home user interface 806 in relation to FIG. 8C. In some embodiments, the notification is overlaid on a home screen (e.g., such as described in relation to FIG. 4A) user interface of the electronic device, wherein the notification is displayed when the application corresponding to the installation and/or activation of the respective configurations is not active and/or displayed.

In some embodiments, the notification is displayed overlaid on a user interface of an application installed on the electronic device, such as if notification 822a is displayed while displaying user interface of an application installed on the electronic device in relation to FIG. 8C. In some embodiments, the notification is overlaid on a user interface of an application installed on the electronic device, wherein the notification is displayed when the application other than the application corresponding to the installation and/or activation of the respective configurations is active and/or displayed on the electronic device. In some embodiments, the user interface is not a user interface of an operating system of the electronic device. In some embodiments, the application is created by an entity other than an entity who created the operating system of the electronic device.

In some embodiments, while displaying the selectable user interface element, the electronic device detects, via the one or more input devices, a user input corresponding to selection of the selectable user interface element, such as user input 834b directed to the user interface element 834a in relation to FIG. 8F. In some embodiments, while the electronic device displays the selectable user interface element, the electronic device detects an input which corresponds to the selection of the user interface element. In some embodiments, the user input shares one or more characteristics with one or more user inputs as described herein in relation to method 700 and/or 900.

In some embodiments, in response to detecting the user input, the electronic device activates the second configuration for use in the second geographic location, such as the activation to the Travel SIM (see toggle 810c) as shown in relation to FIG. 8G. In some embodiments, in response to detecting the user input to the selectable user interface element, the electronic device activates the second configuration for use in the second geographic location. In some embodiments, activating the second configuration optionally includes making the second configuration the primary configuration for use in one or more communication functionalities while in the second geographic location. In some embodiments, activating the second configuration shares one or more characteristics with activating the second configuration as described herein in relation to methods 700 and/or 900.

In some embodiments, in response to detecting the user input, the electronic device presents information about the activation of the second configuration, such as if in relation to activation of the Travel SIM as shown in FIG. 8G, the electronic device further displays a notification indicating that the Travel SIM has been successfully activated. In some embodiments, in response to detecting the user input to the selectable user interface element, the electronic device presents information about the activation of the second configuration for use in the second geographic location. Presenting information about the activation of the second configuration optionally shares one or more characteristics with presenting information about the activation of the second configuration as described herein in relation to methods 700 and/or 900.

In some embodiments, while the second configuration is active on the electronic device, the electronic device detects that the electronic device has arrived in a third geographic location, different than the first geographic location and different than the second geographic location, wherein the first configuration corresponds to the third geographic location, such as shown in FIG. 8K, wherein the electronic device detects arrival in San Francisco (see current geographic location 814), for which the Home SIM is configured.. In some embodiments, while the second configuration is active for user on the electronic device, such as in accordance with detecting that the electronic device arrived in the second geographic location, the electronic device detects that the electronic device has arrived in a third geographic location which corresponds to the first configuration. The third geographic location is optionally the same as the first geographic location, or different than the first geographic location. In some embodiments, the third geographic location corresponds to a different geographic location than the first geographic location, but the respective geographic locations correspond to the same region served by the first configuration. For instance, the first geographic location optionally corresponds to California, and the third geographic location optionally corresponds to Colorado, which are both in the United States. Thus, although the first geographic location and the third geographic location are different, a first configuration which optionally corresponds the United States, the first configuration corresponds to both the first geographic location and the third geographic location.

In some embodiments, in response to detecting that the electronic device arrived in the third geographic location, the electronic device initiates one or more operations for activating the first configuration, such as if the Home SIM were in a deactivated state prior to displaying of the notification 846 as shown in FIG. 8K in response to detecting that the electronic device has arrived in San Francisco, wherein the one or more operations to deactivate the Travel SIM includes one or more operations to activate the Home SIM. In response to detecting that the electronic device arrived in the third geographic location, the electronic device optionally initiates one or more operations for activating the first configuration. In some embodiments, the electronic device displays a notification and/or a selectable user interface element which is selectable to initiate the one or more operations for activating the first configuration. In some embodiments initiating one or more operations for activating a particular configuration shares one or more characteristics with activating one or more configurations (e.g., first configuration, second configuration, third configuration, etc.) as described herein in relation to methods 700, and/or 900. In some embodiments, in response to detecting that the electronic device arrived in the third geographic location, which corresponds to the first configuration, the electronic device activates the first configuration without further input from the user and/or without displaying a notification or information corresponding to the activation of the first configuration and/or deactivation of the second configuration.

In some embodiments, the one or more operations for activating the first configuration on the electronic device include deactivating the second configuration on the electronic device, such as deactivating the Travel SIM as shown in relation to FIG. 8L. In some embodiments, when the electronic device reactivates the first configuration upon returning to a geographic location which corresponds to the first configuration, the electronic device deactivates the second configuration. In some embodiments, when the electronic device deactivates the second configuration, the electronic device forgoes uninstalling the second configuration to allow future use of the second configuration, such as via manual activation by the user and/or when the electronic device detects arriving in a fourth location to which the second configuration corresponds. In some embodiments, when the electronic device deactivates the second configuration, the electronic device uninstalls the second configuration, such as when the services corresponding to the second configuration have expired, and/or are depleted.

In some embodiments, the one or more operations for activating the first configuration on the electronic device include displaying, via the display generation component, a notification corresponding to the activation of the first configuration, wherein the notification is selectable to display a settings user interface corresponding to the first configuration and the second configuration, such as if the Home SIM were in a deactivated state prior to displaying of the notification 846 as shown in FIG. 8K in response to detecting that the electronic device has arrived in San Francisco, where detecting a user input to the notification 846 would initiate one or more operations to activate the Home SIM. In some embodiments, the one or more operations for activating the first configuration includes displaying a notification that is selectable to perform one or more operations corresponding to the activation of the first configuration. When the electronic device detects selection of the notification, the electronic device optionally activates the second configuration and/or changes (e.g., activates, deactivates, and/or uninstalls) the first configuration. In some embodiments, detecting the selection of the notification corresponds to a request to display a settings user interface which corresponds to the first configuration and/or the second configuration. The settings user interface includes one or more selectable and/or customizable options which correspond to the first configuration the second configuration. The settings user interface optionally includes control of functions such as roaming, creation and control of a personal hotspot enabling a user to digitally connect other electronic devices to use the first and/or second configuration for cellular data usage, and/or controlling cellular data usage as related to one or more application installed on the electronic device.

In some embodiments, initiating the one or more operations includes automatically activating the second configuration without user input, such as if following detection that the electronic device has arrived in Japan (see current geographic location 814) as shown in FIG. 8C, the electronic device automatically activates the Travel SIM without further user input. In some embodiments, the one or more operations include activating the second configuration without further user input. Accordingly, in response to detecting that the electronic device has arrived in the second geographic location, the electronic device optionally activates the second configuration without requiring user input corresponding to the activation of the second configuration. Activating the second configuration optionally shares one or more characteristics with activating one or more configurations (e.g., first configuration, second configuration, third configuration, etc.) as described herein in relation to methods 700 and/or 900.

In some embodiments, initiating the one or more operations include presenting information about the use of the first configuration in the second geographic location, such as notification 822a providing information about the Home SIM as shown in relation to FIG. 8C. In some embodiments, the one or more operations include presenting information (e.g., via a visible notification, audible notification and/or haptic notification) corresponding to the use of the first configuration in the second geographic location. The information optionally includes information corresponding to communication incompatibility and/or excess fees corresponding to the use of the first configuration in the second geographic location. Presenting information corresponding to the use of the first configuration in the second geographic location optionally shares one or more characteristics with presenting information and/or displaying a notification corresponding to the use of the first configuration in the second location as described herein in relation to methods 700 and/or 900.

In some embodiments, in response to detecting that the electronic device has arrived at the second geographic location and in accordance with a determination that the first configuration corresponds to the first geographic location and the second geographic location, the electronic device forgoes activating the second configuration, such as if the electronic device detects that the current geographic location 814 of Santa Cruz as shown in FIG. 8B, is then detected as corresponding to New York City, and the Home SIM is configured for use in New York City. In some embodiments, in response to detecting that the electronic device has arrived in the second geographic location, and the electronic device determines that the first configuration corresponds to the first geographic location and the second geographic location, the electronic device does not activate the second configuration. For instance, when the electronic device detects travelling from Los Angeles to New York, the electronic device determines that the SIM that is configured for communication in Los Angeles and New York without communication incompatibility, the electronic device does not initiate the one or more operations to activate the second electronic device.

In some embodiments, such as shown in FIG. 8C, when the electronic device detects that the electronic device has arrived at the second geographic location (e.g., Tokyo as shown in relation to the current geographic location 814) , the first configuration (e.g., Home SIM) is active for performing one or more first communication functions (e.g., cellular voice corresponding to the Home SIM, and cellular data), and a third configuration (e.g., Work SIM), corresponding to the first geographic location, is active for performing one or more second communication functions (e.g., cellular voice corresponding to the Work SIM), different from the one or more first communication functions, the electronic device initiates one or more operations to activate the second configuration (e.g., Travel SIM). In some embodiments, when the electronic device detects that the electronic device has arrived in the second geographic location, the electronic device includes the first configuration which is active for performing one or more first communication functions, and a third configuration that is active for performing one or more second communication functions. In some embodiments the first communication functions include cellular data (e.g., transmission and/or reception), cellular communications (e.g., voice, and/or Short Message Service (SMS)) corresponding to the first configuration, and/or wireless network communications. In some embodiments, the third communication functions share one or more characteristics with the first communication functions. In some embodiments the third communication functions include cellular data (e.g., transmission and/or reception), cellular communications (e.g., voice, and/or Short Message Service (SMS)) corresponding to the third configuration, and/or wireless network communications. In some embodiments, the first and second communication functions are the same or different functions selected from the following list of functions: cellular voice, cellular messaging or cellular data functions, where cellular data functions correspond to any function that can be performed using cellular data, whether voice calls, messaging, video calls, or the like. In some embodiments, the first and second communication functions additionally or alternatively correspond to primary functions or secondary functions. In some embodiments, when a configuration is assigned to primary functions, it is the primary configuration, and when a configuration is assigned to secondary functions, it is the secondary configuration. The primary configuration is optionally the default configuration used for cellular calls, cellular messaging and cellular data, when use of a different configuration for such functions is not separately specified. The secondary configuration is optionally a configuration that can be specified for use in cellular calls, cellular messaging and/or cellular data functions, while those functions that remain unspecified for a particular configuration default to the primary configuration.

In some embodiments, initiating the one or more operations includes the electronic device activating the second configuration for performing the one or more first communication functions, such as shown in relation to FIGS. 8E-8F wherein the Travel SIM is selected to perform cellular voice functions corresponding to the Travel SIM, and cellular data functions (e.g., primary functions and/or one or more of cellular calls, cellular messaging and cellular data). In some embodiments, the one or more operations include activating the second configuration for performing the one or more first communication functions. For instance, when the first communication functions include cellular data communications, when the electronic device detects that it has arrived in the second geographic location corresponding to the second geographic location, the electronic device optionally activates the second configuration and assigns the user of cellular data communications to the second configuration.

In some embodiments, initiating the one or more operations includes the electronic device assigning the one or more second communication functions (e.g., secondary functions and/or one or more of cellular calls, cellular messaging and cellular data) away from the third configuration to the first configuration, such as electing to use the Travel SIM as the Primary configuration (e.g., for cellular data) as shown in relation to FIG. 8F. In some embodiments, when activating the second configuration, the electronic device assigns one or more second communication functions away from the third configuration such as voice over IP corresponding to the third configuration, to the first configuration.

In some embodiments, initiating the one or more operations includes deactivating the third configuration, such as deactivating the Work SIM (see toggle 810b) in relation to FIG. 8G. In some embodiments, initiating the one or more operations includes deactivating the third configuration. In some embodiments, the electronic device deactivates (e.g., based on user input, or without further user input) the third configuration due to the electronic device only supporting a maximum of two active configurations at a given time. In some embodiments, when the electronic device deactivates the third configuration, the electronic device maintains the third configuration on the electronic device such as for future use. In some embodiments, when the electronic device deactivates the third configuration, the electronic device uninstalls the third configuration, such as when the services corresponding to the second configuration have expired, are depleted, and/or the electronic device has not detected an indication of future travel which corresponds to the second geographic location. In some embodiments, detecting an indication of future travel shares one or more characteristics with detecting an indication of future travel as described herein in relation to method 700.

In some embodiments, while in the second geographic location, the electronic device detects an event corresponding to receiving one or more communications, such as if the electronic device receives a call or text. In some embodiments, while in the second geographic location, the electronic device detects an event corresponding to receiving one or more communications (e.g., email, voice over IP, message over IP, cellular voice, cellular SMS, etc.).

In some embodiments, in response to detecting the event corresponding to receiving the one or more communications, in accordance with a determination that the one or more communications are performed using a first application at the electronic device (e.g., an application that performs cellular functions that have been assigned to the second configuration), the electronic device facilitates the one or more communications via the first application using the second configuration, such as if the call to the Hotel were a call received from the Hotel a cellular call directed to the Travel SIM while the electronic device is in Tokyo as shown in FIG. 8G, the communications are performed using the Travel SIM.. In some embodiments, in response to detecting an event corresponding to receiving one or more communications that are associated with a first application, the electronic device optionally facilitates receiving and/or transmitting communications associated with the first application with the second configuration. For instance, when the electronic device detects an event corresponding to receiving one or more emails via an email client, the electronic device uses the second configuration for the use of cellular data transmissions to and from the electronic device via an email client.

In some embodiments, in response to detecting the event corresponding to receiving the one or more communications, in accordance with a determination that the one or more communications are performed using a second application at the electronic device (e.g., an application that performs cellular functions that have been assigned to the first configuration), the electronic device facilitates the one or more communications via the second application using the first configuration and/or the third configuration, such as when the electronic device sends a messages 842 via SMS to “Mom” as shown in FIGS. 8I-8J wherein the SMS is sent via the Home SIM. In some embodiments, in response to receiving one or more communications that are associated with and/or received via a second application which is dependent on the first geographic location, the electronic device optionally facilitates receiving the one or more communications with the first configuration and/or the third configuration. For instance, when the event corresponding to receiving the one or more communications is received via second application which is associated with a cellular network carrier corresponding to the first configuration (e.g., cellular voice and/or cellular messaging), the electronic device optionally uses the first configuration for receiving and transmitting communications corresponding to the second application.

In some embodiments, while in the second geographic location, the electronic device detects an event corresponding to receiving one or more communications, such as if the electronic device as shown in FIG. 8H is receiving a phone call. In some embodiments detecting an event corresponding to receiving one or more communications shares one or more characteristics with detecting an event corresponding to receiving one or more communications as described herein in relation to methods 700 and/or 900.

In some embodiments, in response to detecting the event corresponding to receiving the one or more communications, in accordance with a determination that the one or more communications correspond to the first configuration (e.g., the communications require cellular functions that have been assigned to the first configuration), the electronic device facilitates the one or more communications using the first configuration, such as if the electronic device as shown in FIG. 8H is receiving a cellular phone call directed to the Home SIM, the electronic device facilitates the call with the Home SIM. In response to detecting the event corresponding to receiving the one or more communications, the electronic device optionally facilitates the one or more communications using the first configuration and/or the second configuration.

When the electronic device determines that the one or more communications correspond to the first configuration, the electronic device optionally facilitates the one or more communications using the first configuration. For instance, when the one or more communications include a cellular phone call directed to a phone number associated with the first configuration, the electronic device optionally facilitates the phone call using the first configuration.

In some embodiments, in response to detecting the event corresponding to receiving the one or more communications, in accordance with a determination that the one or more communications correspond to the second configuration (e.g., the communications require cellular functions that have been assigned to the second configuration), the electronic device facilitates the one or more communications using the second configuration, such as if the electronic device as shown in FIG. 8H is receiving a cellular phone call directed to the Travel SIM, the electronic device facilitates the call with the Travel SIM.. When the electronic device determines that the one or more communications correspond to the second configuration, the electronic device optionally facilitates the one or more communications using the second configuration. For instance, when the one or more communications include a phone call directed to a phone number associated with the second configuration, the electronic device optionally facilitates the phone call using the second configuration.

In some embodiments, while in the second geographic location, the electronic device detects an event corresponding to sending one or more communications, such as shown for instance in FIGS. 8G-8J. In some embodiments, while in the second geographic location, when the electronic device detects an event which corresponds to sending one or more communications, the electronic device sends the one or more communications with the fist configuration and/or the second configuration dependent upon which geographic location the communications correspond to.

In some embodiments, in response to detecting the event corresponding to sending the one or more communications, in accordance with a determination that the one or more communications correspond to the first geographic location, the electronic device sends the one or more communications using the first configuration, such as the electronic device sending an SMS text to “Mom” (presumably corresponding to the Home location of the U.S.), wherein the SMS text is sent via the Home SIM as shown in FIG. 8J. In response to detecting the event corresponding to sending the one or more communications, when the one or more communications correspond to the first geographic location, the electronic device sends the one or more communications using the first configuration. For instance the electronic device optionally determines that the one or more communications corresponds with the first geographic location (e.g., based on phone number, contact information, and/or previous communications) the electronic device sends the one or more communications using the first configuration. For example, a cellular phone call to a phone number in the first geographic region will optionally be performed using the first configuration.

In some embodiments, in response to detecting the event corresponding to sending the one or more communications, in accordance with a determination that the one or more communications correspond to the second geographic location, the electronic device sends the one or more communications using the second configuration, such as the electronic device placing a cellular phone call to “Hotel” (presumably corresponding to the travel location of Japan), wherein the phone call is placed via the Travel SIM as shown in FIG. 8H. In response to detecting the event corresponding to sending the one or more communications, when the one or more communications correspond to the second geographic location, the electronic device sends the one or more communications using the second configuration. For instance the electronic device optionally determines that the one or more communications corresponds with the second geographic location (e.g., based on phone number, contact information, and/or previous communications) the electronic device sends the one or more communications using the second configuration. For example, a cellular phone call to a phone number in the second geographic region will optionally be performed using the second configuration.

In some embodiments, after detecting that the electronic device has arrived at the second geographic location (e.g., current geographic location 814 of Tokyo as shown in FIG. 8J), the electronic device detects that the electronic device has returned to the first geographic location (e.g., corresponding to the U.S. as shown in reference to a current geographic location of San Francisco such as shown in FIG. 8K). In some embodiments, after detecting that the electronic device arrived in the second geographic location, the electronic device detects that the electronic device subsequently returns to the first geographic location. In some embodiments, detecting that the electronic device has returned to the first geographic location shares one or more characteristics with detecting that the electronic device has arrived in the second geographic location as described herein in relation to methods 700 and/or 900.

In some embodiments, in response to detecting that the electronic device has returned to the first geographic location, the electronic device assigns the one or more first communication functions away from the second configuration to the first configuration, such as updating the Home SIM to be the Primary 809a SIM profile (e.g., assigning cellular data back to the Home SIM from the Travel SIM), as shown in relation to FIG. 8L. In some embodiments, in response to detecting that the electronic device has returned to the first geographic location, the electronic device initiates one or more operations to return the electronic device to the status prior to detecting that the electronic device arrived in the second geographic location. In some embodiments, returning the electronic device to the status prior to detecting arrival in the second geographic location optionally includes resetting one or more settings, and/or restoring to one or more default settings corresponding to the communication configurations.

In some embodiments, in response to detecting that the electronic device has returned to the first geographic location, the electronic device assigns the one or more first communication functions, originally assigned to the first configuration prior to detecting the electronic device’s arrival in the second geographic location, back to the first configuration.

In some embodiments, in response to detecting that the electronic device has returned to the first geographic location, the electronic device assigns the one or more second communication functions away from the first configuration to the third configuration, such as the deactivation of the Travel SIM and activation of the Work SIM as the secondary 809b SIM profile, wherein the Travel SIM is no longer used for cellular communications directed to the Travel SIM and the Work SIM is used for cellular communications directed to the Work SIM, as shown in FIG. 8L. In some embodiments, in response to detecting that the electronic device has returned to the first geographic location, the electronic device assigns the one or more second communication functions, originally assigned to the third configuration prior to detecting the electronic device’s arrival in the second geographic location, back to the third configuration.

In some embodiments, in response to detecting that the electronic device has returned to the first geographic location, the electronic device deactivates the second configuration, such as the deactivation of the Travel SIM as shown in relation to FIG. 8L. In some embodiments, in response to detecting that the electronic device has returned to the first geographic location, the electronic device deactivates the second geographic location and optionally uninstalls the second configuration from the electronic device. In some embodiments, deactivating the second configuration shares one or more characteristics with deactivating one or more configurations (e.g., first configuration, second configuration, third configuration, etc.) as described herein in relation to methods 700 and/or 900.

In some embodiments, after detecting that the electronic device has arrived at the second geographic location (e.g., current geographic location 814 of Tokyo as shown in FIG. 8J), the electronic device detects that the electronic device has arrived in a third geographic location (e.g., corresponding to the current geographic location 814 of San Francisco such as shown in FIG. 8K), different than the first geographic location and the second geographic location. In some embodiments, after detecting the arrival of the electronic device in the second geographic location, the electronic device detects the arrival of the electronic device in a third geographic location which is different than the first geographic location and the second geographic location. In some embodiments, detecting that the electronic device arrived in a third geographic location shares one or more characteristics with detecting that the electronic device has arrived in the first geographic location and/or the second geographic location as described herein in relation to methods 700 and/or 900.

In some embodiments, in response to detecting that the electronic device has arrived in the third geographic location and in accordance with a determination that the third geographic location corresponds to the first configuration (e.g., Home SIM corresponding to use in San Francisco in addition to Santa Cruz), the electronic device assigns the one or more first communication functions (e.g., primary functions) away from the second configuration to the first configuration, such as updating the SIM profiles from the Travel SIM being the primary 809a SIM profile as shown in FIG. 8K, to the Home SIM being the primary 809a SIM profile as shown in FIG. 8L. In response to detecting that the electronic device has arrived in the third geographic location, and further determining that the first configuration corresponds to the third geographic location, the electronic device electronic device takes one or more actions which share one or more characteristics with the use of the first configuration in the first geographic location as described herein in relation to methods 700 and/or 900. In some embodiments, detecting that the electronic device has arrived in the third geographic location, and further determines that the first configuration corresponds to the third geographic location shares one or more characteristics with detecting that the electronic device has returned to the first geographic location after detecting arrival in the second geographic location.

In some embodiments, in response to detecting that the electronic device has arrived in the third geographic location, the electronic device assigns one or more first communication functions from the second configuration to the first configuration such as configured prior to detecting that the electronic device arrived in the second geographic location. Assigning the one or more first communication functions away from the second configuration to the first configuration optionally shares one or more characteristics with assigning the one or more communication functions (e.g., first functions, second functions, etc.) away from a particular configuration to a different configuration.

In some embodiments, in response to detecting that the electronic device has arrived in the third geographic location and in accordance with a determination that the third geographic location corresponds to the first configuration, the electronic device assigns the one or more second communication functions (e.g., secondary functions) away from the first configuration to the third configuration, such as shown in FIGS. 8K-8L wherein the secondary 809b SIM profile (e.g., corresponding to secondary cellular functionality) is updated from being supported by the Home SIM (see FIG. 8K), to the Work SIM as shown in FIG. 8L. In some embodiments, in response to detecting that the electronic device has arrived in the third geographic location, the electronic device optionally assigns the one or more second communication functions away from the first configuration to the third configuration. In some embodiments, when the first configuration and the third configuration correspond to the third geographic location, the electronic device optionally reverts to the configurations (e.g., the first configuration and the third configuration) that were active when the electronic device was in the first geographic location. In some embodiments, when the electronic device detects arrival in the third geographic location, the electronic device reconfigures as described herein to us the first configuration and the third configuration in the third geographic location without further input from the user. In some embodiments, when the electronic device detects arrival in the third geographic location, the electronic device optionally deactivates and/or uninstalls (e.g., based on user input, or without further user input) the second configuration.

In some embodiments, in response to detecting that the electronic device has arrived in the third geographic location, in accordance with a determination that the third geographic location corresponds to a third configuration installed on the electronic device,(optionally activating the third configuration, if the third configuration is inactive, and) the electronic device assigns the one or more first communication functions (e.g., primary functions) away from the second configuration to the third configuration, such as if the Work SIM was configured for use in the EU, and the electronic device detected travel from Tokyo (e.g., as shown in FIG. 8J) to Paris, the electronic device would optionally update the Work SIM to be the primary 809a SIM profile, thus assigning primary cellular voice and cellular data functionality from the Travel SIM to the Work SIM. In some embodiments, when the electronic device detects that the electronic device has arrived in a third geographic location which is different than the first geographic location and the second geographic location, the electronic activates a third configuration which is installed on the electronic device which corresponds to the third geographic location. In some embodiments, when the electronic device activates the third configuration, the electronic device assigns one or more communication functions from the first configuration and/or the second configuration, to the third configuration. For instance, having arrived in the third geographic location from the second geographic location, the electronic device assigns one or more communication functions that were originally assigned to the first configuration in the first geographic location, to the third configuration. For instance, when detecting arrival in the second geographic location from the first geographic location, the electronic device optionally transfers cellular data functions (e.g., based on a user input corresponding to a request to transfer cellular data functions, or without further input from a user) from the second configuration to the third configuration, and when the electronic device detects that it has arrived in the third geographic location from the second geographic location, the electronic device optionally assigns the cellular data functions from the second configuration to the third configuration.

In some embodiments, in response to detecting that the electronic device has arrived in the third geographic location, in accordance with a determination that the second configuration does not correspond to the third geographic location, the electronic device deactivates the second configuration, such as shown in relation to FIGS. 8J-8L wherein the electronic device detects travel to the U.S. from Japan, wherein the Travel SIM is not configured for use, thus the electronic device deactivates (see toggle 810c) the Travel SIM such as shown in FIG. 8L. In some embodiments, when the electronic device detects that the electronic device has arrived in the third geographic location from the second geographic location, the electronic device determines that the second configuration does not correspond to the third geographic location, and accordingly, the electronic device deactivates the second configuration (e.g., based on user input corresponding to a request to deactivate the second config, or without further user input). In some embodiments, deactivating the second configuration includes uninstalling the second configuration. Deactivating the second configuration optionally shares one or more characteristics with deactivating one or more configurations (e.g., first configuration, second configuration, third configuration, etc.) as described herein in relation to methods 700 and/or 900. Accordingly, in some embodiments, when the electronic device detects that it has arrived in the third geographic location, the third configuration is active, and the first electronic device is active. For instance, when the first configuration corresponds to a default configuration and/or a configuration corresponding to the home location of the user of the electronic device, the electronic device maintains the first configuration in at least a secondary use functionality in addition to a configuration that is specific to the geographic location that the electronic device is currently in when the electronic device is not in the first geographic location.

It should be understood that the particular order in which the operations in FIG. 9 have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., method700) are also applicable in an analogous manner to method 900 described above with respect to FIG. 9. For example, the initiating one or more operations for activating a configuration corresponding to a destination with reference to method 900 optionally has one or more of the characteristics of detecting an indication of future travel to a second geographic location, and initiating one or more operations for installing a configuration for use in a second geographic location described herein with reference to other methods described herein (e.g., method 700). For brevity, these details are not repeated here.

The operations in the information processing methods described above are, optionally, implemented by running one or more functional modules in an information processing apparatus such as general purpose processors (e.g., a as described with respect to FIGS. 1A-1B, 3, 5A-5H) or application specific chips. Further, the operations described above with reference to FIG. 9 are, optionally, implemented by components depicted in FIGS. 1A-1B. For example, while a first configuration corresponding to a first geographic location and a second configuration corresponding to a second geographic location are installed on the electronic device 901, detecting operation 902, and initiating operation 904 are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

As described above, one aspect of the present technology is tracking and displaying content. The present disclosure contemplates that in some instances, the data utilized may include personal information data that uniquely identifies or can be used to contact or locate a specific person. Such personal information data can include demographic data, content consumption activity, location-based data, telephone numbers, email addresses, twitter ID's, home addresses, data relating to a person’s likeness, name, date of birth, or any other identifying or personal information.

The present disclosure recognizes that the use of such personal information data, in the present technology, can be used to the benefit of users. For example, analyzing notifications and/or communications for indications of future travel, and/or detecting the geographic location of the electronic device can enable the electronic device to determine when the installation and/or activation of a configuration is required. Accordingly, use of such personal information data enables users to use electronic devices to perform enhanced operations with mathematical functions and expressions. Further, other uses for personal information data that benefit the user are also contemplated by the present disclosure. For instance, analyzing a user’s handwriting may enhance detection of indications of future travel.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of location services, the present technology can be configured to allow users to select to "opt in" or "opt out" of participation in the collection of personal information data during registration for services or anytime thereafter. In another example, users can select not to enable recording of personal information data in a specific application. In addition to providing “opt in” and “opt out” options, the present disclosure contemplates providing notifications relating to the access or use of personal information. For instance, a user may be notified upon initiating content collection that their personal information data will be accessed and then reminded again just before personal information data is accessed by the device(s).

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user’s privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an electronic device determines indications of future travel and/or detects the current geographic location of the electronic device without associating the content with personal user data.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

What is claimed is:

1. A method comprising:
at an electronic device, in communication with a display generation component and one or more input devices:
while a first configuration corresponding to a first geographic location and a second configuration corresponding to a second geographic location are installed on the electronic device, wherein the second configuration is not active on the electronic device, detecting that the electronic device has arrived at the second geographic location; and
in response to detecting that the electronic device has arrived at the second geographic location, initiating one or more operations for activating the second configuration that is already installed on the electronic device.

2. The method of claim 1, wherein the first configuration corresponds to a first SIM, and the second configuration corresponds to a second SIM.

3. The method of claim 1, wherein the one or more operations include presenting information indicating that the first configuration does not correspond to the second geographic location.

4. The method of claim 1, wherein the one or more operations includes displaying, via the display generation component, a selectable user interface element which when selected activates the second configuration for use in the second geographic location.

5. The method of claim 4, wherein the selectable user interface element is a notification.

6. The method of claim 5, wherein the notification is displayed overlaid on a lock screen user interface of the electronic device.

7. The method of claim 5, wherein the notification is displayed overlaid on a home screen user interface of the electronic device.

8. The method of claim 5, wherein the notification is displayed overlaid on a user interface of an application installed on the electronic device.

9. The method of claim 4, further comprising:
while displaying the selectable user interface element, detecting, via the one or more input devices, a user input corresponding to selection of the selectable user interface element; and
in response to detecting the user input:
activating the second configuration for use in the second geographic location; and
presenting information about the activation of the second configuration.

10. The method of claim 1, further comprising:
while the second configuration is active on the electronic device, detecting that the electronic device has arrived in a third geographic location, different than the first geographic location and different than the second geographic location, wherein the first configuration corresponds to the third geographic location; and
in response to detecting that the electronic device arrived in the third geographic location, initiating one or more operations for activating the first configuration.

11. The method of claim 10, wherein the one or more operations for activating the first configuration on the electronic device include deactivating the second configuration on the electronic device.

12. The method of claim 10, wherein the one or more operations for activating the first configuration on the electronic device include displaying, via the display generation component, a notification corresponding to the activation of the first configuration, wherein the notification is selectable to display a settings user interface corresponding to the first configuration and the second configuration.

13. The method of claim 1, wherein initiating the one or more operations includes automatically activating the second configuration without user input.

14. The method of claim 1, wherein initiating the one or more operations include presenting information about the use of the first configuration in the second geographic location.

15. The method of claim 1, further comprising:
in response to detecting that the electronic device has arrived at the second geographic location and in accordance with a determination that the first configuration corresponds to the first geographic location and the second geographic location, forgoing activating the second configuration.

16. The method of claim 1, wherein:
when the electronic device detects that the electronic device has arrived at the second geographic location, the first configuration is active for performing one or more first communication functions, and a third configuration, corresponding to the first geographic location, is active for performing one or more second communication functions, different from the one or more first communication functions, and initiating the one or more operations includes:
activating the second configuration for performing the one or more first communication functions; and
assigning the one or more second communication functions away from the third configuration to the first configuration.

17. The method of claim 16, wherein initiating the one or more operations includes deactivating the third configuration.

18. The method of claim 16, further comprising:
while in the second geographic location, detecting an event corresponding to receiving one or more communications; and
in response to detecting the event corresponding to receiving the one or more communications:
in accordance with a determination that the one or more communications are performed using a first application at the electronic device, facilitating the one or more communications via the first application using the second configuration; and
in accordance with a determination that the one or more communications are performed using a second application at the electronic device, facilitating the one or more communications via the second application using the first configuration and/or the third configuration.

19. The method of claim 16, further comprising:
while in the second geographic location, detecting an event corresponding to receiving one or more communications; and
in response to detecting the event corresponding to receiving the one or more communications:
in accordance with a determination that the one or more communications correspond to the first configuration, facilitating the one or more communications using the first configuration; and
in accordance with a determination that the one or more communications correspond to the second configuration, facilitating the one or more communications using the second configuration.

20. The method of claim 16, further comprising:
while in the second geographic location, detecting an event corresponding to sending one or more communications; and
in response to detecting the event corresponding to sending the one or more communications:
in accordance with a determination that the one or more communications correspond to the first geographic location, sending the one or more communications using the first configuration; and
in accordance with a determination that the one or more communications correspond to the second geographic location, sending the one or more communications using the second configuration.

21. The method of claim 16, further comprising:
after detecting that the electronic device has arrived at the second geographic location, detecting that the electronic device has returned to the first geographic location; and
in response to detecting that the electronic device has returned to the first geographic location:
assigning the one or more first communication functions away from the second configuration to the first configuration;
assigning the one or more second communication functions away from the first configuration to the third configuration; and
deactivating the second configuration.

22. The method of claim 16, further comprising:
after detecting that the electronic device has arrived at the second geographic location, detecting that the electronic device has arrived in a third geographic location, different than the first geographic location and the second geographic location; and
in response to detecting that the electronic device has arrived in the third geographic location and in accordance with a determination that the third geographic location corresponds to the first configuration:
assigning the one or more first communication functions away from the second configuration to the first configuration; and
assigning the one or more second communication functions away from the first configuration to the third configuration.

23. The method of claim 22, further comprising:
in response to detecting that the electronic device has arrived in the third geographic location:
in accordance with a determination that the third geographic location corresponds to a third configuration installed on the electronic device:
assigning the one or more first communication functions away from the second configuration to the third configuration.

24. The method of claim 22, further comprising:
in response to detecting that the electronic device has arrived in the third geographic location:
in accordance with a determination that the second configuration does not correspond to the third geographic location, deactivating the second configuration.

25. An electronic device that is in communication with one or more display generation components and one or more input devices, the electronic device comprising:
one or more processors;
memory; and
one or more programs, wherein the one or more programs are stored in the memory and configured to be executed by the one or more processors, the one or more programs including instructions for:
while a first configuration corresponding to a first geographic location and a second configuration corresponding to a second geographic location are installed on the electronic device, wherein the second configuration is not active on the electronic device, detecting that the electronic device has arrived at the second geographic location; and
in response to detecting that the electronic device has arrived at the second geographic location, initiating one or more operations for activating the second configuration that is already installed on the electronic device.

26. A non-transitory computer readable storage medium storing one or more programs, the one or more programs comprising instructions, which when executed by one or more processors of an electronic device, cause the electronic device to perform a method comprising:
while a first configuration corresponding to a first geographic location and a second configuration corresponding to a second geographic location are installed on the electronic device, wherein the second configuration is not active on the electronic device, detecting that the electronic device has arrived at the second geographic location; and
in response to detecting that the electronic device has arrived at the second geographic location, initiating one or more operations for activating the second configuration that is already installed on the electronic device.
